(19) United States
(12) Patent Application Publication
(10) Pub. No.: US 2014/0378212 A1
(43) Pub. Date: Dec. 25, 2014

(54) SYSTEMS AND METHODS FOR CREATING ADVERTISING CONTENT AND PROMOTIONS THROUGH ONLINE CONTESTS

(71) Applicant: Thomas William Sims, Santa Barbara, CA (US)

(72) Inventor: Thomas William Sims, Santa Barbara, CA (US)

(21) Appl. No.: 14/164,169

(22) Filed: Jan. 25, 2014

Related U.S. Application Data
(60) Provisional application No. 61/758,739, filed on Jan. 30, 2013.

(51) Int. Cl. A63F 13/61; G06Q 30/02

(52) U.S. Cl. CPC A63F 13/61; G06Q 30/0276
USPC 463/25

(57) ABSTRACT

A system is disclosed for holding online contests on a membership web site. The contests are used to challenge members to design advertising material for Sponsor companies, which is posted online for viewing by the public and voting by registered Members and Judges. The contest process generates advertising revenue and a portion of this revenue is distributed to contestants in the form of cash proceeds or non-cash prizes based on the number of votes received. The registration process is used to ensure an accurate vote count and fair distribution of proceeds. The invention uniquely allows skilled and non-skilled people to use their social networking connections, natural talents, and common tools to participate in advertising campaigns and generate extra income.

This application claims priority to Provisional Application Ser. 61/758,739 filed Jan. 30, 2013, the content of which is incorporated by reference.

### BACKGROUND

The present invention relates to creating advertising content and running promotions by using online contests. Certain existing or conventional software applications and related web sites such as www.worth1000.com, or www.zooppa.com provide contests for the purpose of showcasing art or generating advertising material. However, these sites may be orientated towards using skilled, professional artists to create high quality art or advertisements that can be used by sponsoring companies in formal advertising campaigns. The participants in these contests can often expect to spend a lot of their own time (days or weeks) and money to create the art or advertisements. Since there are typically a large number of contestants and only a few prizes to distribute, contestants have very little chance of receiving any financial rewards for their efforts. The winners may receive some short recognition for their work, but it's unlikely that this will lead to a long term source of income. In many cases, contestants will be operating at a loss by participating in these types of competitions.

U.S. Pat. No. 6,532,448 discloses an automated system and method for holding contests for multiple, geographically dispersed contestants, in which the contestants are interconnected by a computer network such as the internet, and in which the contestant's skill level, time and effort required for preparing an entry is decreased, while the chance of generating income and the amount of income generated is increased. These benefits are provided primarily by giving contest participants extra tools and support for creating their entries, structuring each contest in an efficient and creative manner and building gamification into the voting ballots to increase viewer base, advertising effectiveness and prize pools.

### BRIEF SUMMARY OF THE INVENTION

In one aspect, a system, method, web site software and a business model are disclosed for holding online contests which challenge contestants to create advertisements for Sponsor companies.

In another aspect, systems and methods are disclosed for holding an online contest using a web site by holding online contests which challenge contestants to create advertisements for one or more sponsor companies; displaying advertisements for online voting, creating online audiences and generating advertising revenue; and using a portion of the advertising revenue to reward contestants as prizes based on the number of votes received.

Implementations of the above aspects may include one or more of the following. The advertisements are displayed for online voting with the intent of creating online audiences and generating advertising revenue. A portion of the advertising revenue (or other types of prizes) are returned to the contestants as prizes based on the number of votes received.

Other implementations of the above aspect may include one or more of the following. One exemplary embodiment allows for 3 categories of people to participate in the contests: Members, Judges, and Guests. Members can enter contests and vote in contests and must maintain a financial account linked to the web site where funds can be automatically deposited for contest winnings and deducted for monthly fees (if monthly fees are deemed to be required). Judges do not enter contests, but can vote in contests. Guests can view the contests, entries, and voting results but cannot vote. If no monthly fees are accessed, then Members and Judges could be combined into 1 category (e.g. Users) where the only requirement would be that they must be identified and registered so that web site Administrators can ensure that the voting results are accurate and rewards are fairly distributed. Members and Judges can participate in only one voting session per contest. Each session may require voters to cast multiple votes on different entries (to create diversity in votes), but voters are not allowed to vote more than once for any given entry. Judges and Members must register and provide personal information and identification so that web site Administrators can ensure that no one votes under multiple names. Guests can view contest descriptions and voting ballots, but are not allowed to vote since Guest voting cannot be accurately accounted for (e.g. a single Guest could vote on the same entry from multiple computers).

Advantages of the system may include one or more of the following. The system provides an online service to help both non-professional and professional designers to develop their design skills and generate a continuous and profitable income. Contestants can use a few hours of time and common skills (drawing, writing, sense of humor, home movies, photos) to generate simple, non-professional ads which will generate income.

### BRIEF DESCRIPTION OF THE DRAWINGS

FIG. 1 discloses the functional block diagram of the invention.

FIG. 2A discloses page 1 of the database tables (T1-T8).

FIG. 2B discloses page 2 of the database tables (T9-T16).

FIG. 2C discloses page 3 of the database tables (T17-T20).

FIG. 3 discloses the database directories (D1-D5).

FIG. 4A discloses page 1 of the message listing (M01-M30).

FIG. 4B discloses page 2 of the message listing (M31-M57).

FIG. 5A discloses page 1 of the subroutine listing (SR1-SR32).

FIG. 5B discloses page 2 of the subroutine listing (SR33-SR 64).

FIG. 6 discloses the web site screen listing (S1-S24).

FIG. 7A discloses page 1 of the software tools listing.

FIG. 7B discloses page 2 of the software tools listing.

FIG. 8 discloses page 1 of the glossary of terms.

FIG. 9 discloses page 2 of the glossary of terms.

FIG. 10 discloses the Server Executive software flowchart.

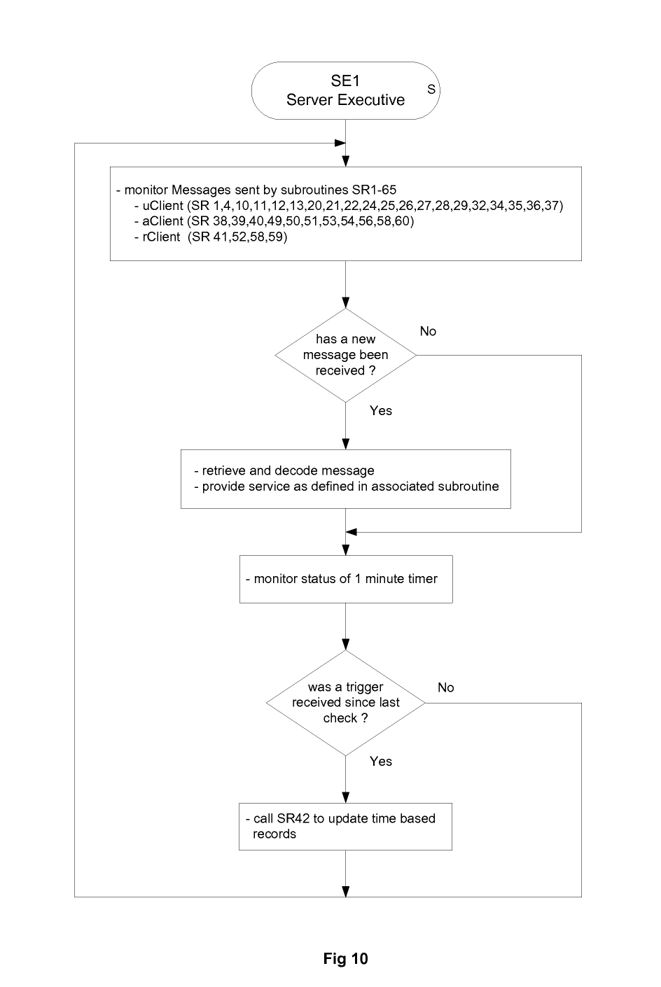

FIG. 11 discloses the Client Executive software flowchart.

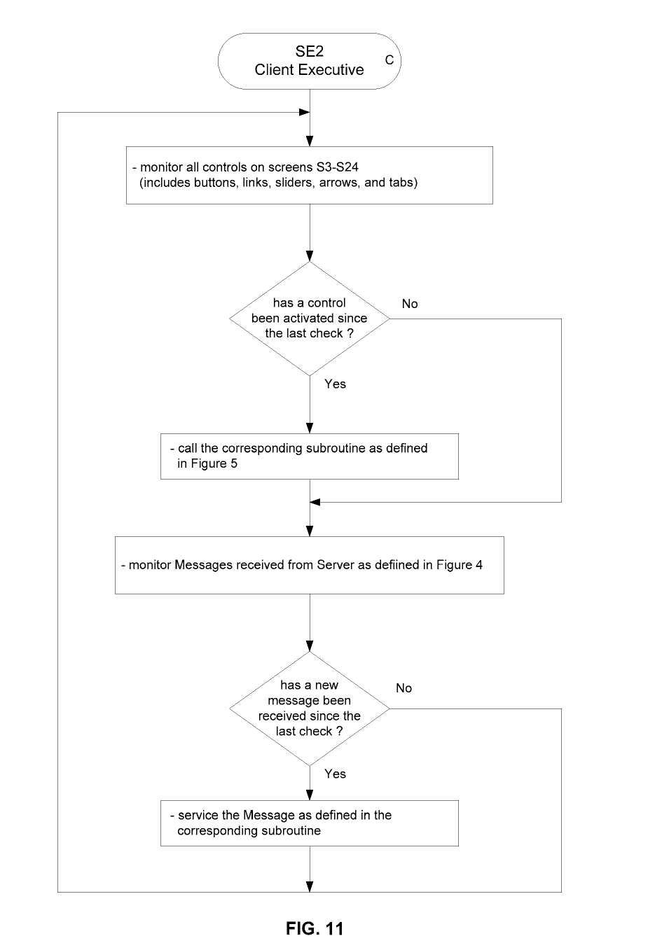

FIG. 12 discloses the flow chart for subroutine SR1.

FIG. 13 discloses the flow charts for subroutines SR2, SR3, SR5 & SR6.

FIG. 14 discloses the flow chart for subroutine SR4.

FIG. 15A discloses page 1 of the flow chart for subroutine SR7.

FIG. 15B discloses page 2 of the flow chart for subroutine SR7.

FIG. 16A discloses page 1 of the flow chart for subroutine SR8.

FIG. 16B discloses page 2 of the flow chart for subroutine SR8.

FIG. 17 discloses the flow chart for subroutine SR9.

FIG. 18A discloses page 1 of the flow chart for subroutine SR10.

FIG. 18B discloses page 2 of the flow chart for subroutine SR10.

FIG. 19A discloses page 1 of the flow chart for subroutine SR11.

FIG. 19B discloses page 2 of the flow chart for subroutine SR11.

FIG. 20A discloses page 1 of the flow chart for subroutine SR12.

FIG. 20B discloses page 2 of the flow chart for subroutine SR12.

FIG. 21A discloses page 1 of the flow chart for subroutine SR13.

FIG. 21B discloses page 2 of the flow chart for subroutine SR13.

FIG. 22 discloses the flow chart for subroutine SR14.

FIG. 23 discloses the flow charts for subroutines SR15, SR16 & SR17.

FIG. 24 discloses the flow chart for subroutine SR18.

FIG. 25 discloses the flow chart for subroutine SR19.

FIG. 26A discloses page 1 of the flow chart for subroutine SR20.

FIG. 26B discloses page 2 of the flow chart for subroutine SR20.

FIG. 27 discloses the flow chart for subroutine SR21.

FIG. 28A discloses page 1 of the flow chart for subroutine SR22.

FIG. 28B discloses page 2 of the flow chart for subroutine SR22.

FIG. 29 discloses the flow chart for subroutine SR24.

FIG. 30 discloses the flow chart for subroutine SR25.

FIG. 31 discloses the flow chart for subroutine SR26.

FIG. 32 discloses the flow chart for subroutine SR27.

FIG. 33 discloses the flow chart for subroutine SR28.

FIG. 34A discloses page 1 of the flow chart for subroutine SR29.

FIG. 34B discloses page 2 of the flow chart for subroutine SR29.

FIG. 35 discloses the flow charts for subroutines SR23, SR30, SR31 & SR33.

FIG. 36 discloses the flow chart for subroutine SR32.

FIG. 37 discloses the flow chart for subroutine SR34.

FIG. 38 discloses the flow chart for subroutine SR35.

FIG. 39 discloses the flow chart for subroutine SR36.

FIG. 40A discloses page 1 of the flow chart for subroutine SR37.

FIG. 40B discloses page 2 of the flow chart for subroutine SR37.

FIG. 41 discloses the flow chart for subroutine SR38.

FIG. 42A discloses page 1 of the flow chart for subroutine SR39.

FIG. 42B discloses page 2 of the flow chart for subroutine SR39.

FIG. 43 discloses the flow chart for subroutine SR40.

FIG. 44A discloses page 1 of the flow chart for subroutine SR42.

FIG. 44B discloses page 2 of the flow chart for subroutine SR42.

FIG. 44C discloses page 3 of the flow chart for subroutine SR42.

FIG. 44D discloses page 4 of the flow chart for subroutine SR42.

FIG. 44E discloses page 5 of the flow chart for subroutine SR42.

FIG. 45 discloses the flow chart for subroutine SR44.

FIG. 46 discloses the flow chart for subroutine SR45.

FIG. 47 discloses the flow chart for subroutines SR41 & SR46.

FIG. 48A discloses page 1 of the flow chart for subroutine SR47.

FIG. 48B discloses page 2 of the flow chart for subroutine SR47.

FIG. 48C discloses page 3 of the flow chart for subroutine SR47.

FIG. 49 discloses the flow chart for subroutine SR48.

FIG. 50 discloses the flow chart for subroutine SR50.

FIG. 51 discloses the flow chart for subroutine SR51.

FIG. 52 discloses the flow chart for subroutine SR52.

FIG. 53 discloses the flow chart for subroutine SR53.

FIG. 54 discloses the flow chart for subroutine SR54.

FIG. 55 discloses the flow charts for subroutines SR55 & SR57.

FIG. 56 discloses the flow chart for subroutine SR56.

FIG. 57 discloses the flow chart for subroutine SR58.

FIG. 58A discloses page 1 of the flow chart for subroutine SR59.

FIG. 58B discloses page 2 of the flow chart for subroutine SR59.

FIG. 59A discloses page 1 of the flow chart for subroutine SR60.

FIG. 59B discloses page 2 of the flow chart for subroutine SR60.

FIG. 59C discloses page 3 of the flow chart for subroutine SR60.

FIG. 60 discloses the flow chart for subroutine SR61.

FIG. 61 discloses the flow chart for subroutine SR62.

FIG. 62 discloses the flow chart for subroutine SR63.

FIG. 63A discloses page 1 of the flow chart for subroutine SR64.

FIG. 63B discloses page 2 of the flow chart for subroutine SR64.

FIG. 64 discloses the Introduction screen (S1).

FIG. 65 discloses the Guest Screen (S2).

FIG. 66 discloses the User Login Screen (S3).

FIG. 67 discloses the Home Page screen (S4).

FIG. 68 discloses the Registration screen (S5).

FIG. 69 discloses the Contest Intro—Closed Curtain screen (S6).

FIG. 70 discloses the Contest Intro—Open Curtain screen (S7).

FIG. 71 discloses the Entry Example screen (S8).

FIG. 72 discloses the View & Vote screen (S9).

FIG. 73 discloses the Contest Description screen (S10).

FIG. 74 discloses the Enter Contest screen (S11).

FIG. 75 discloses the Voting Ballot—Fixed Period screen (S12).

FIG. 76 discloses the Voting Ballot—Fixed Votes screen (S13).

FIG. 77 discloses the Member Account screen (S14).

FIG. 78 discloses the BizBuddy Account screen (S15).

FIG. 79 discloses the Judge Account screen (S16).

FIG. 80 discloses the Vote Credit Product Choices screen (S17).

FIG. 81 discloses the Bizzler Coupon screen (S18).

FIG. 82 discloses the Administrator Login screen (S19).

FIG. 83 discloses the Admin Database Access screen (S20).

FIG. 84 discloses the Admin Entry Assignment screen (S21).

FIG. 85 discloses the Admin Entry Review screen (S22).

FIG. 86 discloses the Reviewer Login screen (S23).

FIG. 87 discloses the Reviewer Controls screen (S24).

### DETAILED DESCRIPTION OF THE DRAWINGS

Some implementations of the invention are described in the sections below, consisting of;

### 1) Overview

### 2) System Components

### 3) Software Components

### 4) Operation

### Overview

The following example procedure (or method) can be used by web site Administrators to set-up the contests, establish guidelines, conduct the contests, generate advertising revenue, and distribute advertising revenue;
Reach agreement with Sponsor on advertising guidelines and cost
Generate the contest description and other guidelines used for creating contest entries
Announce contests and provide contest descriptions via web site
Receive contest entries from Members during submittal period
Review entries, reject entries with inappropriate material
Post approved entries on web site and start voting period
   Members can vote on their own entries
   Members can have their friends login as Judges or Members and vote on their entries
   Each voter can vote only once for any given entry
   Each voter must vote for the same number of entries in any given contest. However, the number of votes required from each voter can vary from contest to contest
Distribute prizes to contestants based on the number of votes received
Retain an adequate percentage of the advertising proceeds to cover operational expenses and profit

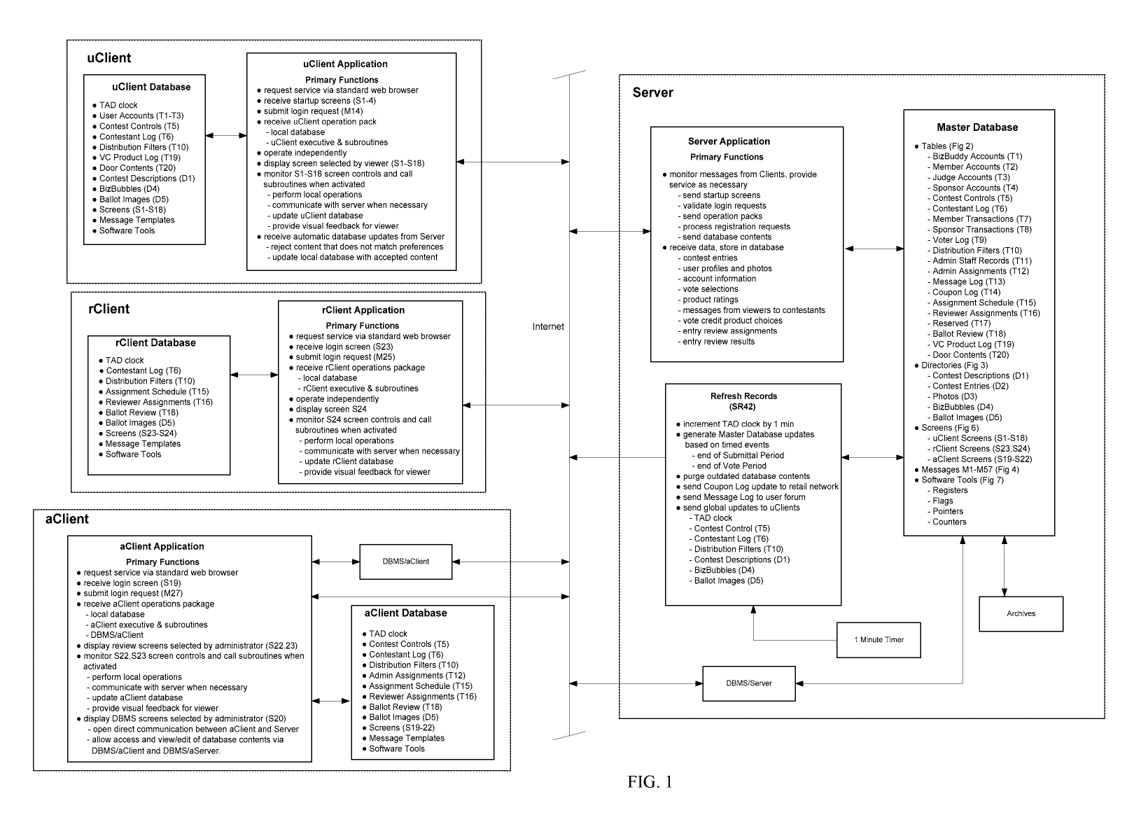

### System Components (Refer to FIG. 1)

### Server

The Server performs a number of functions related to contest set-up, operation, and maintenance, including; 1) monitor messages from Clients, 2) validate login requests from Clients, 3) provide start-up software, screens and Database components to Clients after a successful login, 4) provide frequent and automatic Database updates to uClients, 5) perform appropriate actions in response to messages from Client computers, 6) provide a means for Administrators to access and manage the Master Database using embedded DBMS components for the Server and aClient (DBMS/Server and DBMS/aClient).

uClient

The uClients are used by Judges and Members to, 1) login with secured password protection, 2) browse web site screens, 3) view general information 4) view specific instructions and examples related to each contest, 5) view contest entries from all contestants, 6) receive additional product information, games, and prizes from voting ballots, 7) vote on contest entries, 8) receive vote credits which can be used to purchase products, and 9) establish and maintain personal profiles and financial accounts.

In addition to the above, Members can; 1) submit contest entries, 2) provide a personal photo, profile, stories and messages to the voters to be displayed with their entry, 3) receive cash proceeds or other prizes based on voting results, 4) add a second person (BizBuddy) to their account to act as a “muse” or inspiration for creating their entries, add to their story, and share in the cash proceeds, and 5) receive messages back from the voters.

The uClients are used by Guests, without a login requirement, to view reference information, contest descriptions, contest entries and voting ballots. Guests can register as a Member or Judge if they want to participate in the contest activities and receive voting credits and prizes.

aClient

The aClients are used by Administrators to manage contest operations. The Server provides aClient computers with software applications and tools to allow Administrators to; 1) login with a highly secured login method, 2) update the Database with new contests, 3) define contest operating parameters, 4) set contest start and stop times for entry submittal and voting, 5) conduct preliminary and final reviews on contest entries and accept or reject contest entries, before posting, based on censoring guidelines which can vary from contest to contest, 6) assign contest review efforts to Reviewers to assist in checking large volumes of entries, and 7) maintain accounts and records for Sponsors, Members, BizBuddies, and Judges.

rClient

rClients are used by Reviewers (Judges or Members working under special contracts) to assist Administrators in checking contest entries for inappropriate material. The Server provides rClients with software applications and tools to allow Reviewers to: 1) login with secured password protection, 2) receive reviewing tools, assignments and contest entries, 3) conduct a preliminary review of contest entries, 4) accept or reject each contest entry based on censoring guidelines from the Sponsor, and 5) submit their review to an Administrator for final check and submittal.

### Database

The Master Database and primary components of the Database Management System (DBMS/Server) are located on the Server. Each of the Clients has its own local Database to work from, which is a subset of the Master Database. The aClient has a DBMS component (DBMS/aClient) which interacts with DBMS/Server to provide Administrators with direct access to Master Database content.

The Database content is described in simple terms (e.g. tables, directories) and without going into the complexity of Database structure which varies between Database types. However, this method of description is not intended to limit the means of implementation, since several types of commercial Database solutions, each with their own unique methods, tools, and terminology, could be used with some implementations.

Administrators are provided with direct access to Master Database content by using conventional network communications and DBMS software to facilitate seamless communication between the Server and aClient computers. Database usage is described in terms of viewing, editing and saving content, without going into the details of conventional DBMS operations, such as; setting priorities, limiting access, resolving access conflicts, security, encoding, corrupt data, file backup, file recovery, etc.

### Computers

Some implementations may use small volumes of Server computers (1 computer or multiple computers operating as a single computer, e.g., a cloud system) and medium volumes of aClient and rClient computers (1,000s) in order to handle large volumes of uClient computers (millions). The underlying objective of uClient operation is to maximize operational efficiency and response time for users and minimize Server bandwidth requirements by; 1) setting up uClient computers to operate independently (to the greatest extent possible), 2) sending out common updates globally from the Server and letting the Clients accept or reject content based on local preference settings, and 3) using embedded links instead of actual files to reduce bandwidth requirements when displaying video clips on the uClient computers.

The uClient can be hosted on multiple computer types and brands, including; PC computers, Apple computers, mobile devices and tablet computers.

### Software Components

Some implementations can include several software components, all of which reside as master files on the Server (e.g., stored in a computer readable medium for execution by one or more processors). The Server downloads appropriate components to uClient, aClient and rClient computers during 3 types of transfers; 1) initial login, 2) updates, and 3) upon request. In addition, aClient computers have direct access to Database content via standard network communications.

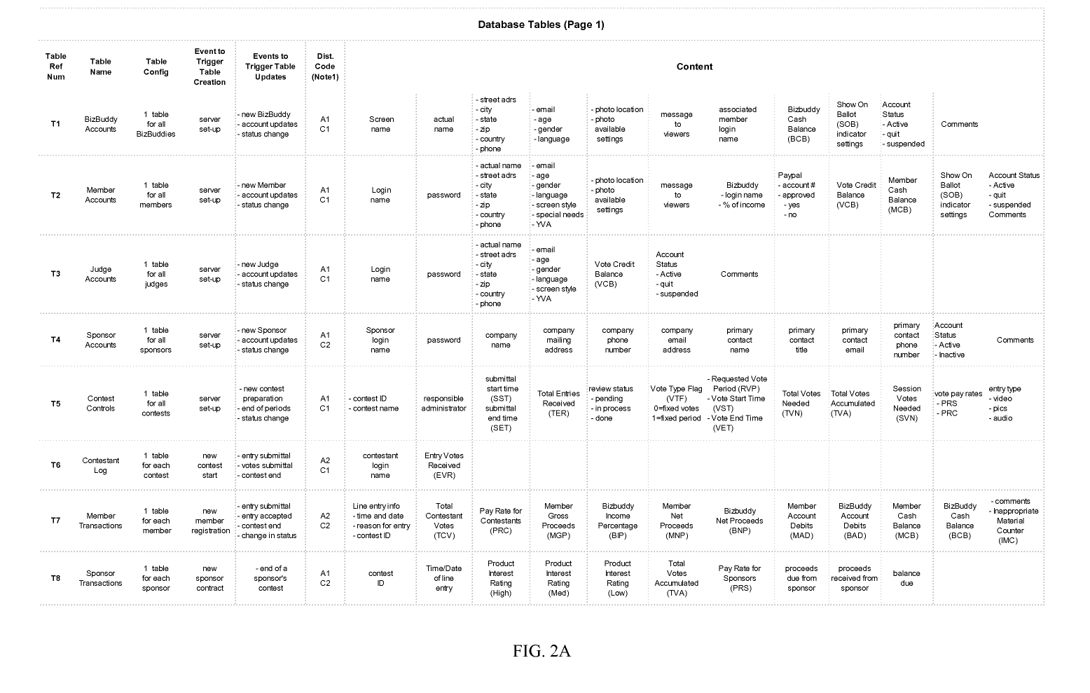

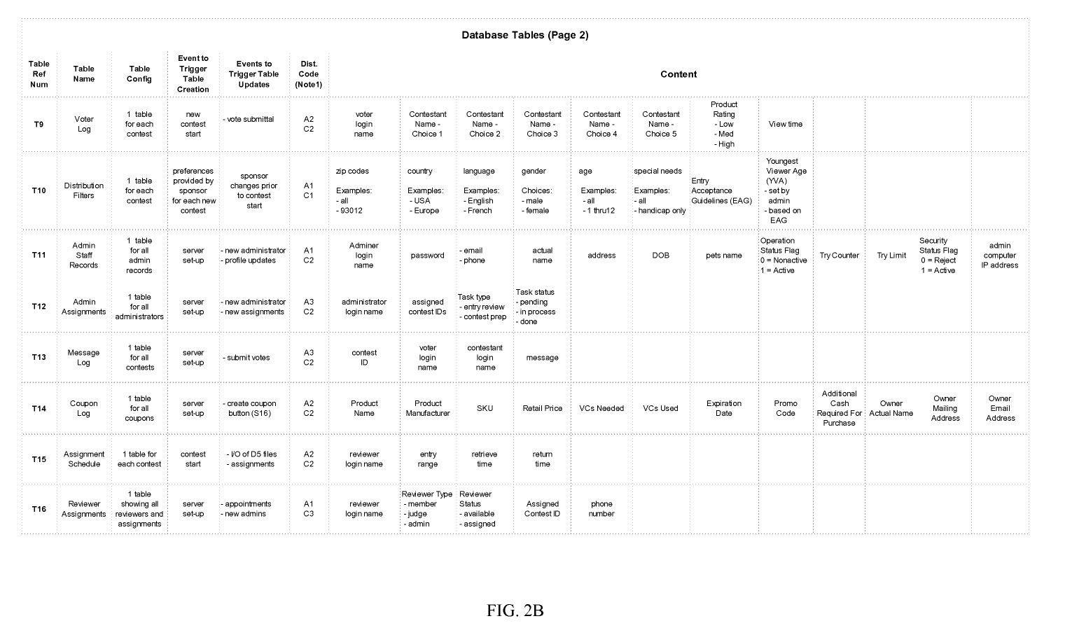

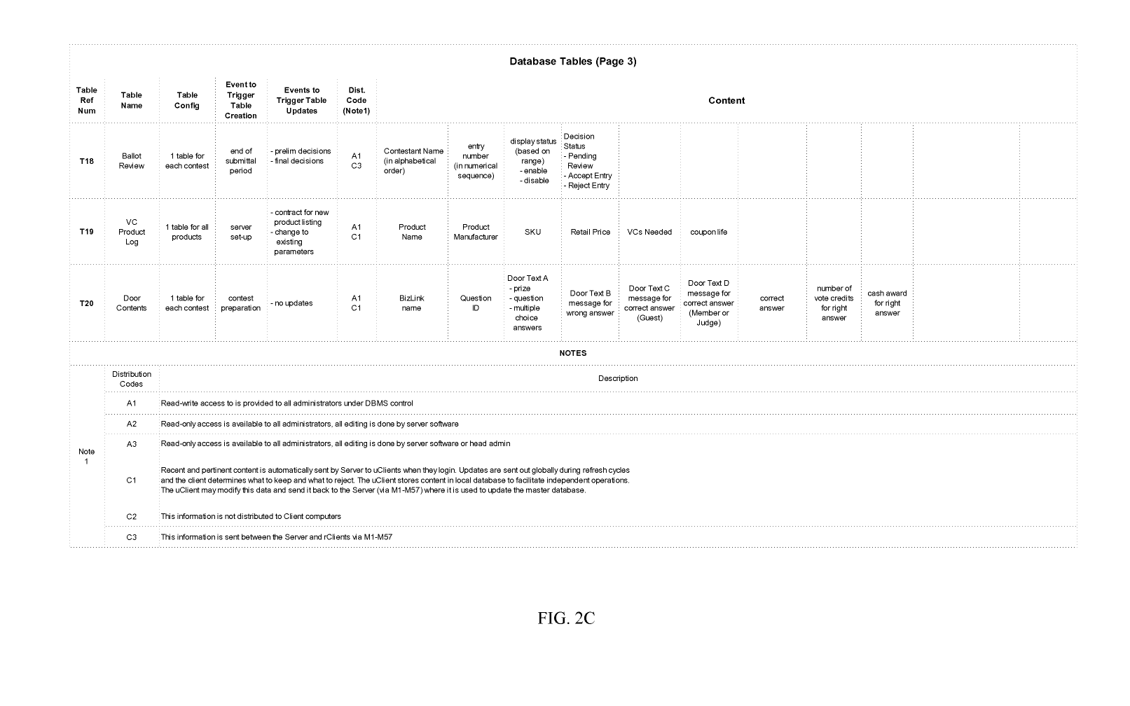

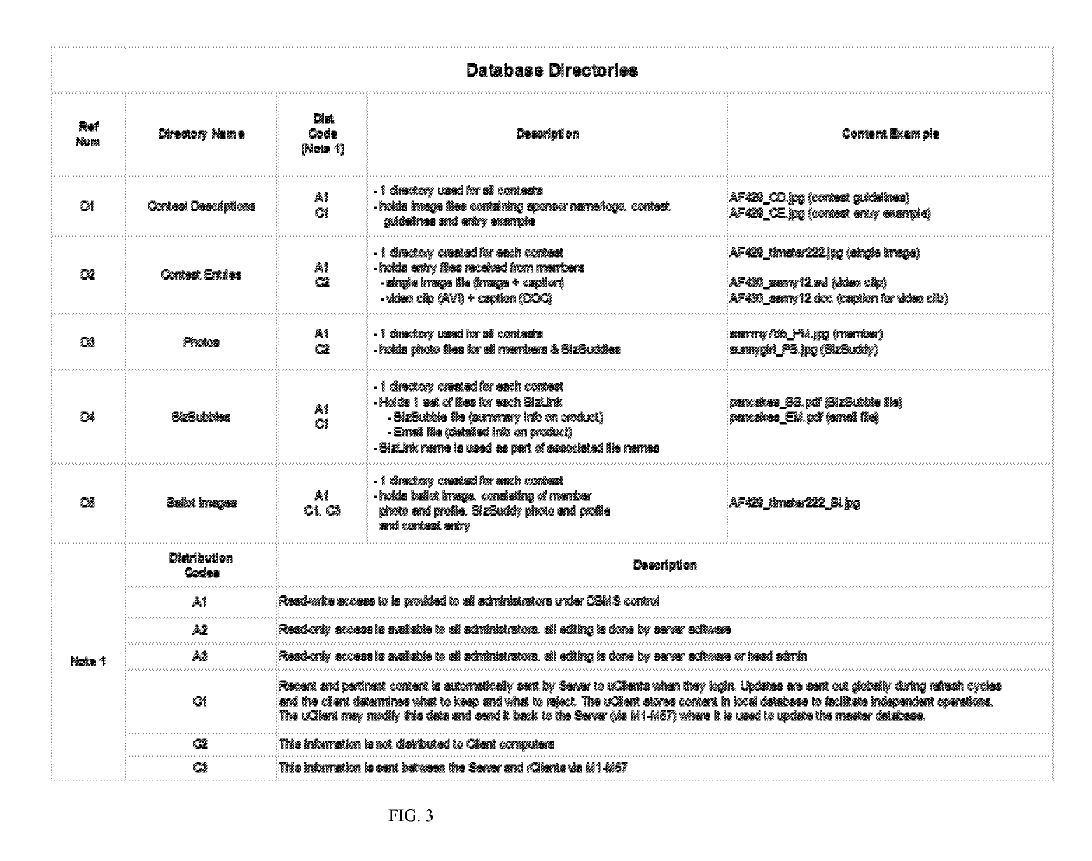

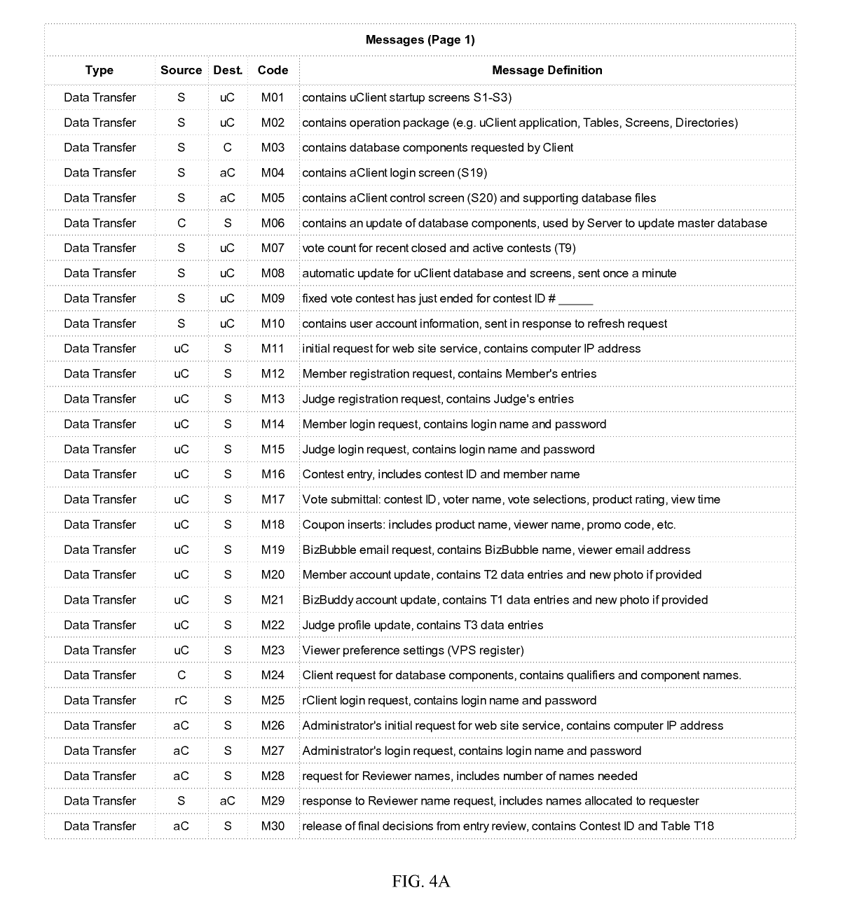

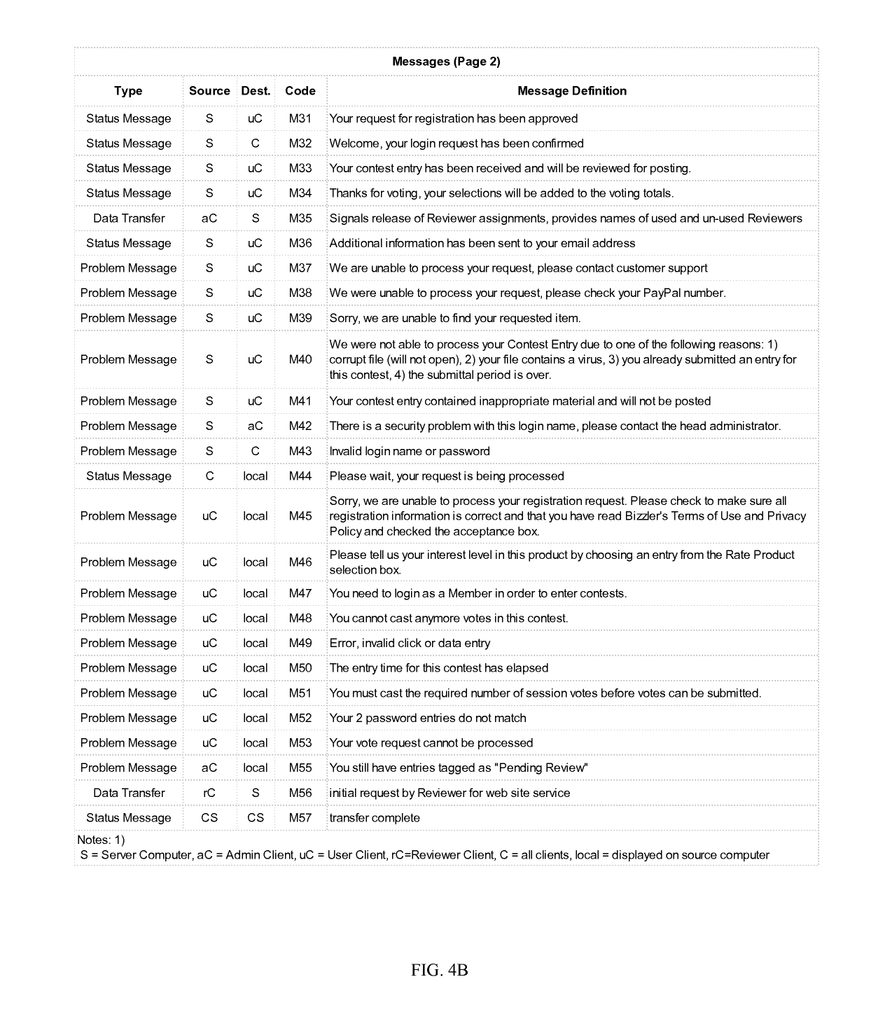

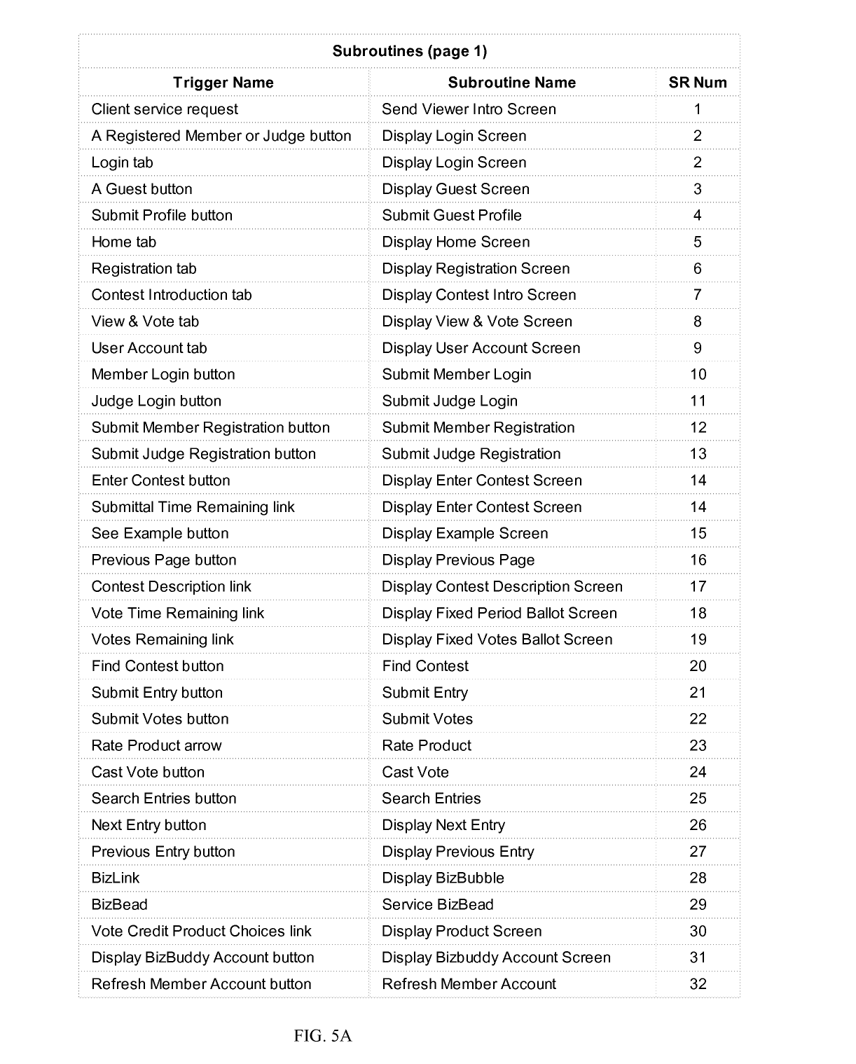

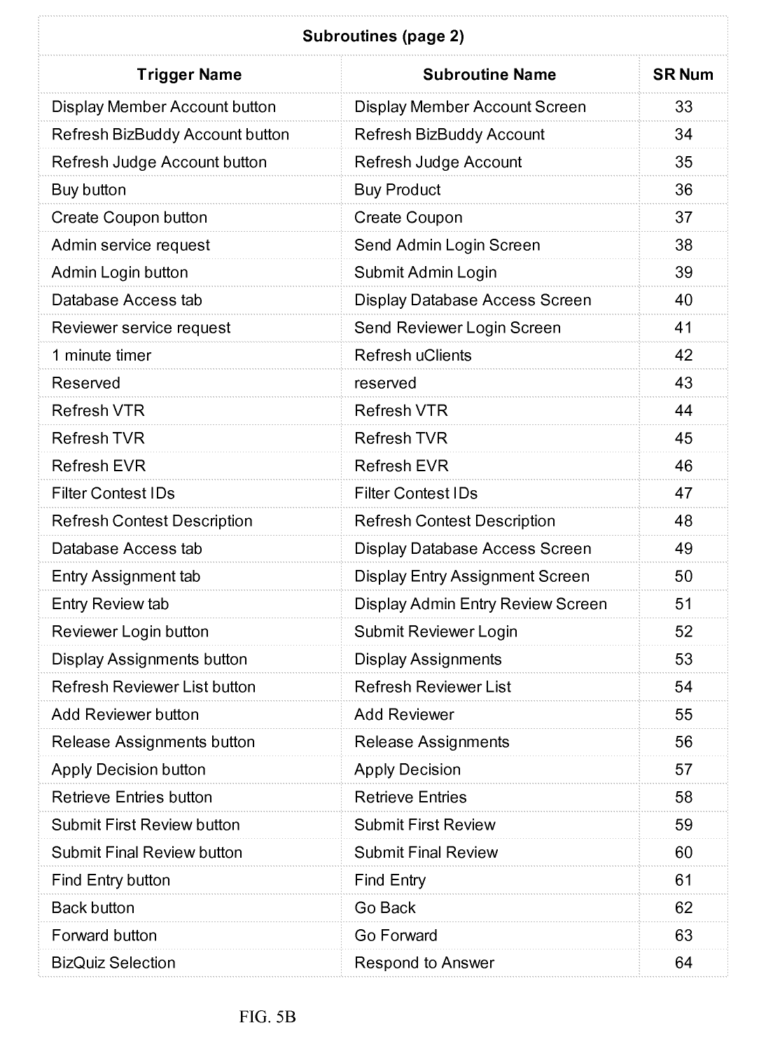

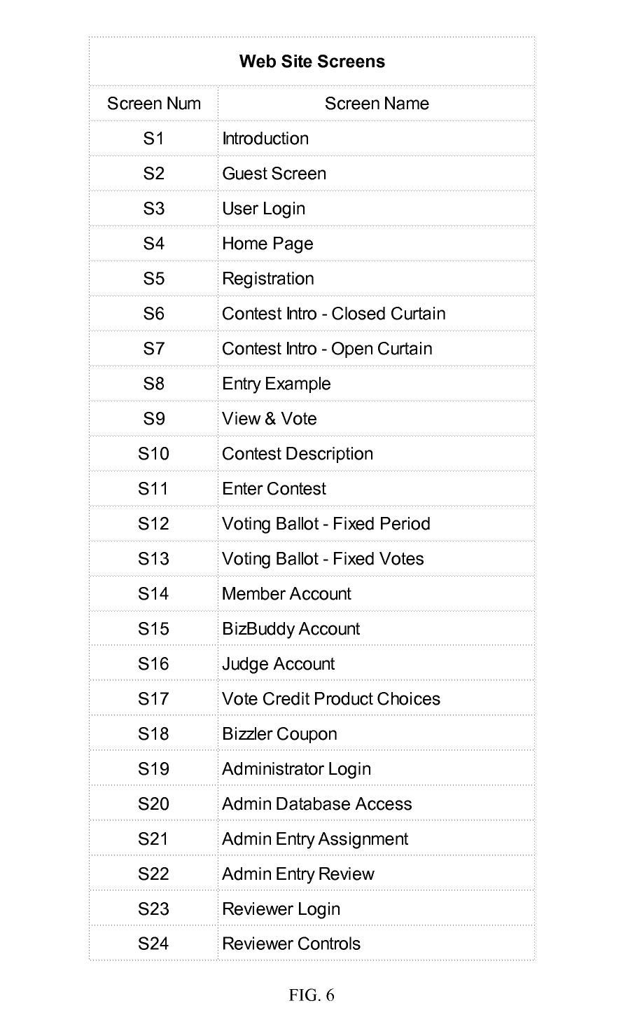

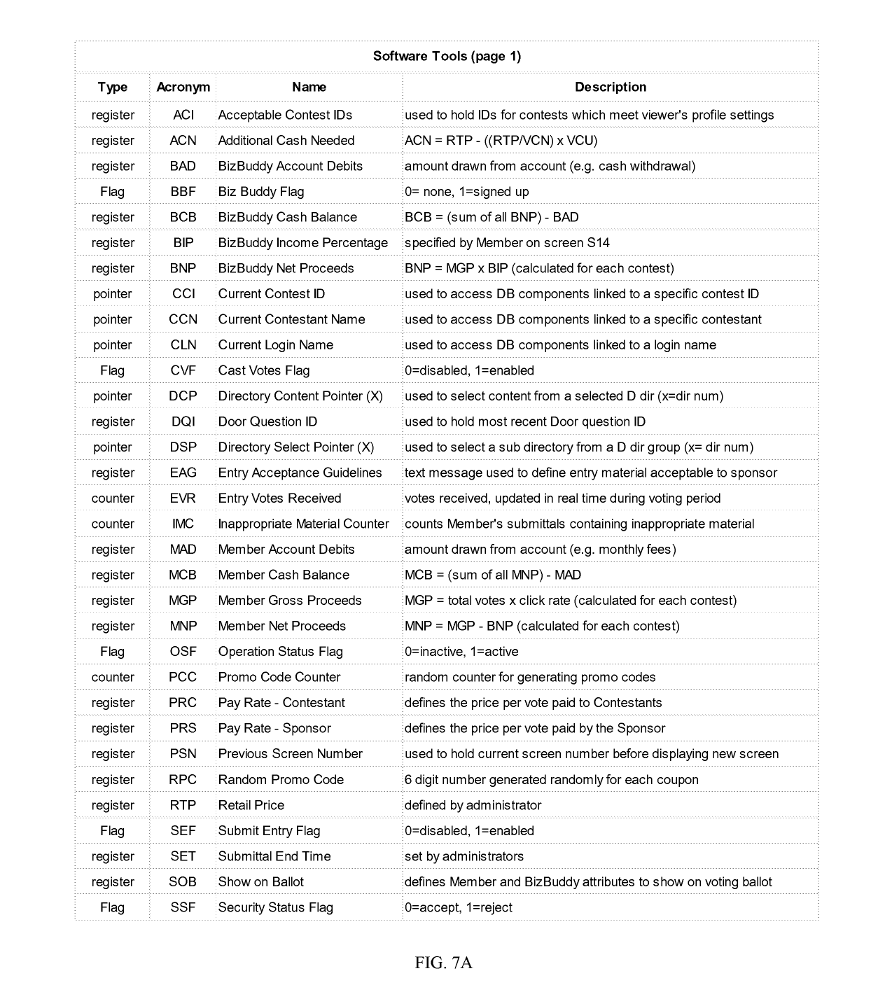

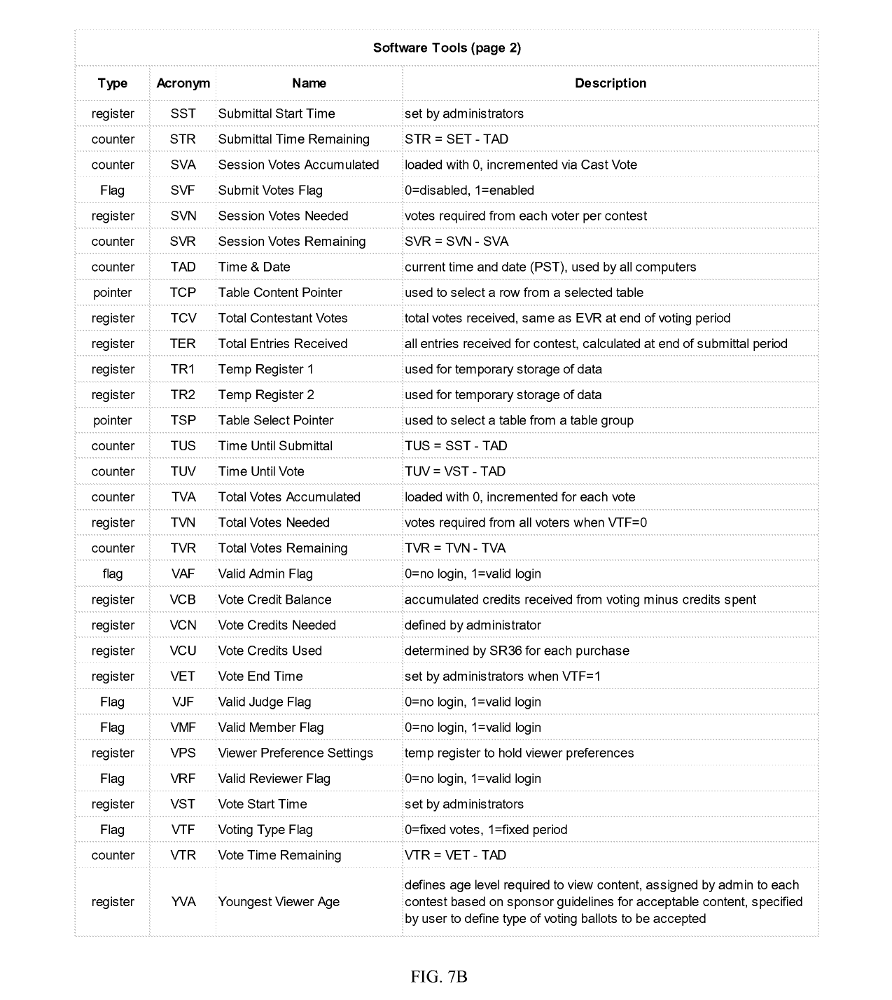

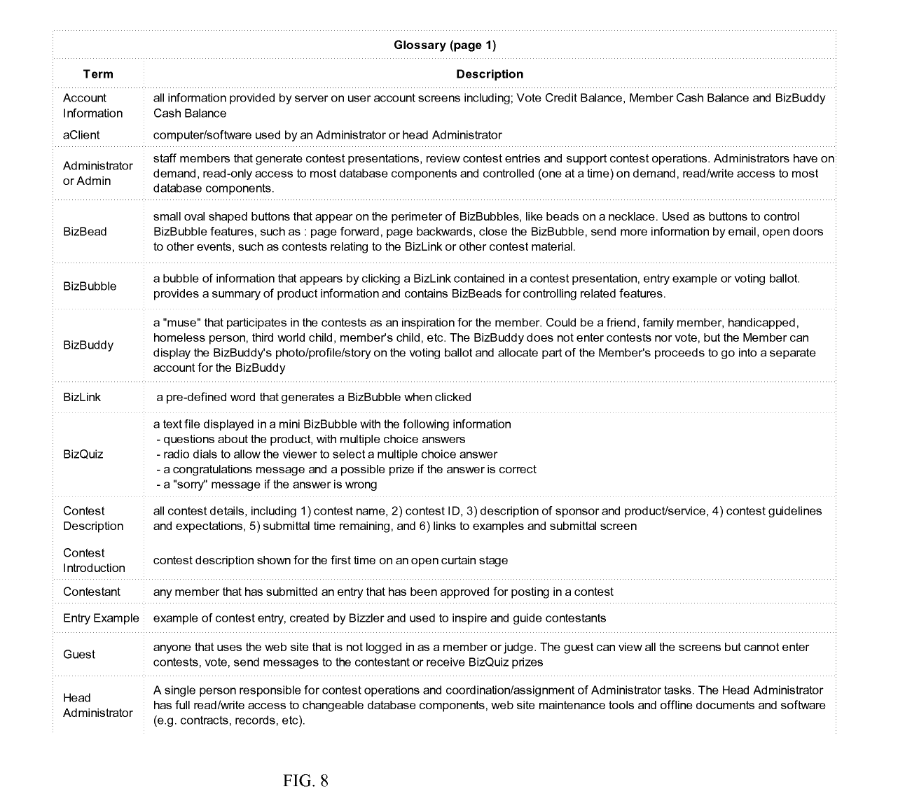

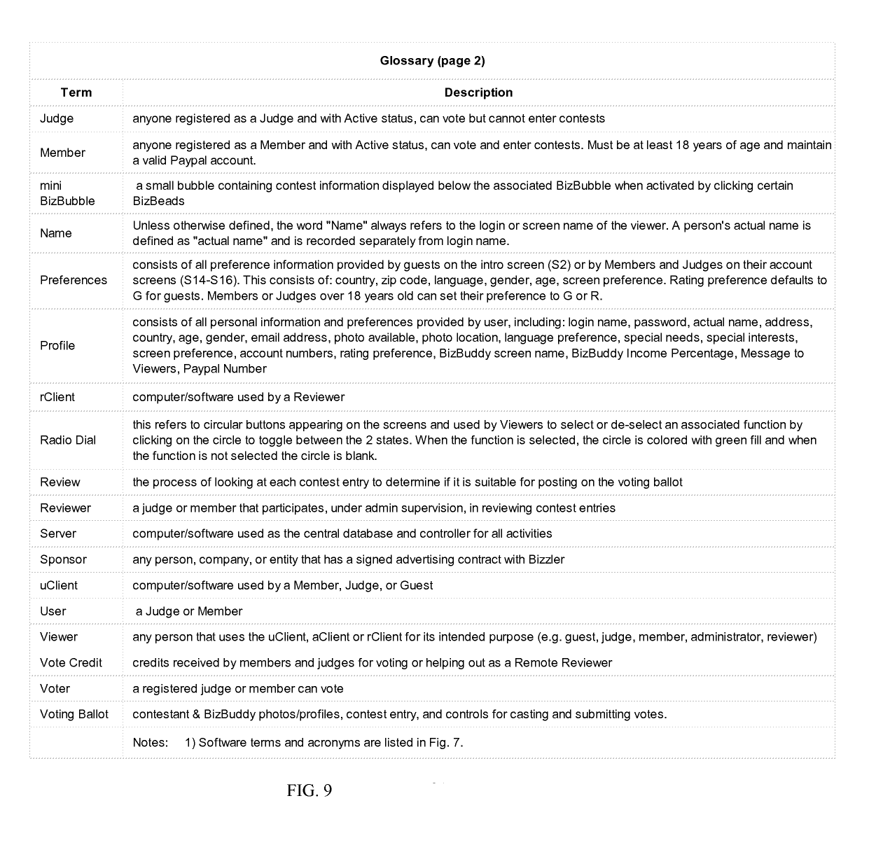

The following provides a list of the Figs. used to define the software components;
FIGS. 2A, 2B, 2C—Database Tables (T1-T20)
FIG. 3—Database Directories (D1-D5)
FIGS. 4A, 4B—Messages (M1-M57)
FIGS. 5A, 5B—Subroutine Listing (SR1-SR63)
FIG. 6—Screen Listing (S1-S24)
FIGS. 7A, 7B—Software Tools
FIGS. 8, 9—Glossary

### Database Tables (T1-T20)

The Database tables are created and maintained by Administrators and Server software. They are used primarily to keep track of user account information and define contest variables, such as; submittal start/stop time, voting start/stop time, contest type, and contest distribution. Some of the tables are structured as single tables used for all contests, while others require a separate table for each contest. FIGS. 2A, 2B and 2C provide an overview of the table structure, including: reference number, name, configuration, event to trigger table generation, events to trigger table updates, distribution method and content. The following provides a brief description of each Database table.

### Table T1—BizBuddy Accounts

This is a single table used to hold the profile, account, and status information for all BizBuddy (muse) participants. Since BizBuddies aren't always able to “log in” they are not assigned a login name. Instead, they are assigned a “screen” name instead to use like a login name for identification purposes. The Member associated with the BizBuddy can establish and update the BizBuddy profile via S15 while logged into the system. The information is used for internal accounting, future reference for the Member, and profile display on the voting ballots [S13]. The associated Member is responsible for providing accurate information, keeping the BizBuddy informed on contest results, and assisting the company with occasional disbursement of accumulated funds to the BizBuddy using offline methods (e.g. Western Union cash transfer).

The account can be terminated by either Administrators or the associated Member for a variety of reasons. This causes the Account Status flag to change from Active to Inactive, but the information is left intact. The Comments column can be used to record the conditions surrounding termination for future reference.

### Table T2—Member Accounts

This is a single table used to hold the profile, account, and status information for all Members. The Members can establish and update this information via S14 while logged into the system. The information is used for internal accounting, future reference for the Member, and profile display on the voting ballots [S12, S13]. The account can be terminated by either Administrators or the Member for a variety of reasons. This causes the Account Status flag to change from Active to Inactive, but the information is left intact. The Comments column can be used to record the conditions surrounding termination for future reference (e.g. suspended for too many entry rejects due to inappropriate material).

### Table T3—Judge Accounts

This is a single table used to hold the profile, account, and status information for all Judges. The Judges can establish and update this information via S16 while logged into the system. The information is used for internal accounting and future reference for the Judge. The account can be terminated by either Administrators or Judges for a variety of reasons. This causes the Account Status flag to change from Active to Inactive, but the information is left intact. The Comments column can be used to record the conditions surrounding termination for future reference (e.g. changed from Judge to Member).

### Table T4—Sponsor Accounts

This is a single table used to hold profile and status information for all Sponsors. The Administrators enter the information from internal contract documents using DBMS controls [S20] to access the correct table and enter the data. The information is used for internal records and accounting purposes. The account can be terminated by either Administrators or Sponsors for a variety of reasons. This causes the Account Status flag to change from Active to Inactive, but the information is left intact. The Comments column can be used to record the conditions surrounding termination for future reference (e.g. legal issues).

### Table T5—Contest Controls

This is a single table used to hold the key operating parameters and status for all contests. This table is updated by Administrators when preparing and running each contest and updated by Server software at the end of each submittal period (inserts total entries received) and voting period (inserts total votes accumulated). The information is used by the Server and uClients, primarily as a reference for scheduling and running the contests.

### Table T6—Contestant Log

A unique Table 6 is created by Server software for each contest when the contest is started, using the contest ID as part of the file name. This table is used to keep track of contestant names and the number of entry votes received for each entry. The number of entry votes received (EVR) for each contestant is derived from Table 9 and updated in real time as the votes come in. The Server pulls the latest EVR information prior to sending out each uClient update so Viewers will see the latest voting results for each contestant as they view and evaluate the contest entries.

### Table T7—Member Transactions

A unique Table 7 is created for each Member during registration, using the Member's name as part of the file name. This table is used primarily to keep track of the Member's transactions (contest submittals, vote counts, pay rates, credits, debits, etc.) and store detailed information which is monitored by Administrators but not provided on screens for Members. The data is used for generating financial reports (e.g. tax statements) and supplying summary information to other tables (e.g. MCB to Table 2).

### Table T8—Sponsor Transactions

A unique Table 8 is created for each Sponsor during sign-up, using the Sponsor's name as part of the file name. This table is used primarily to keep track of contest results (e.g. total votes, product ratings), Sponsor pay rates (PRS) rates, and associated transactions (fees received, balance due, etc.). The contest results are inserted by the Server after the associated contest is finished and the other information is gathered from offline sources (e.g. contracts, bank transactions) and entered by Administrators. The information is used by the Server to perform off line analysis and generate financial and statistical reports for the Sponsor.

### Table T9—Voter Log

A unique Table 9 is created for each contest when the contest is started, using the contest ID as part of the file name. This table is used to record the voter names, the voting choices they make, the product rating choice they make, and the amount of time they spend looking at the voting ballots. The data is inserted by the Server as the votes come in. The information is used by Table 6 to calculate EVR, by Table 8 to calculate TVR and product ratings, and for offline analysis of view time.

### Table T10—Distribution Filters

A unique Table 10 is created for each contest when the contest is prepared, using the contest ID as part of the file name. This table is used to store distribution guidelines received from the Sponsor which define who should participate in the contest (e.g. geographic location, age, gender, language) custom suitability guidelines for the contest entries (e.g. contest entries may contain R rated material, except for profanity). Administrators use the Sponsor written guidelines to determine the Youngest Viewer Age (YVA) for the contest (e.g. age 18) and this is entered as an additional filter parameter.

The distribution parameters are sent to uClient computers and used as a filter to accept or reject contest material which is received from the Server via global transmissions. The Sponsor suitability guidelines are defined for the contestants in the Contest Introduction and used by Administrators and Reviewers during the review period. Any entry that does not meet the Sponsor's guidelines is rejected prior to distribution.

### Table T11—Administrator Staff Records

This is a single table used to hold the personal account information for all Administrators (e.g. name, address, age, gender, status) and to support added security measures related to Administrator login (e.g. Administrator's IP address and “try counter”). The try counter counts the number of times an Administrator fails to get the correct password and locks out the associated IP address and user name if a predetermined threshold is exceeded. The block can be lifted by the head Administrator after a phone conversation with the blocked Administrator.

This table is updated each time a new Administrator is added or provides updated information. The DBMS limits access to cells that are pertinent to the login name (e.g. an administrator can view and edit their own password but not others).

### Table T12—Administrator Assignments

This is a single table used to define Administrator responsibilities for contest support efforts, such as preparation of contest description material and review of contest entries. The head Administrator enters the Administrator login names, assigned contest IDs, task type and status. For all assignment types, except entry review, Administrators use conventional software applications and DBMS tools [S20] to access the Database and perform the assignments.

For entry review tasks, screen S21 is used. When an Administrator logs on to an aClient computer, the Server uses the login name to find the associated Contest IDs in T12 and populates the Contest ID drop down menu on S21 so that each Administrator will have their own unique set of review assignments already defined right after they open the screen.

### Table T13—Message Log

This is a single table used to store short text messages written by voters to contestants during the voting period. This table contains the contest ID, contestant name, voter name, and message. The messages are automatically sent to contestants or user forums at the end of each contest by Server software. This table is updated automatically by Server software and monitored by the Head Administrator.

### Table T14—Coupon Log

This is a single table used to store details associated with the coupons generated by Judges and Members after accumulating a sufficient number of voting credits. This table is automatically distributed to participating retail networks after each update, allowing retailers to validate coupons at the time of redemption. This table is maintained by the Server software and made available to Administrators as read-only information.

### Table T15—Assignment Schedule

A unique Table 15 with no data entries is created for each contest when the contest is started, using the contest ID as part of the file name. The table is used to store review assignments made by Administrators and provide the latest status on assignment progress. The Administrator fills in the blanks (via S21.12) to create part of the table and the Server provides entries to the Retrieve Time and Return Time entry blanks as the reviews are processed. The Administrator can retrieve the table, monitor progress, and make changes if necessary to make sure the jobs get done in a timely manner.

### Table T16—Review Assignments

This is a single table used to hold profile information on Reviewers, including; Reviewer name, Reviewer type (i.e. Judge, Member, or Administrator) availability, assigned contest IDs, and phone number. Names of available Reviewers are pulled from this table and sent to aClients by the Server upon request by Administrators. The sent names are tagged with “assigned” status until released by the aClient, either immediately (if the name is not actually used) or sometime later after an assignment is completed. When an assignment is made, the phone number is used to send a text message to the Reviewer indicating that they have an assignment pending. This table is set up, monitored, and maintained by the Server software and head Administrator.

### Table T17—Reserved

### Table T18—Ballot Review

A unique Table 18 is created for each contest at the end of the submittal period, using the contest ID as a part of the file name. This table holds all information related to review of contest entries, consisting of; contestant names, entry sequence number, display status flag, and decision status (i.e. pending review, accepted entry, or rejected entry). The contestant names and entry sequence numbers are defined by Server software after reviewing and sorting the contents of D5. The display status column is used to define which entries are displayed for each Reviewer, allowing entries from a single contest to be split between multiple Reviewers. The decision status column holds the results of the review. Once all entries have a decision of either accepted or rejected, the table can be used by Server software to discard rejected entries and enable posting of accepted entries.

### Table T19—VC Product Log

This is a single table used to hold information on products offered for purchase with vote credits. The contents include product name, manufacturer, SKU, retail price, VCs needed, and coupon life for each product offering. The data comes from external sources (retailers, distributers) and is entered or downloaded to Table 19 by Administrators. The data is displayed for the viewer when S17 is selected.

### Table T20—Door Contents

A unique Table 20 is created for each contest and used to hold the questions, answers, select buttons, and messages that are displayed when BizBead Door 1 and Door 2 buttons [S13] are activated. This material is developed by Administrators during the contest preparation phase and downloaded to the Server when complete.

### Database Directories

The directories defined in FIG. 3 are created by the Server software and used to hold raw entries, processed entries (i.e. Ballot Images), Member and BizBuddy photos, and product material for display on the web site. Some of the directories are structured as a single directory to use for all contests, while others are structured as a directory type with a subdirectory dedicated to each contest. A brief description of each is provided below;

### Directory D1—Contest Descriptions

D1 is a single directory used to hold contest descriptions for all contests. This directory is updated each time a new contest is added by Administrators. The latest content is filtered and distributed to uClient computers during login and global updates are sent out during each uClient refresh cycle.

### Directory D2—Contest Entries

A D2 subdirectory is created for each contest when the contest is started, using the contest ID as a part of the subdirectory name. These subdirectories are used to hold the entry images or video links & captions received from contestants. These subdirectories are used only for storage and are not distributed to uClient or aClient computers. The Sever software draws contents from these subdirectories when building up the corresponding Ballot Images (D5), which contain the entry files, Member/BizBuddy profiles and photos, and voting ballot templates.

### Directory D3—Photos

D3 is a single directory used to hold photos for all Members and BizBuddies. This directory is updated each time a new Member or BizBuddy photo is added or changed.

### Directory D4—BizBubbles

A D4 subdirectory is created for each contest when the contest is started, using the contest ID as a part of the subdirectory name. The D4 subdirectories are used to hold boilerplate product information (both summarized and detailed) associated with each contest. The D4 subdirectories associated with each active contest are distributed to all uClient computers during login and updates are sent out during each uClient refresh cycle. The contestants can embed BizLinks in their entries which will allow the summary product information to be displayed in a BizBubble [S13.31] when the associated BizLink is activated. This feature allows contestants to focus on creative advertising without getting involved with product details and allows the voter to learn more about the advertised product and receive consistent and accurate product information in summarized and/or detailed form.

The BizBubbles have buttons embedded within the rim of the bubble called BizBeads [S13.25-30]. The BizBeads allow the viewer to trigger additional actions. The X button [S1328] closes the screen, the Send email button [S13.25] causes the detailed product information to be sent to the viewer's email address, the page buttons [S13.27,29] allow the viewer to scroll through pages of summary information, and the Door buttons [S13.26,30] cause a mini BizBubble to be displayed [S13.32] with text and links [S13.33] provided by Table T20. The text is used to ask questions related to the product and the links are used to send the viewer's response back to the Server. The graphics for the BizBubbles, BizBeads and BizQuiz is provided as part of the Voting Ballot template.

### Directory D5—Ballot Images

A D5 subdirectory is created for each contest, when the submittal period is over, using the contest ID as a part of the subdirectory name. The D5 subdirectories are used to hold the processed image files (Ballot Images) that are inserted in the dynamic section of the voting ballots. Each file represents one entry and is comprised of the following components: entry image or video link received from contestant (from D1), Member profile (from T2) and photo (from D3), and BizBuddy profile (from T1) and photo (from D3). The D5 subdirectories associated with each active contest are reviewed and then distributed to all uClient computers during login. Updates are sent out globally during each uClient refresh cycle.

### Messages

A standardized set of codes and associated messages are used to facilitate communication between the Server and Client computers. In some cases the codes are used to request information, provide status, or identify data transmitted with the message. In other cases, the messages are displayed on the screen to inform the Viewer of errors, problems, or status with respect to the current operation. The message type, source computer, destination computer, message code, and message definition are provided in FIGS. 4A and 4B.

### Screen Listing

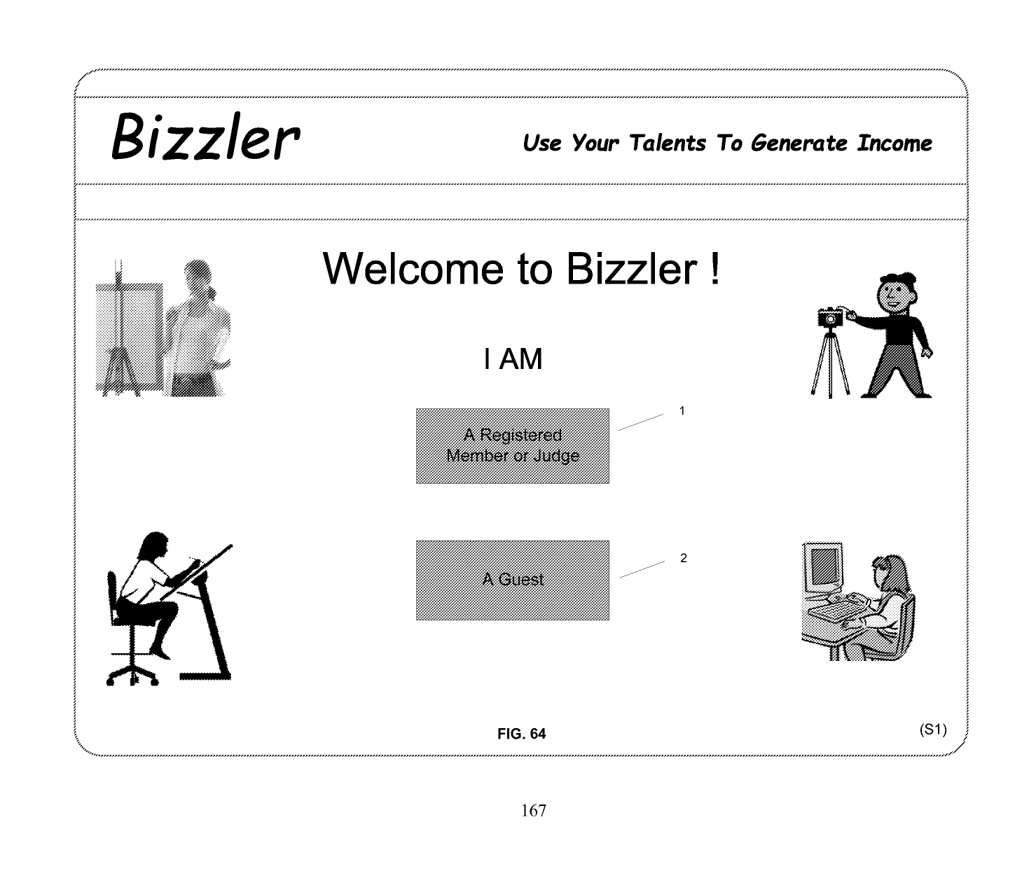

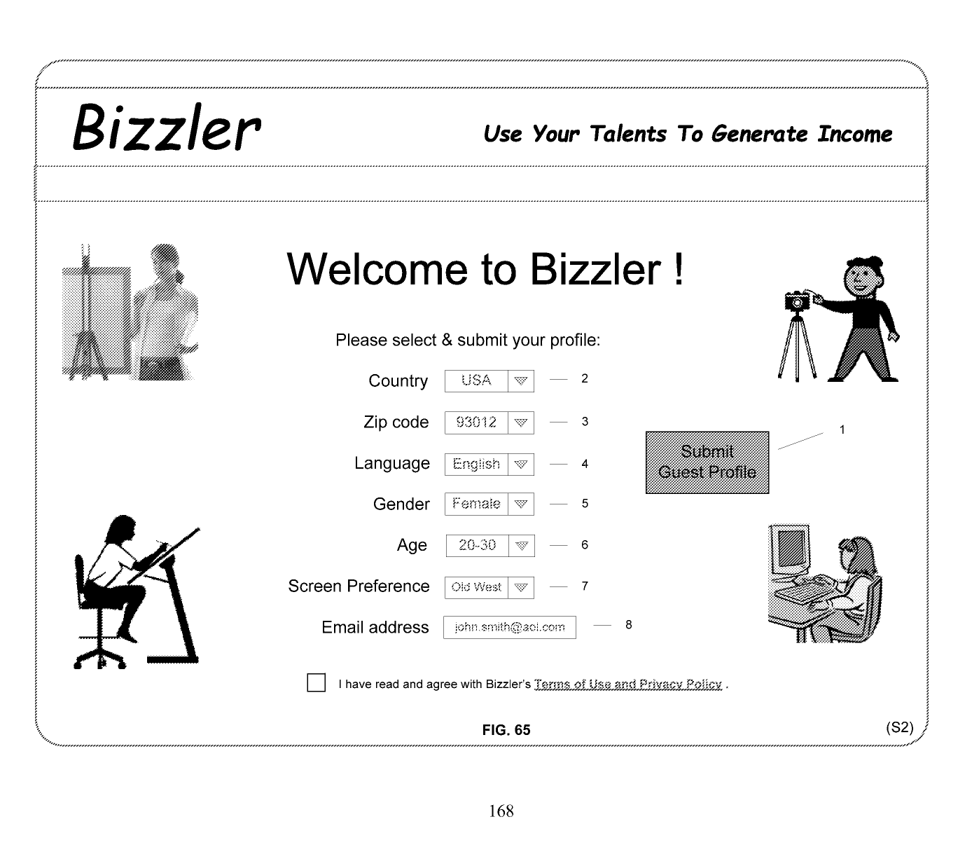

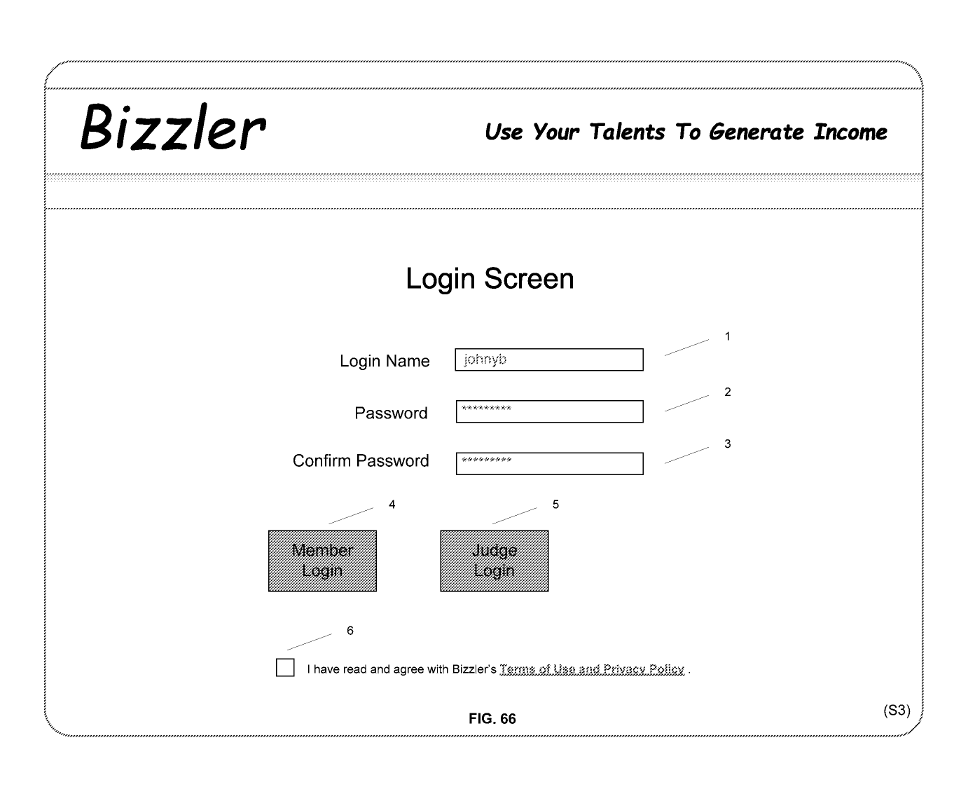

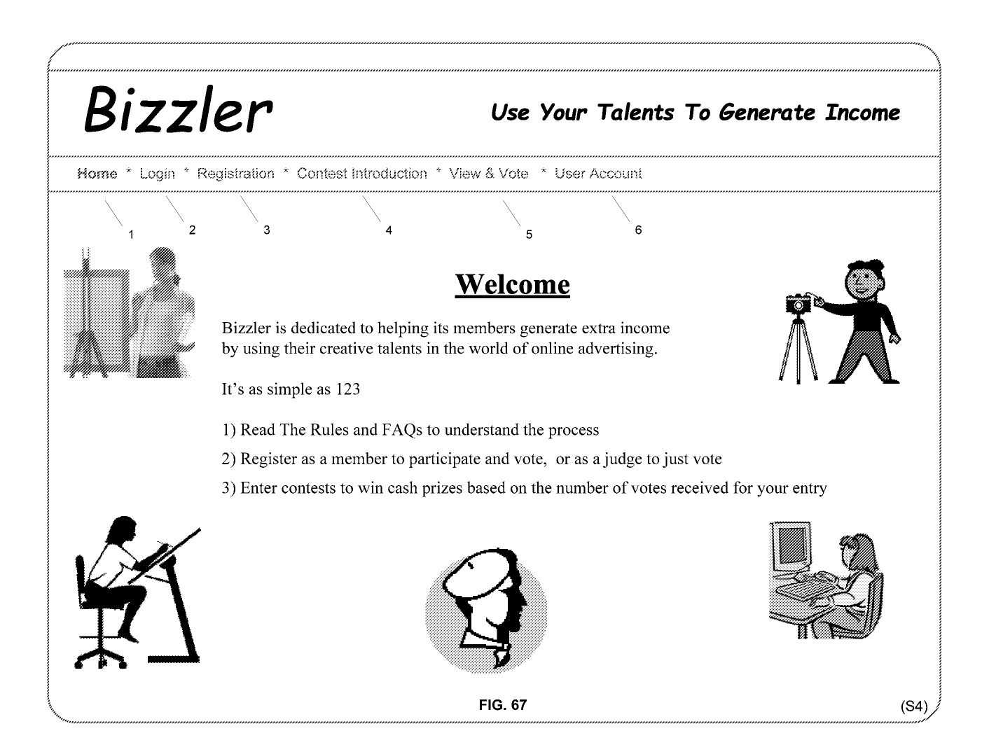

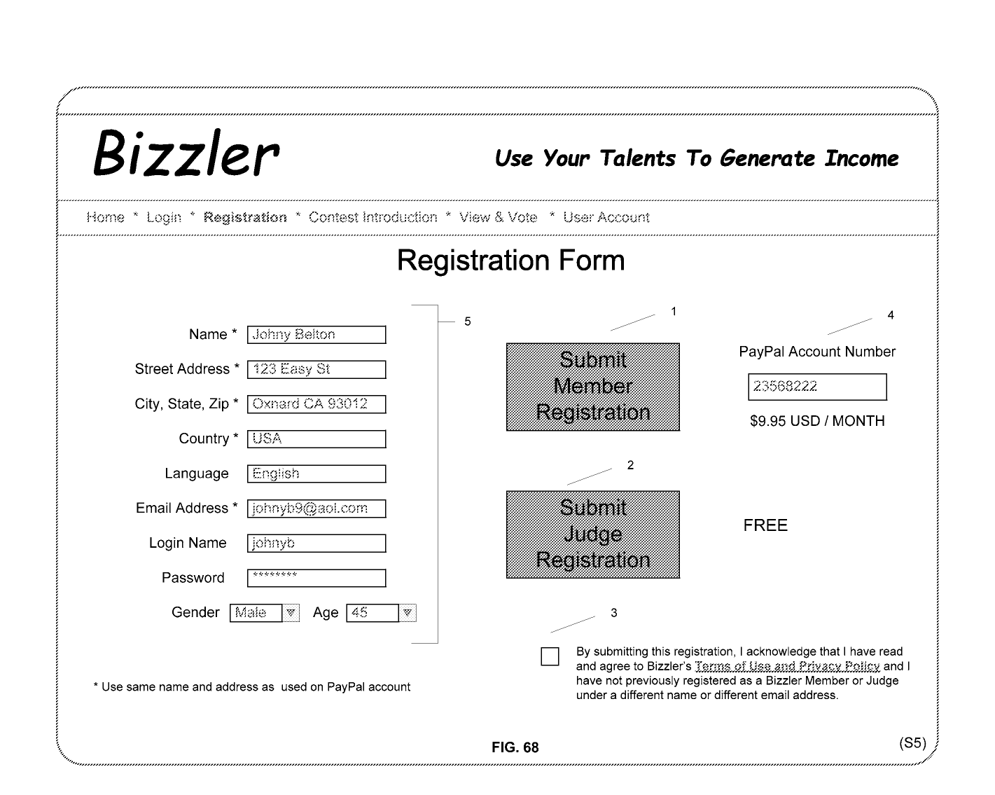

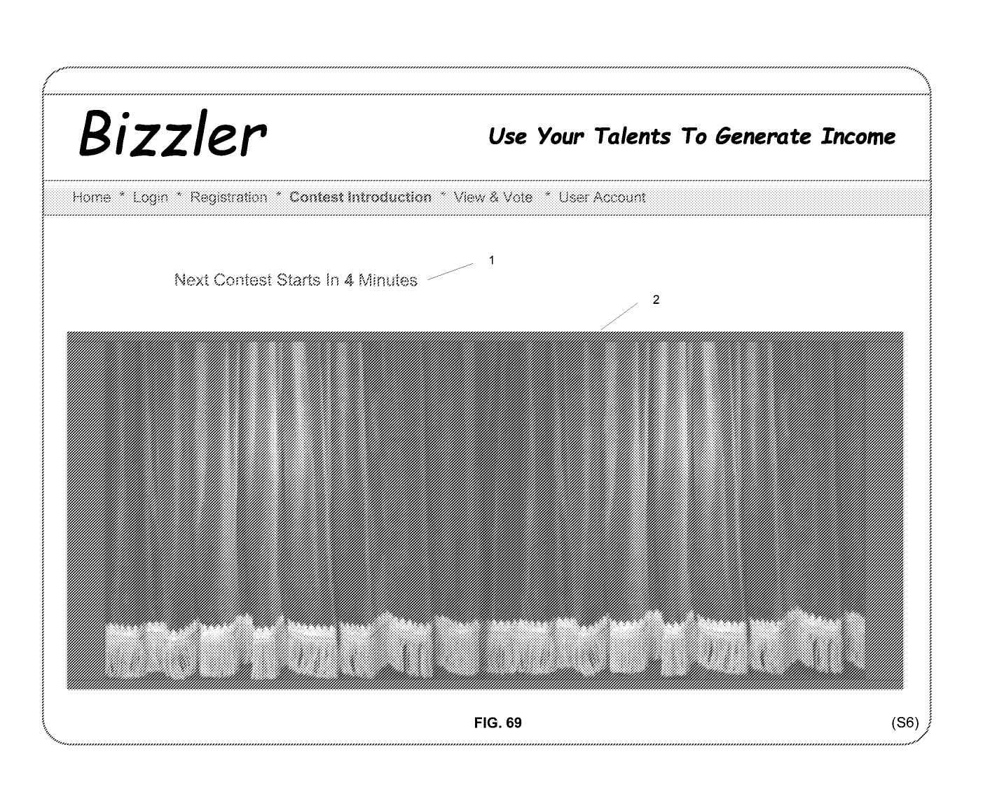

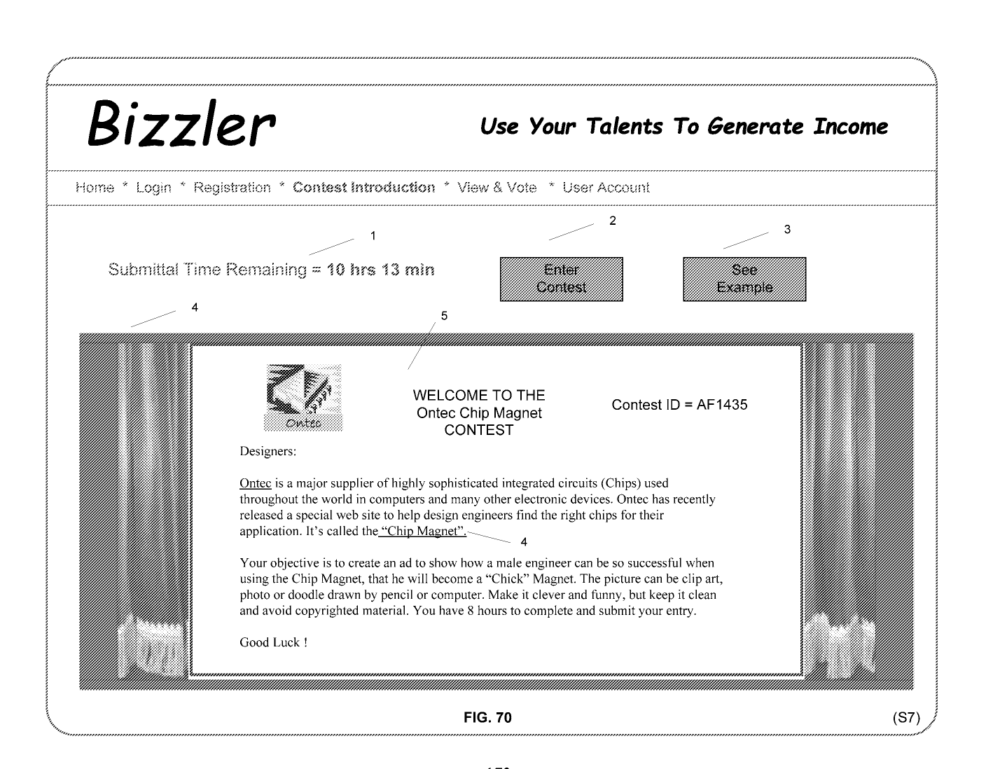

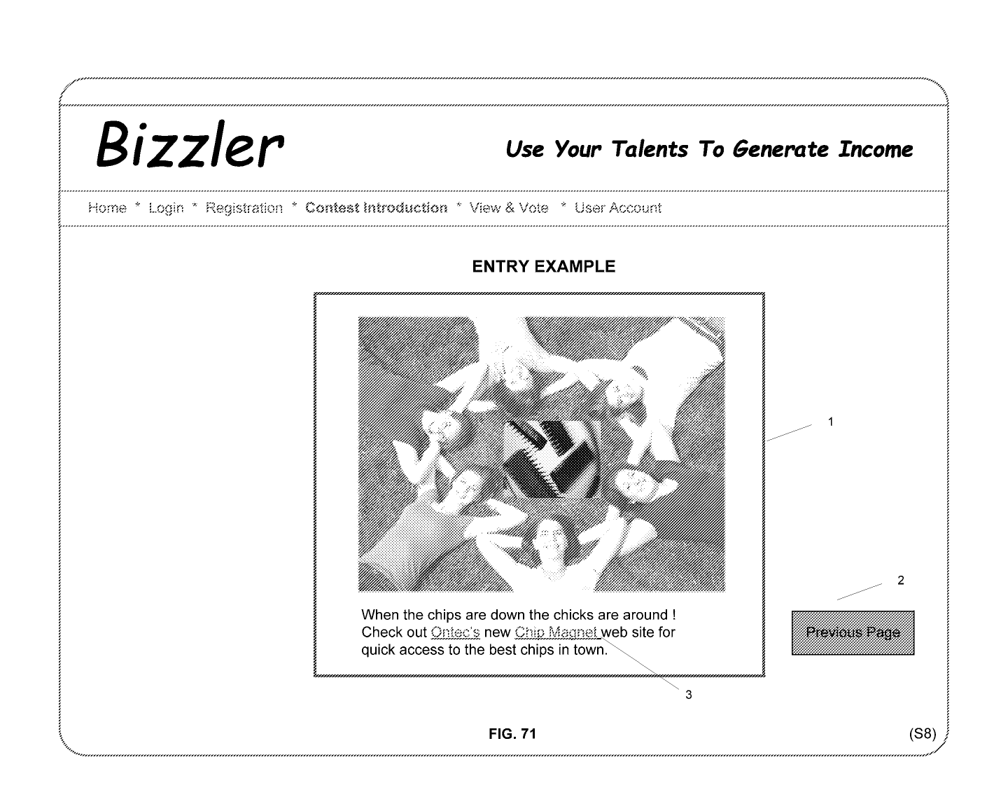

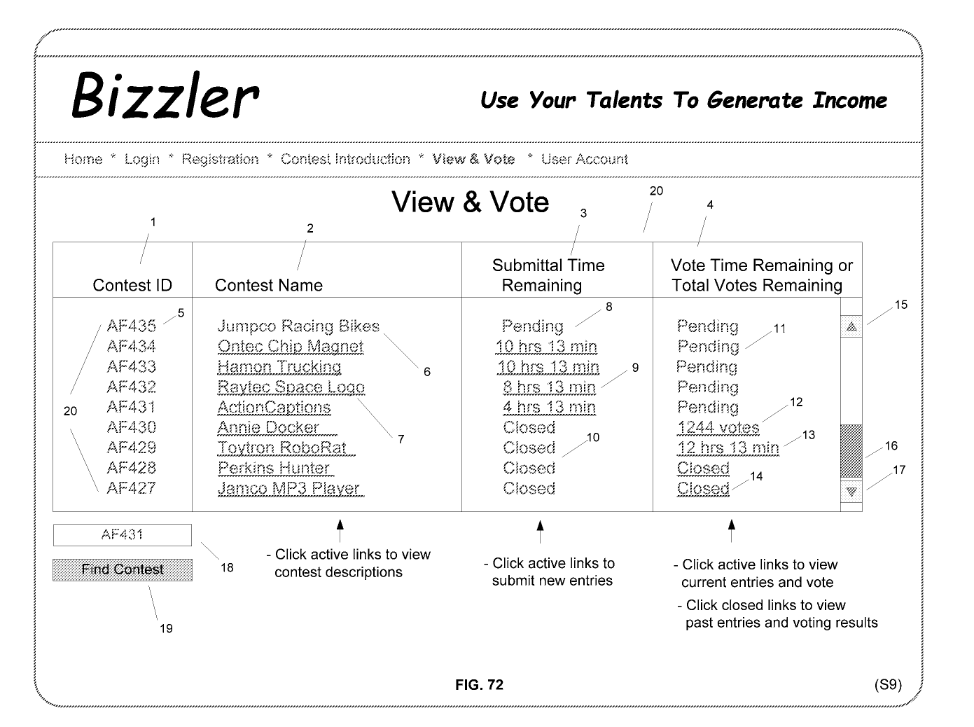

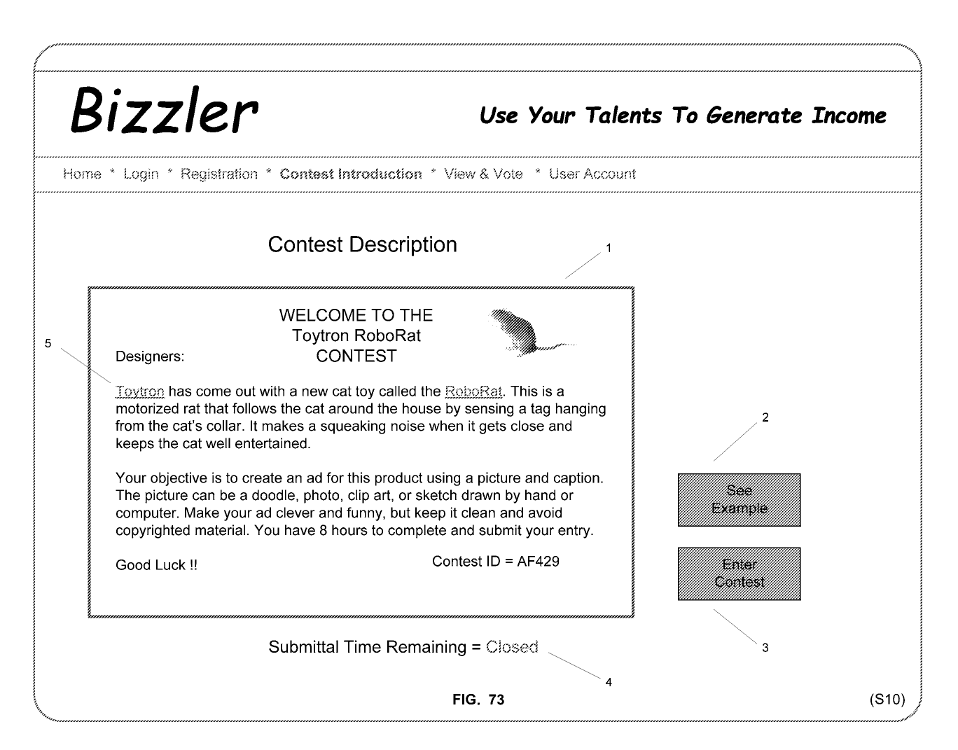

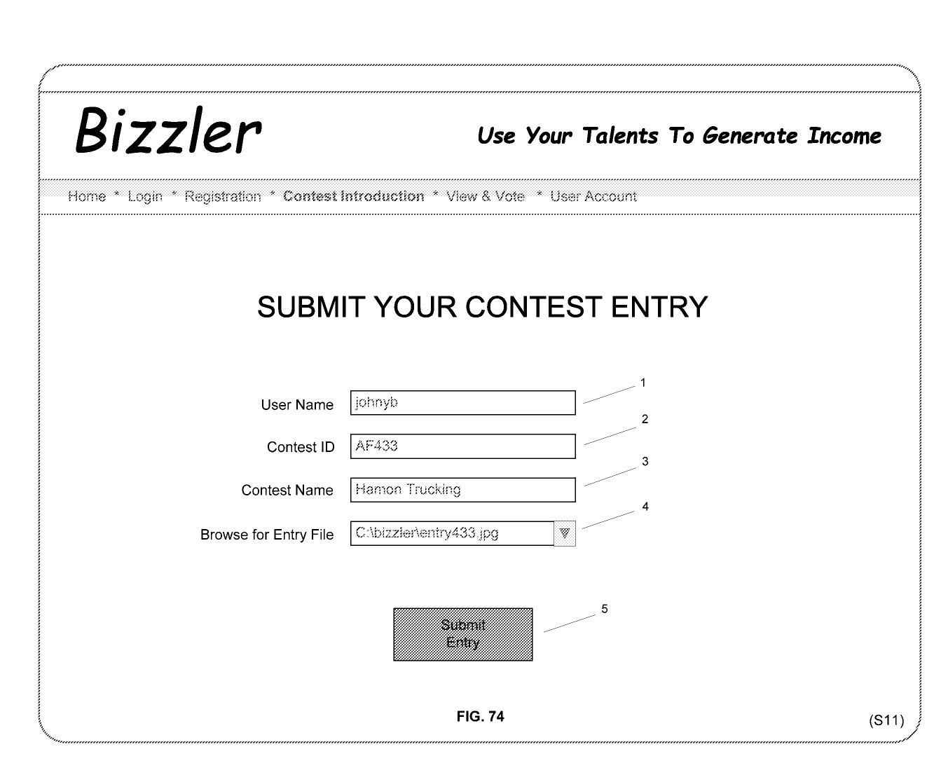

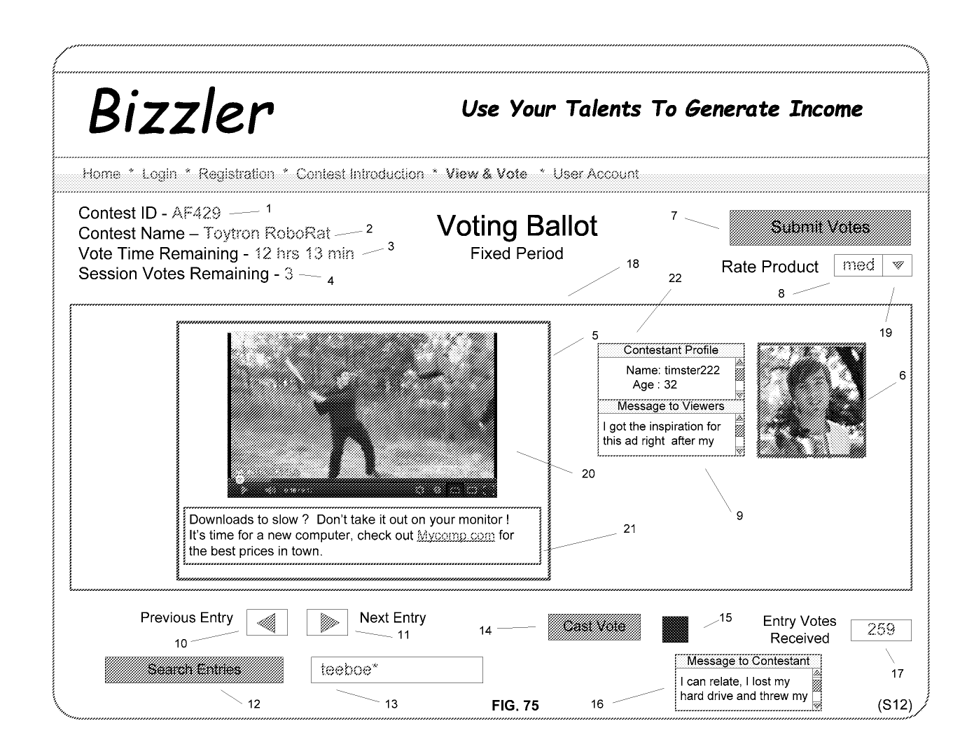

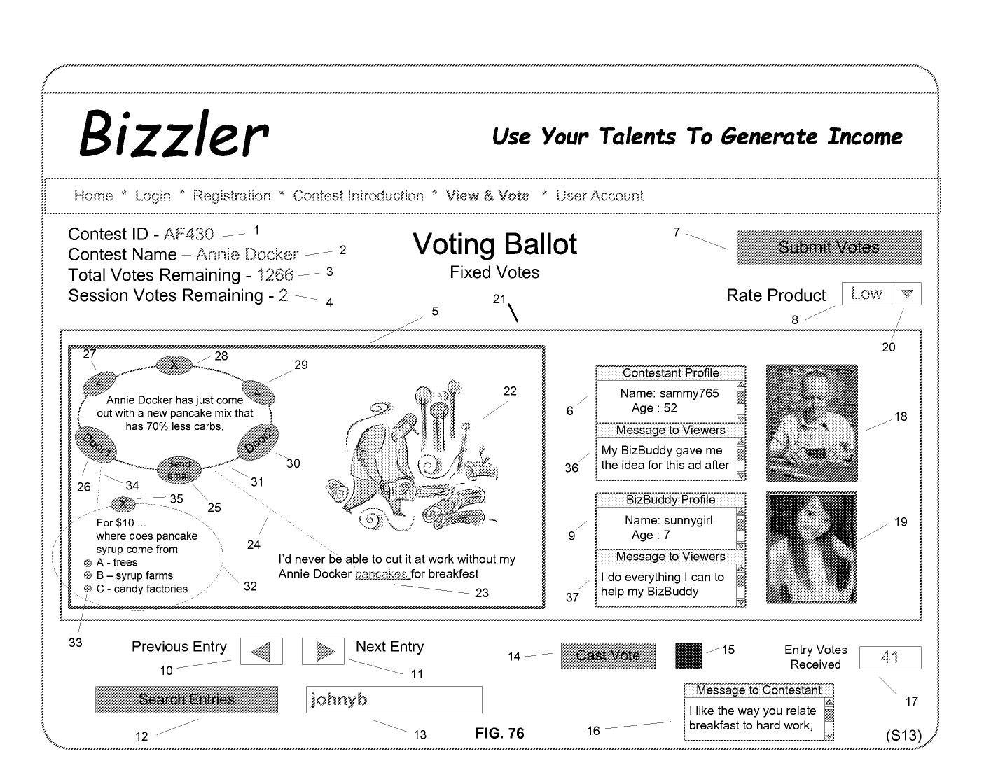

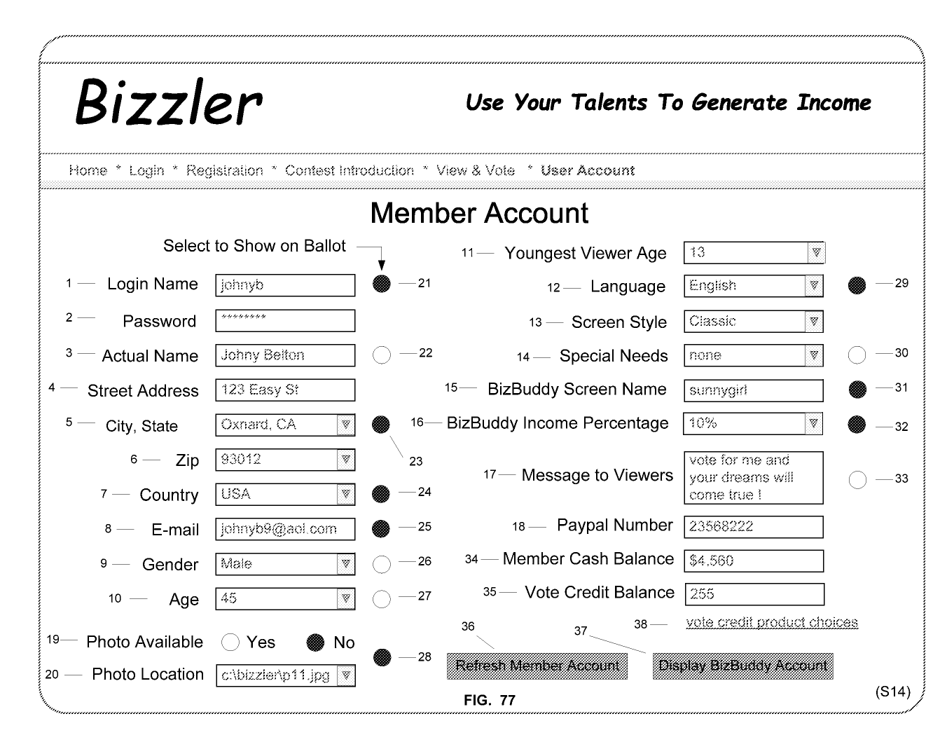

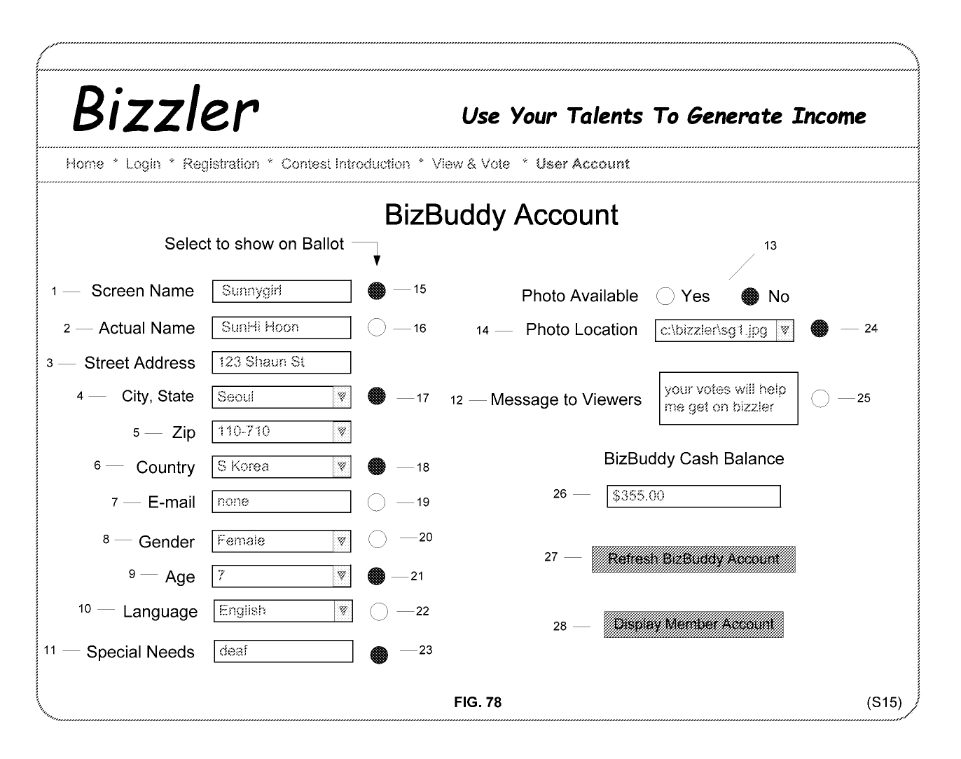

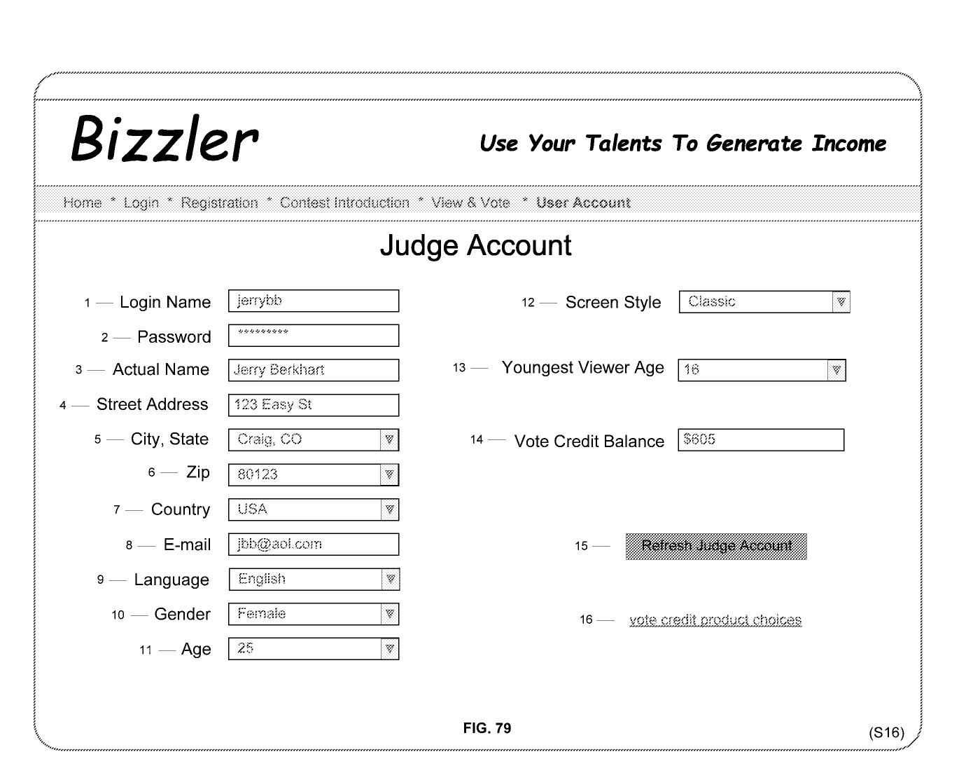

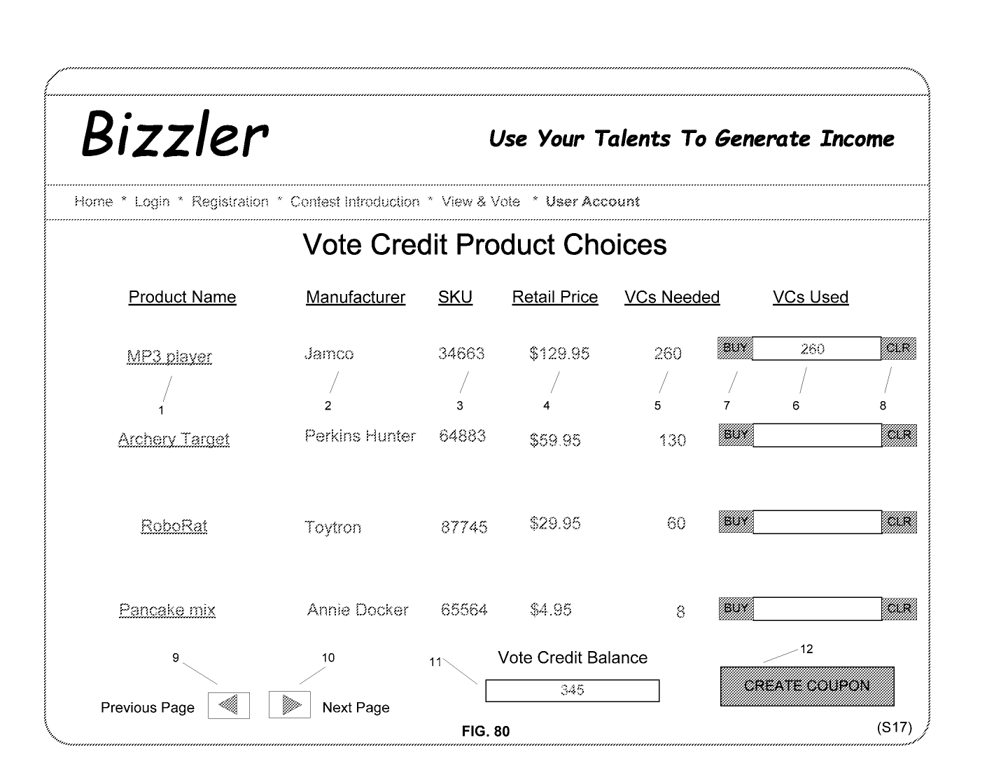

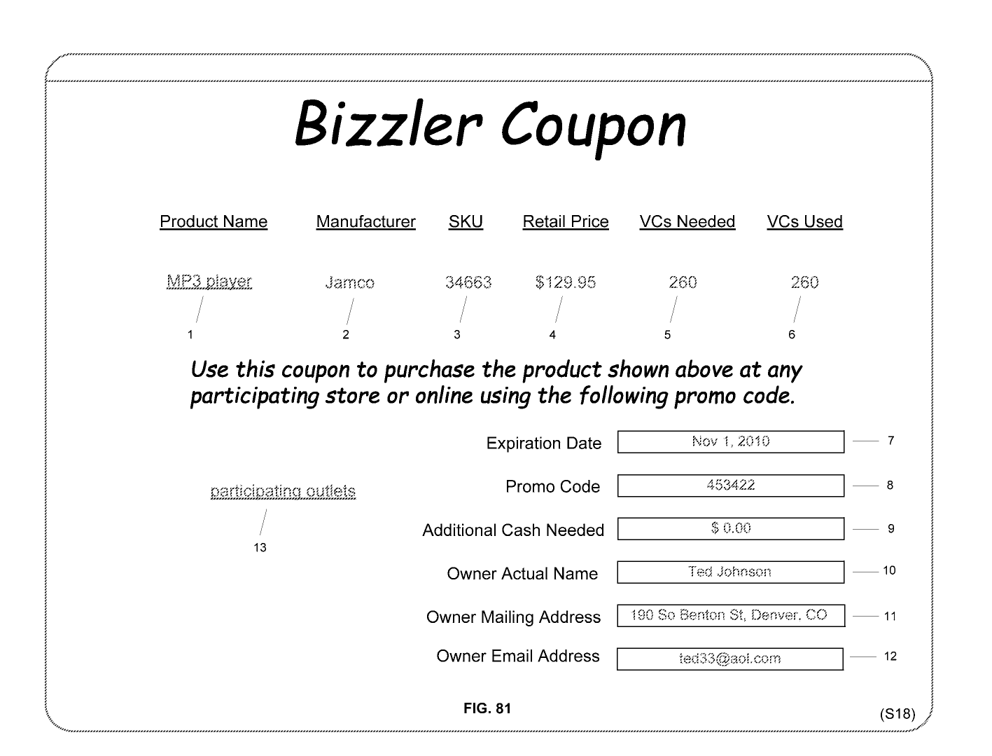

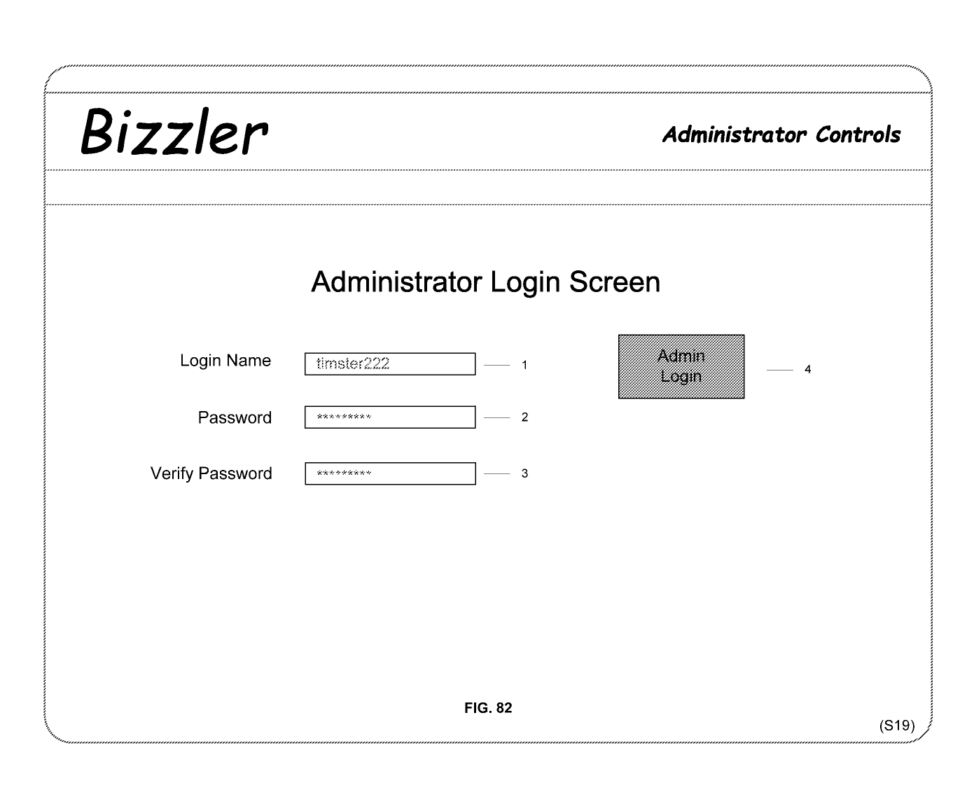

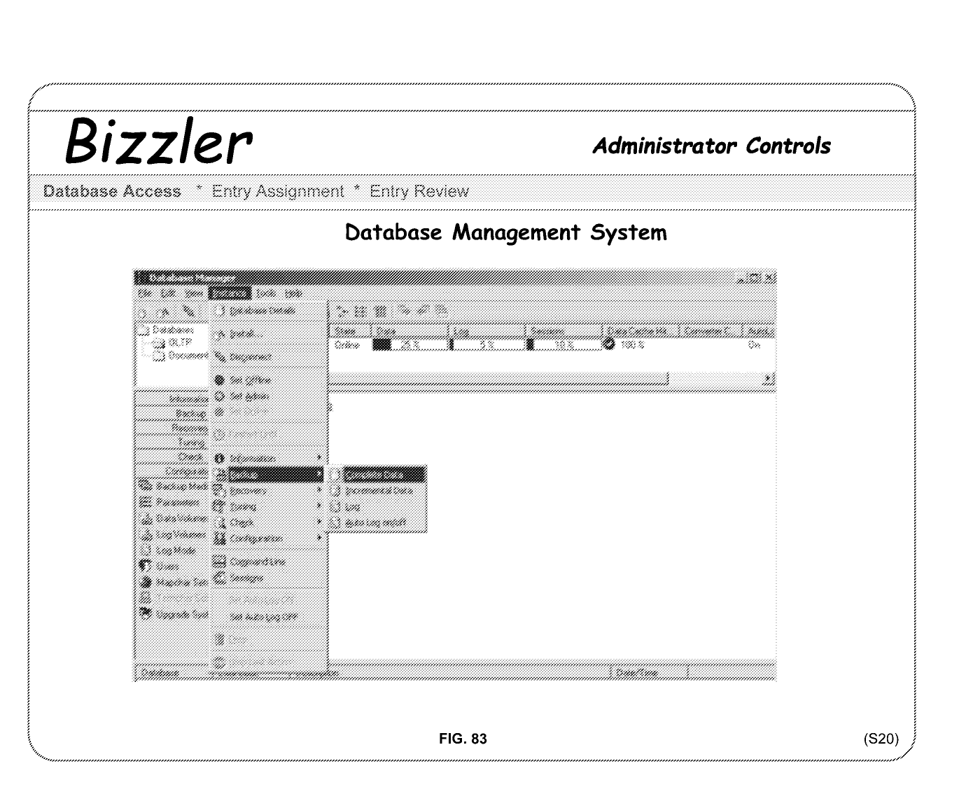

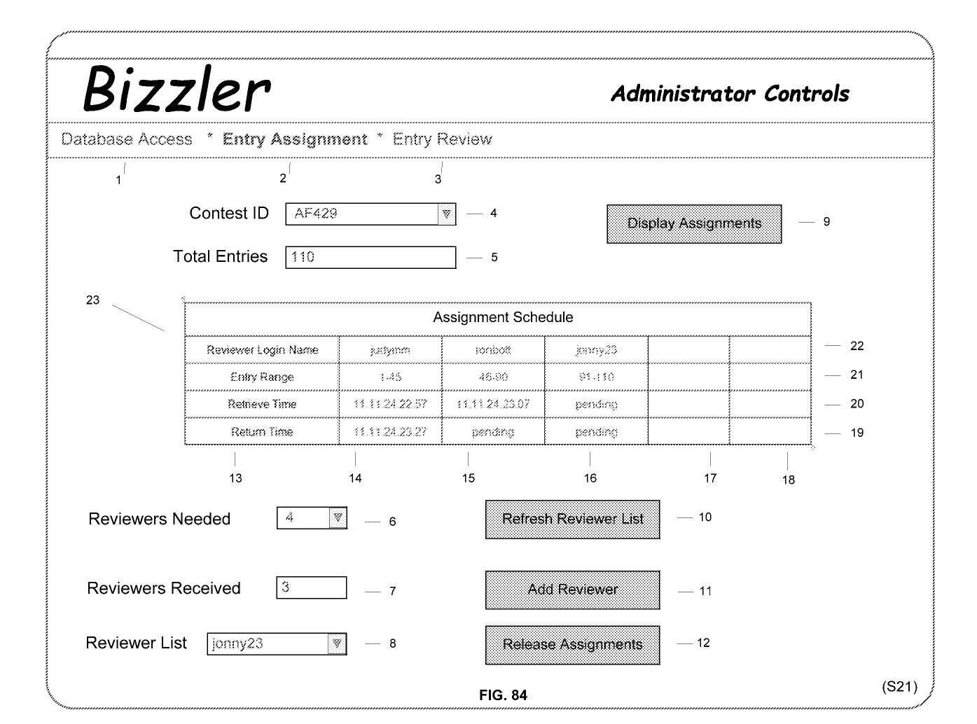

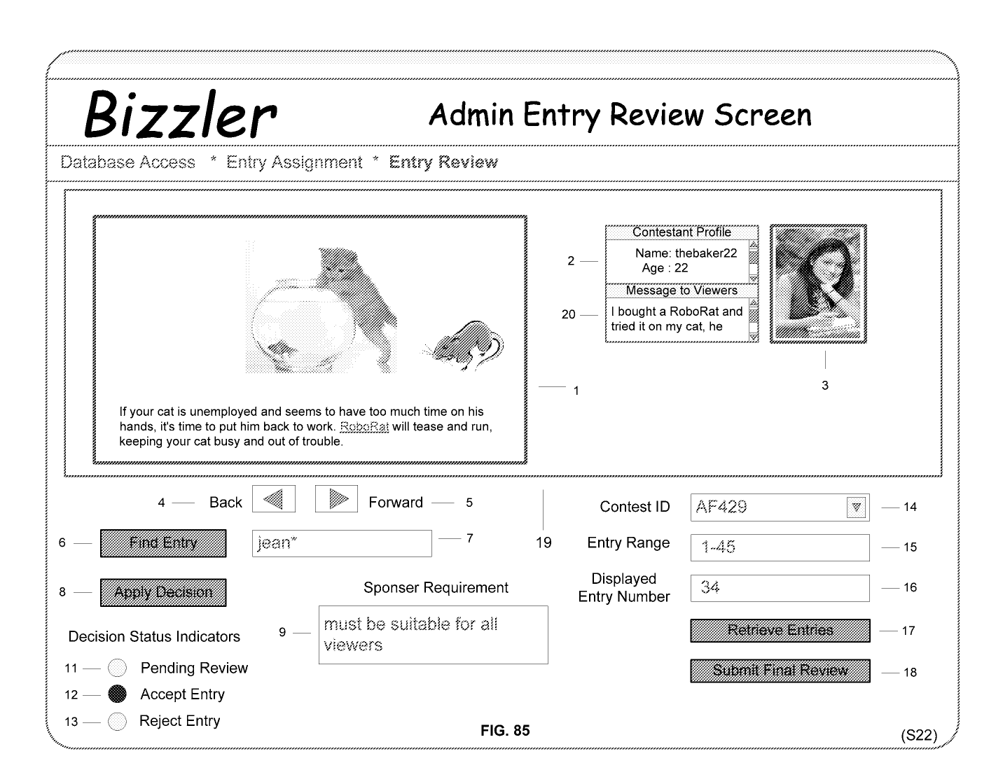

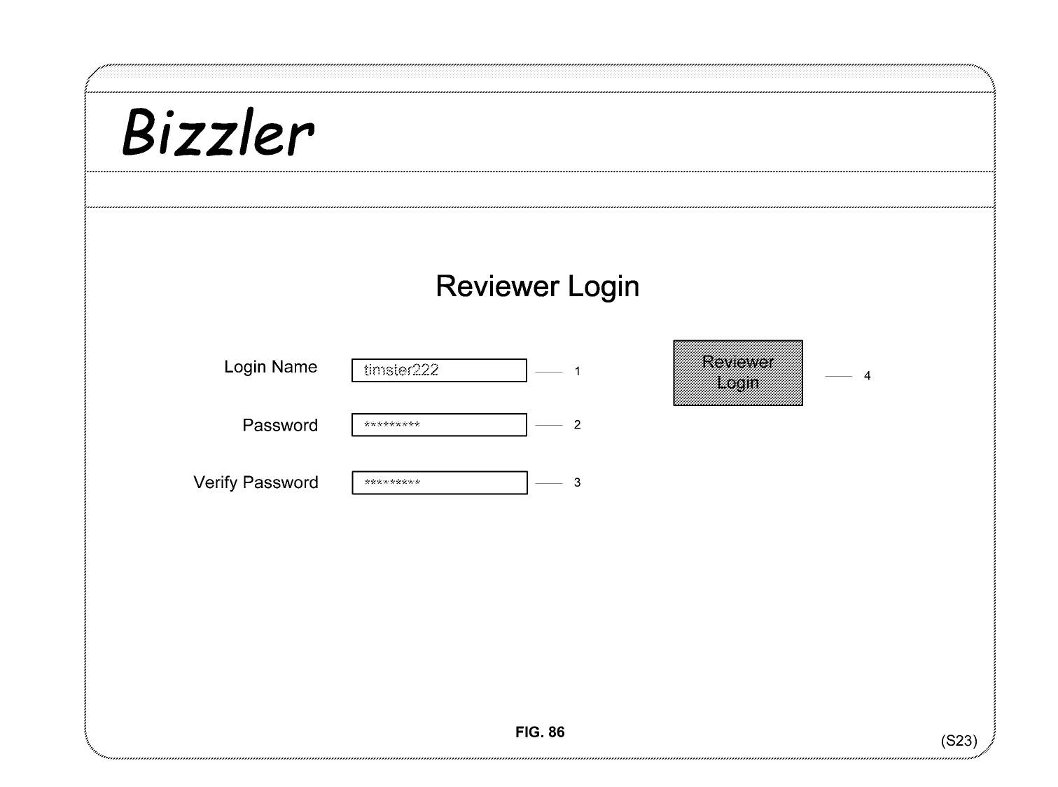

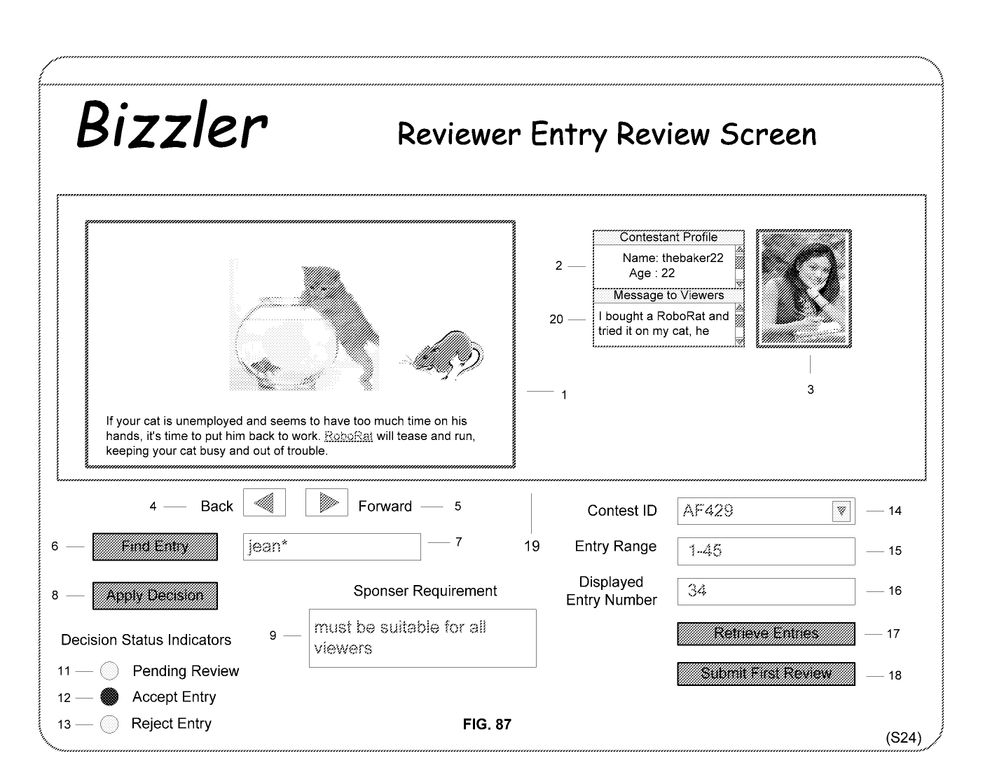

The website is based on a set of screens which contain the information and tools needed to guide Viewers through the various stages of wed site navigation, registration, contest participation, and account management. The screens are comprised of text, controls (buttons, links, drop down menus, navigation tabs), radio dials, images, and displays. A listing of the screens is shown in FIG. 6 and a layout for each screen is provided as FIGS. 64-87. The following conventions are used to assist the reader in understanding the construction, operation, and purpose of each screen element:

a) black text and black/white pictures represent static information (e.g. website information, screen names, button names, company logo, slogans, instructions, photos, etc.)
b) red text and anything within a red frame represents information which can be entered by the Viewer or computer (e.g. votes received, submittal time remaining, contest entries, contestant profile, etc.)
c) colored pictures are used to shown dynamic content (e.g. video clips)
d) green text and green fill are used to show active buttons or links
e) blue fill is used to show selections made by the viewer (e.g. radio dials, voting boxes)

### Software Tools

FIGS. 7A and 7B define the software tools used to support processing in the Server, uClient, rClient and aClient computers, which includes; registers, pointers, counters, flags and timers. In addition, FIGS. 7A and 7B define an acronym for each of the tools which are referenced throughout the document.

### GLOSSARY

FIGS. 8 and 9 provide a list of unique terms used throughout the document and a brief description of each term.

### Subroutines

The software executive operating in each computer type remains in an idle loop until a subroutine is triggered by an event. Once triggered, a set of pre-defined functions are performed and then the idle state is resumed once again. The following summarizes the types of events that can take place in each computer type:
Server—1) 1 min timer, 2) message from uClient, rClient or aClient (e.g. M27)
uClient—1) click on button, radio dial, menu or link, 2) message from Server (e.g. M2)
aClient—1) click on button, radio dial, menu or link, 2) message from Server (e.g. M5)
rClient—1) click on button, radio dial, menu or link, 2) message from Server (e.g. M3)

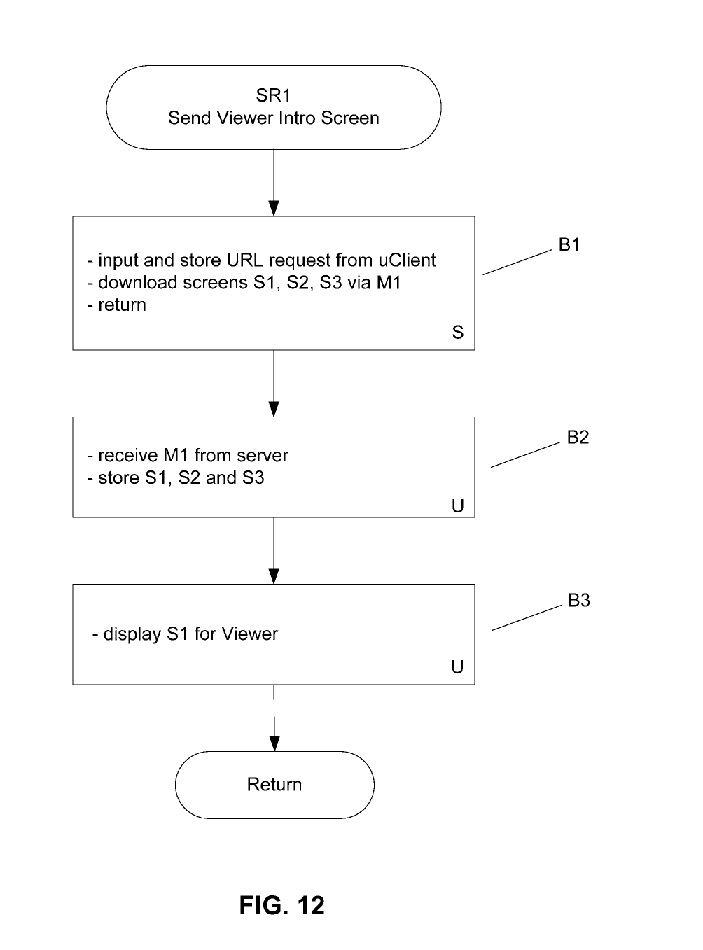

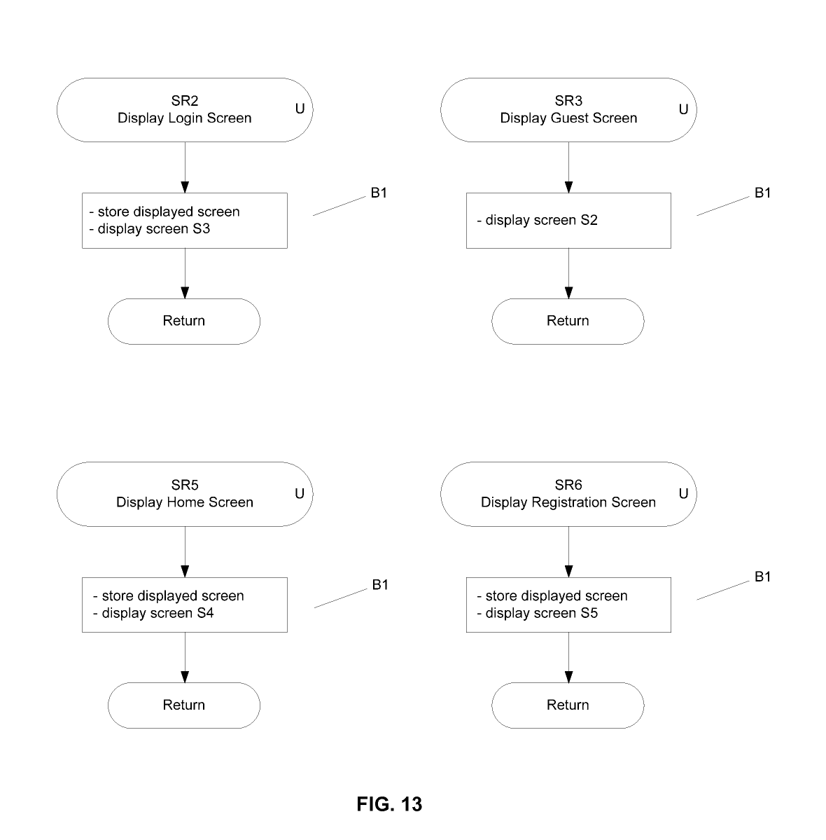

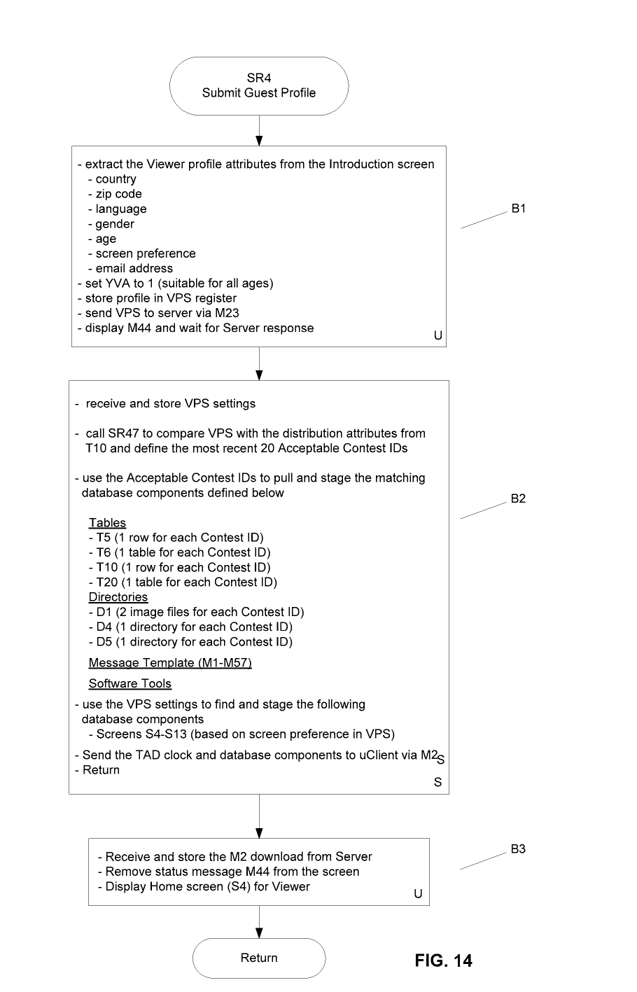

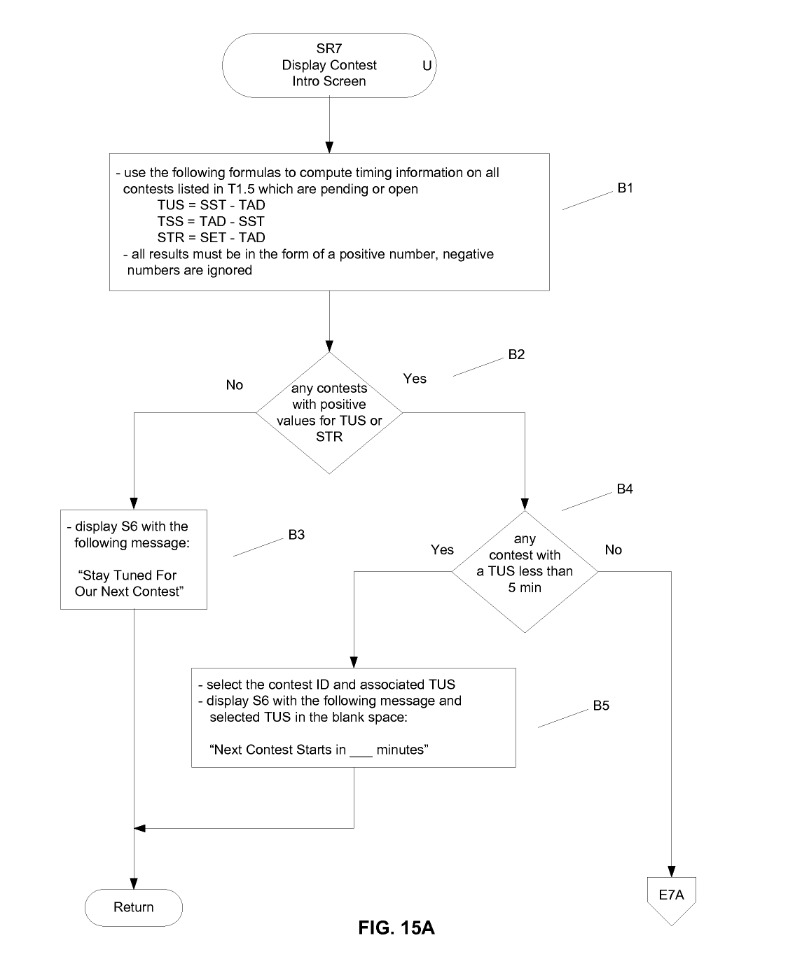

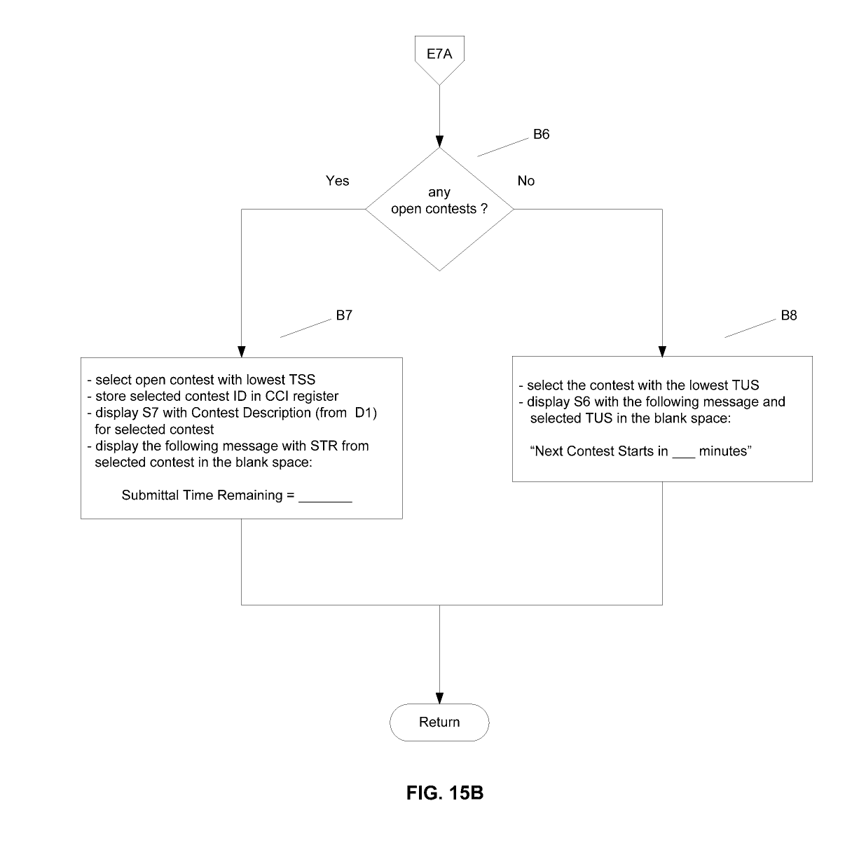

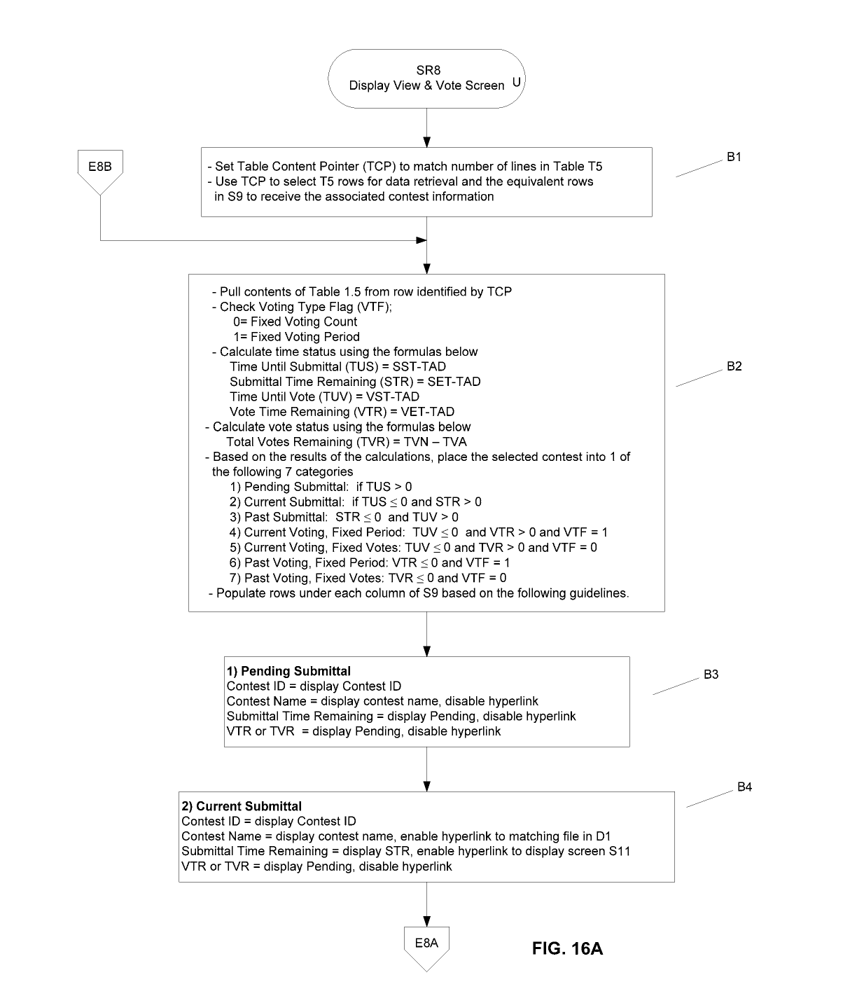

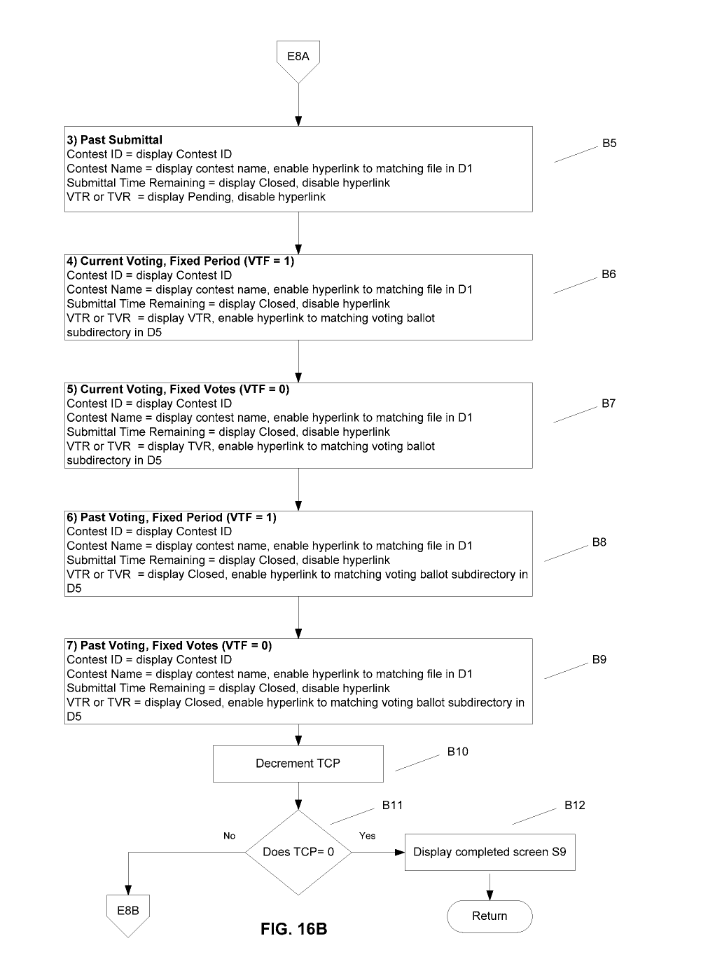

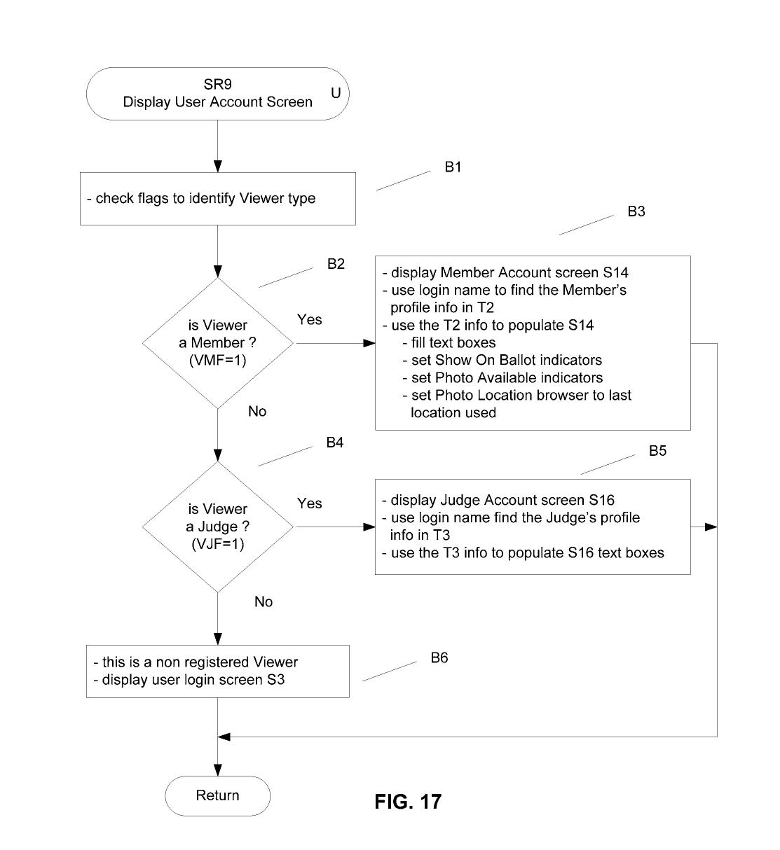

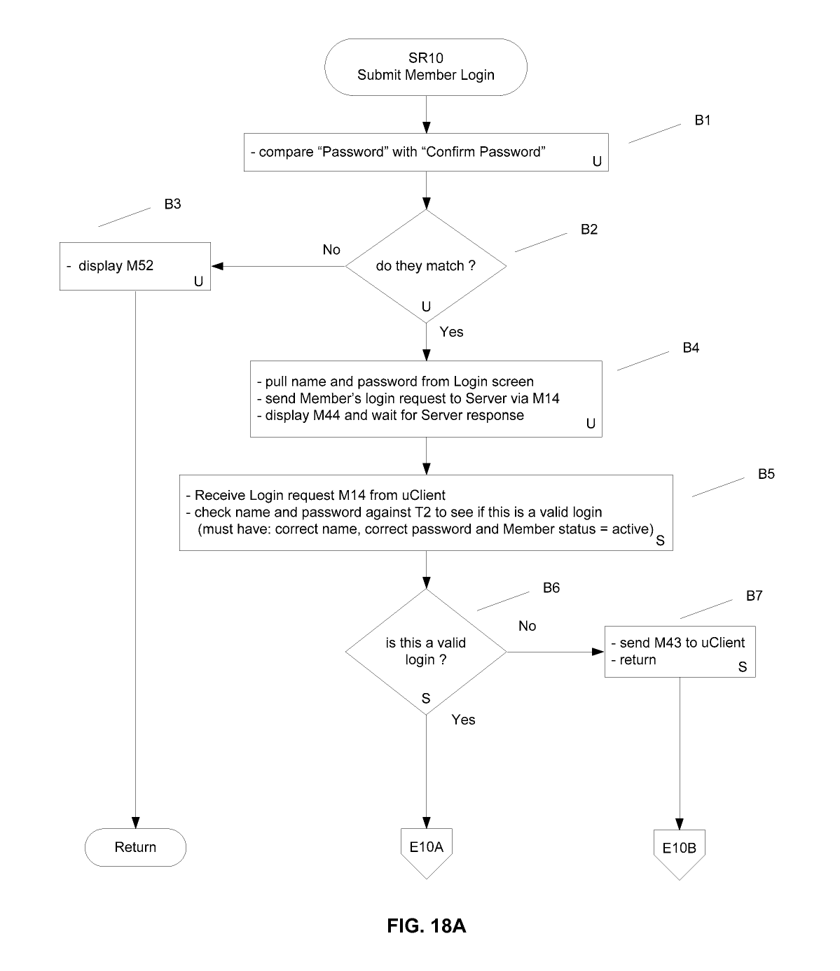

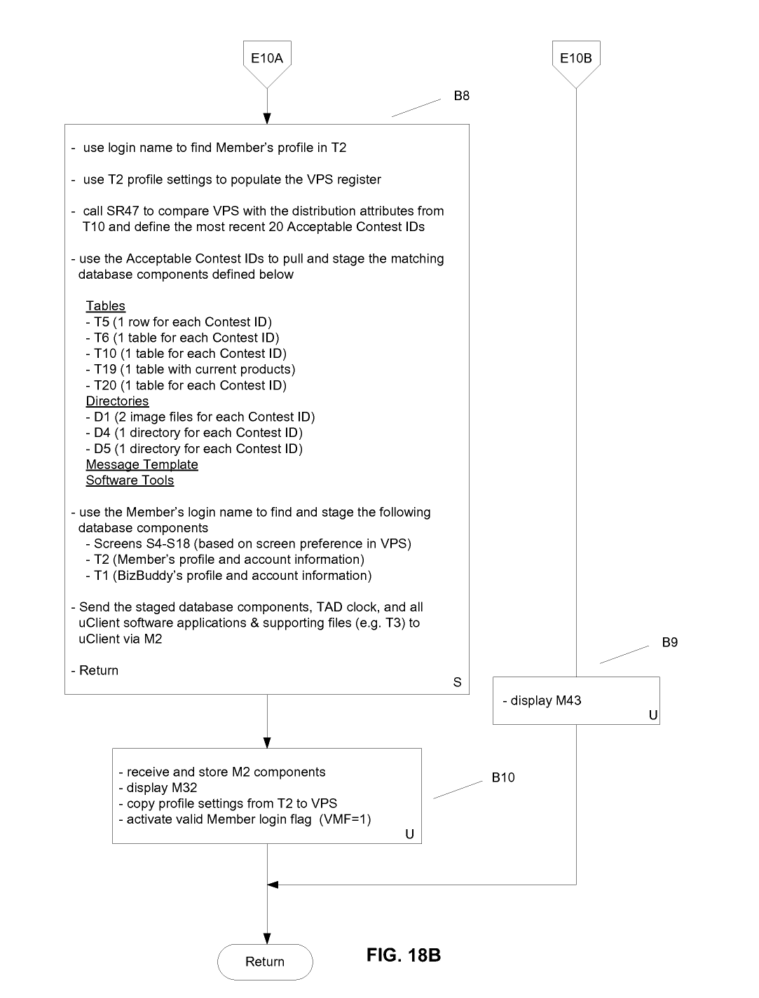

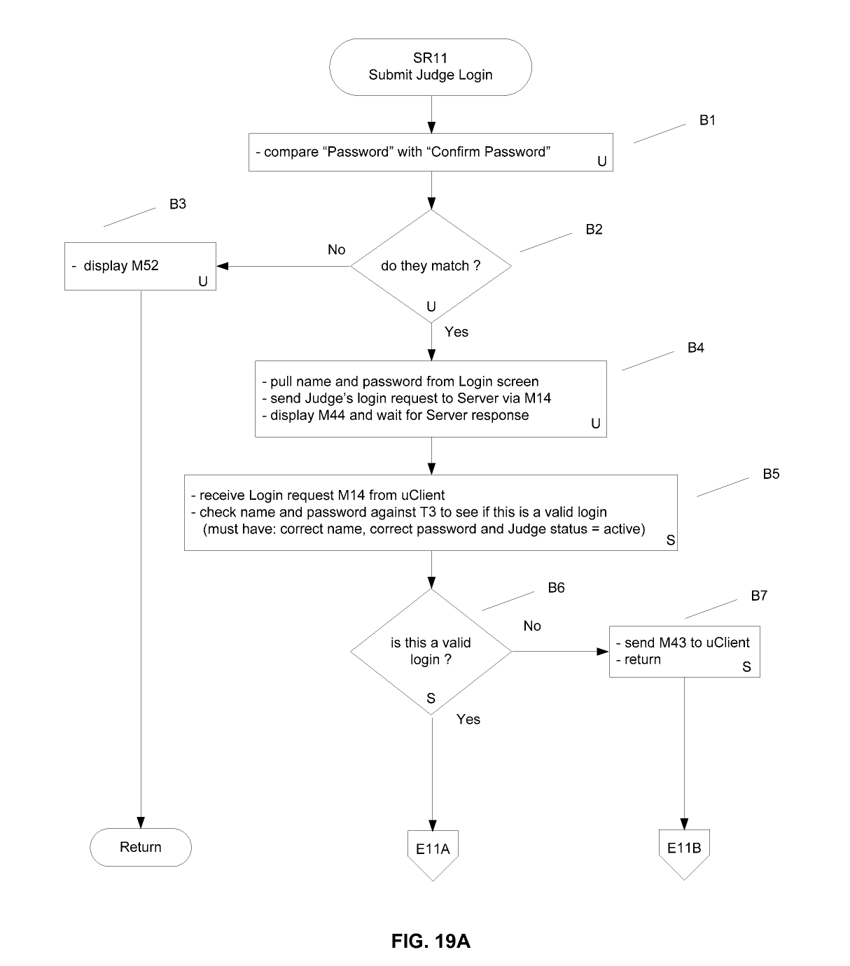

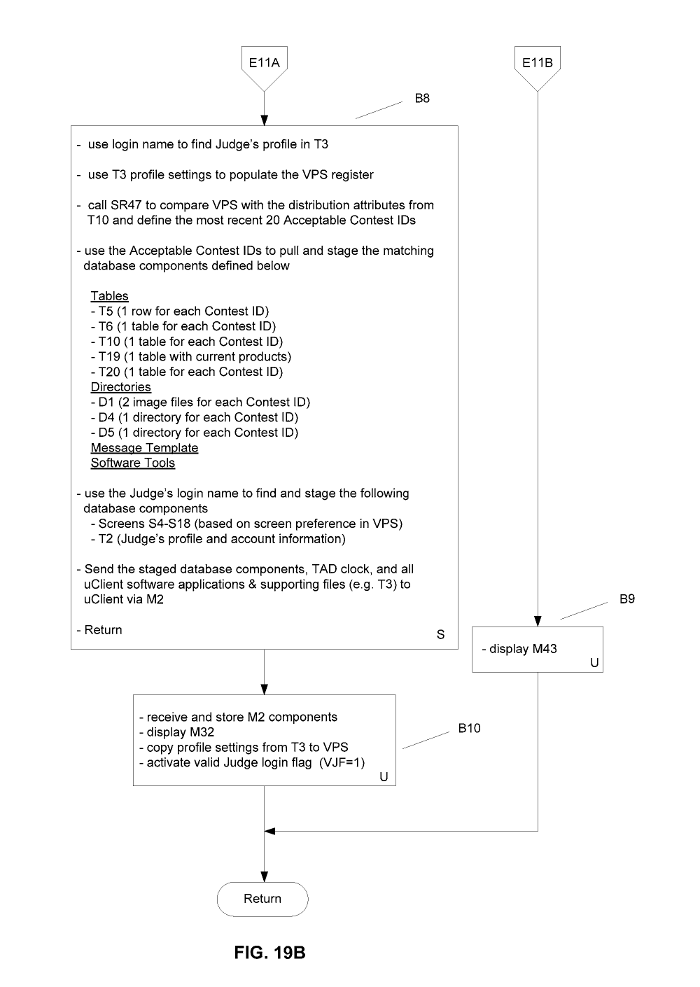

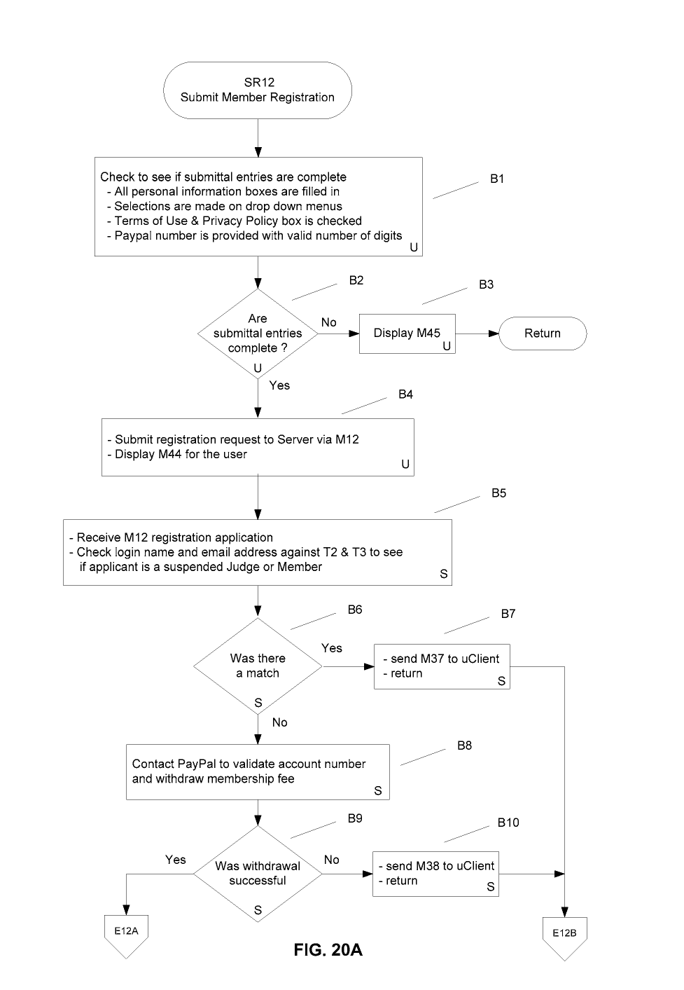

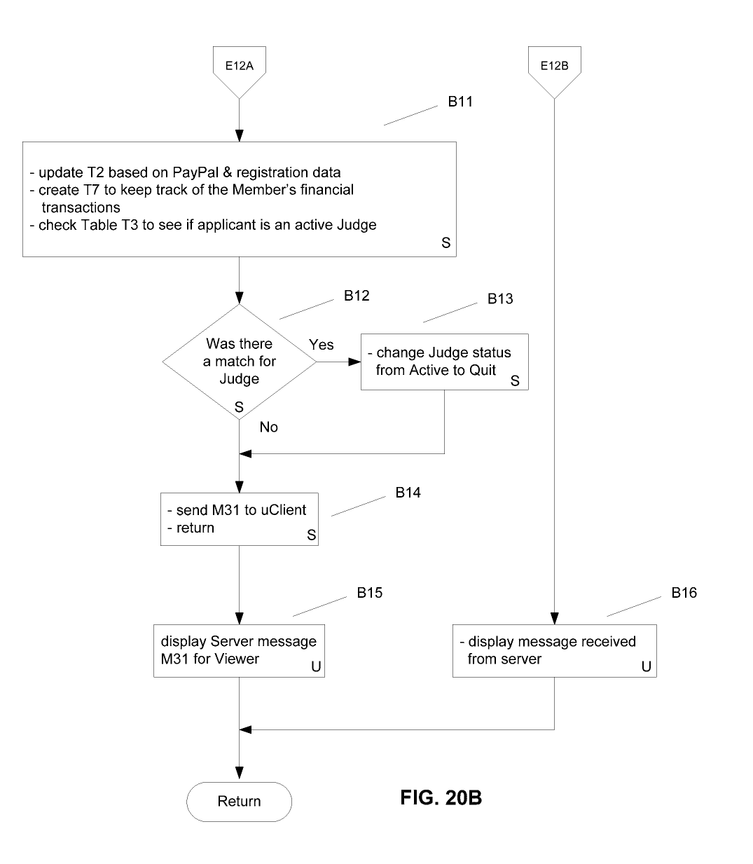

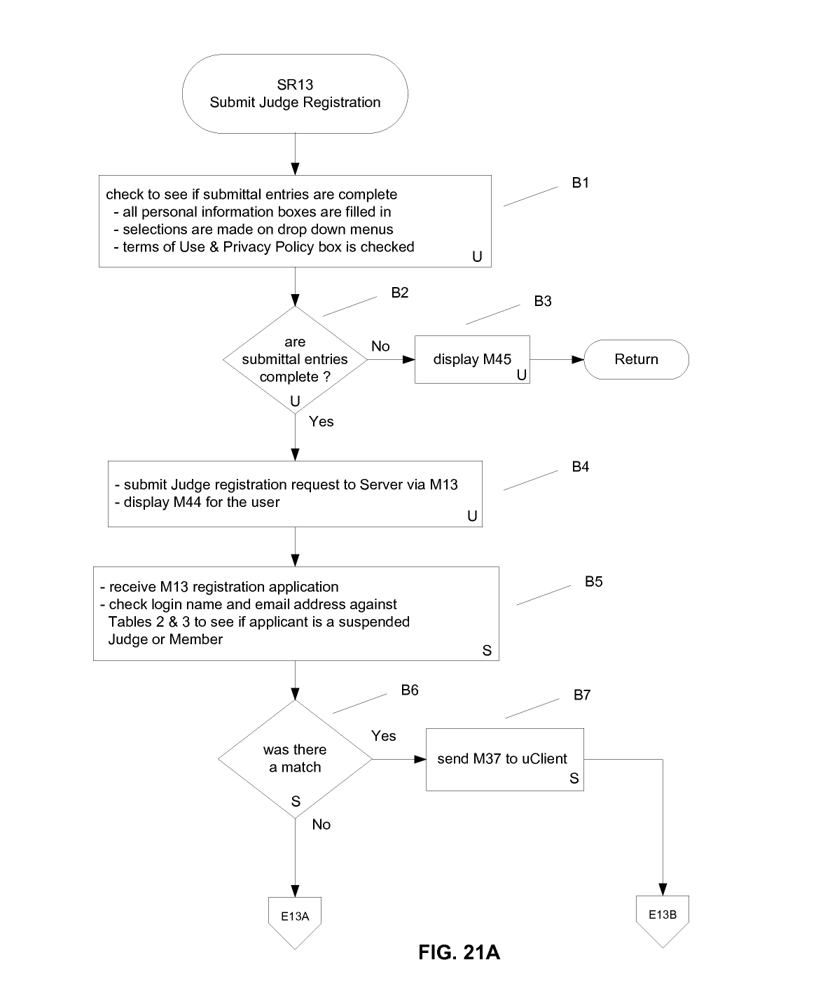

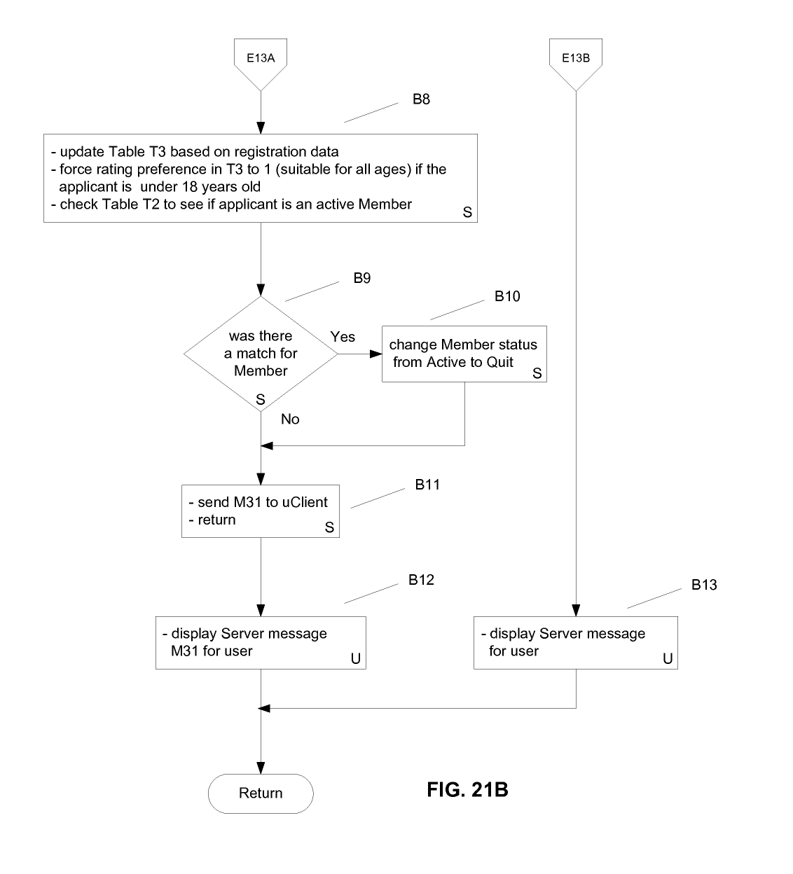

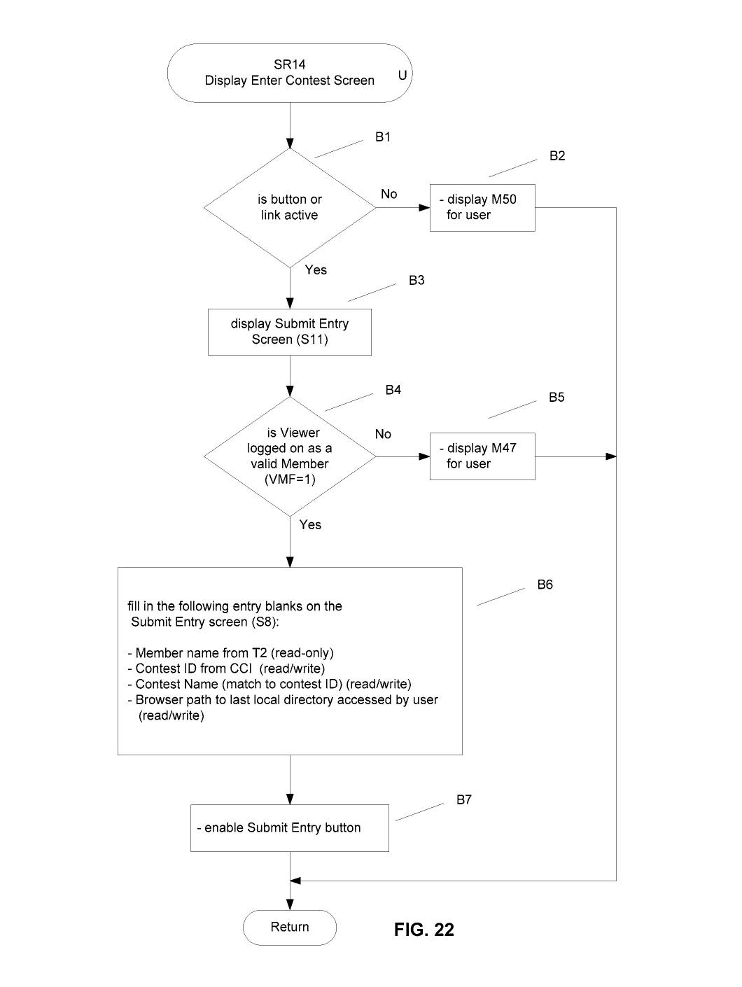

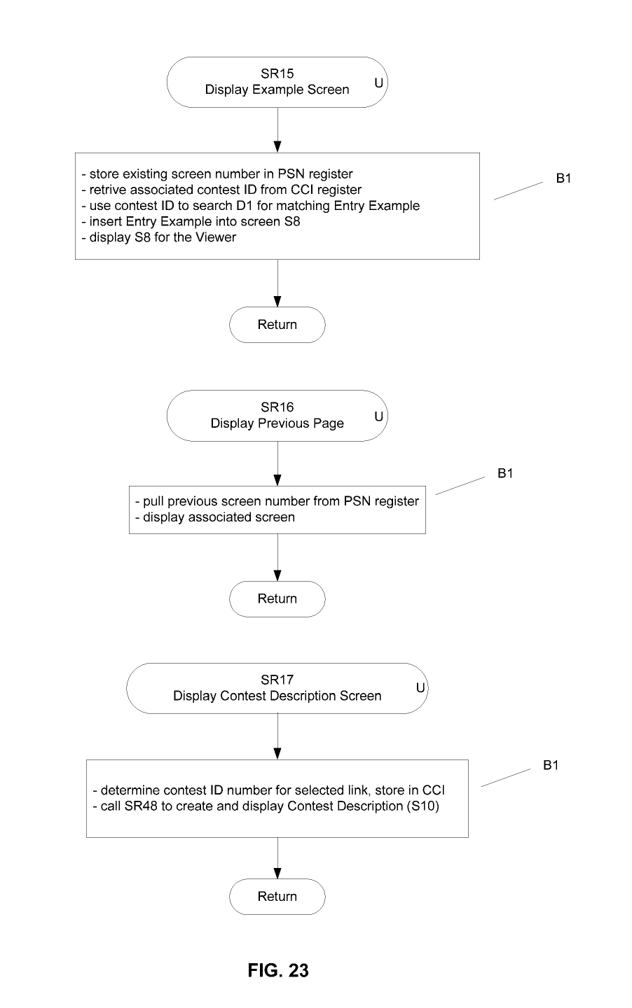

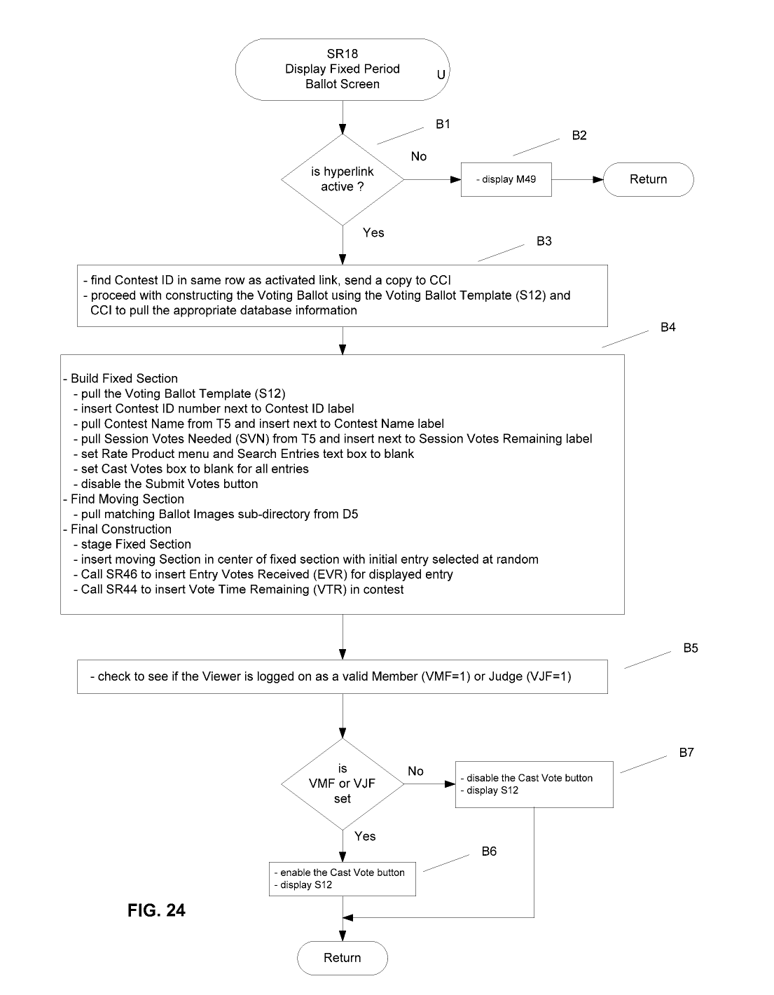

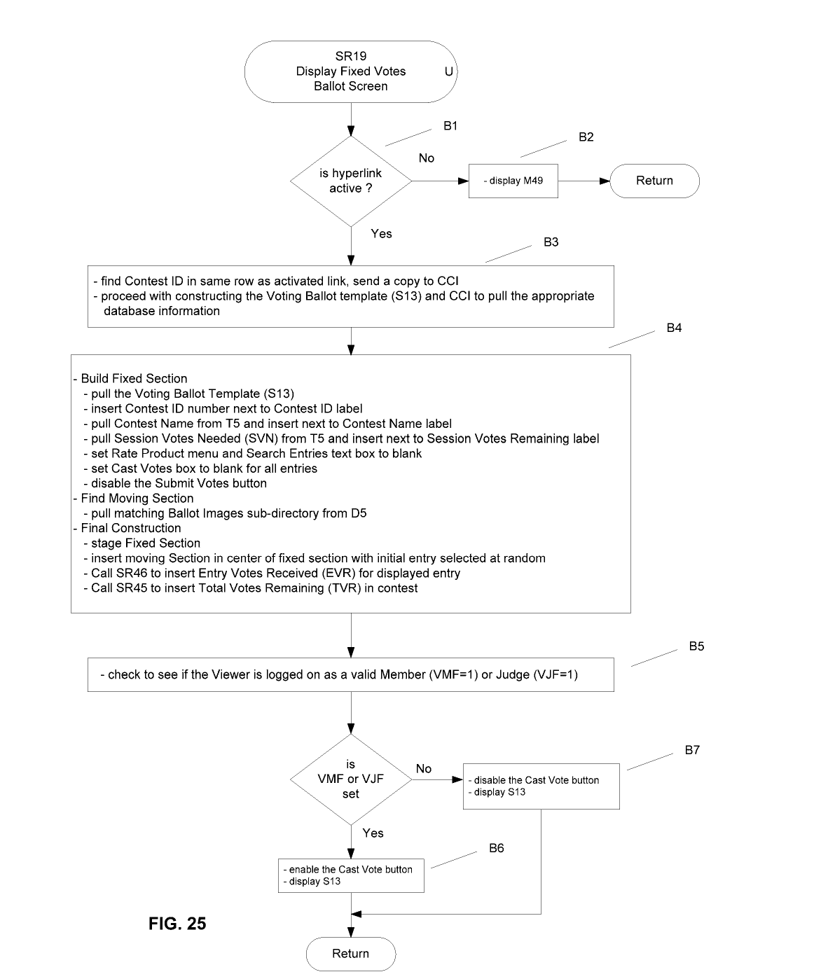

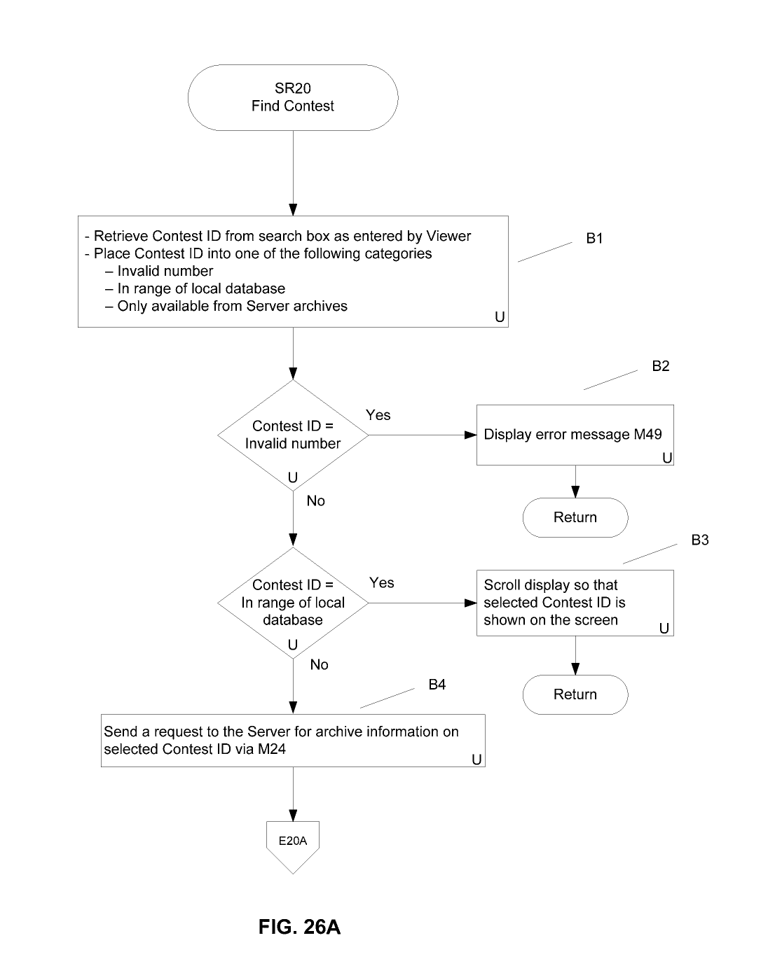

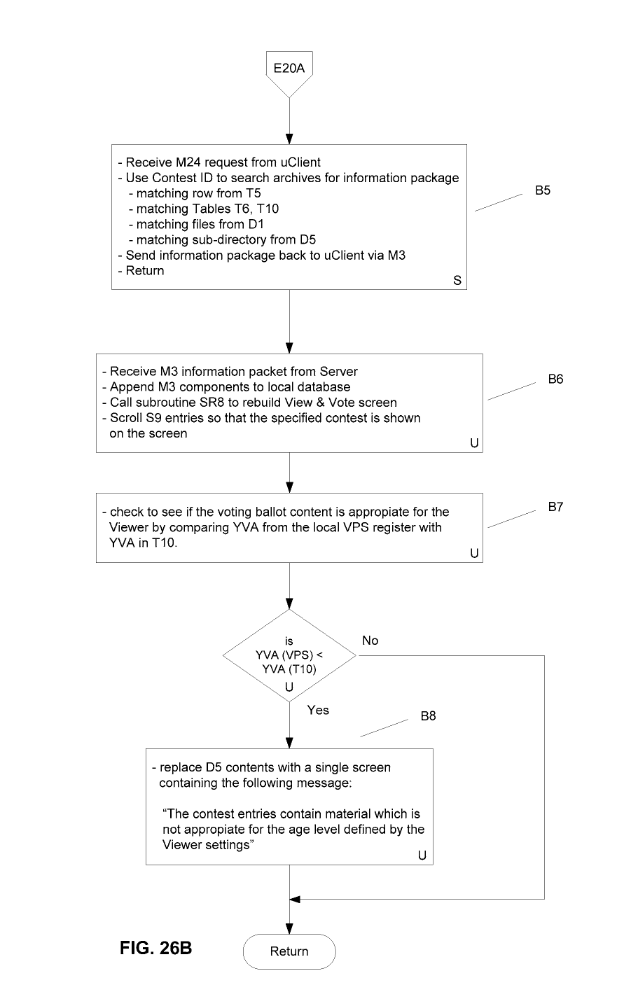

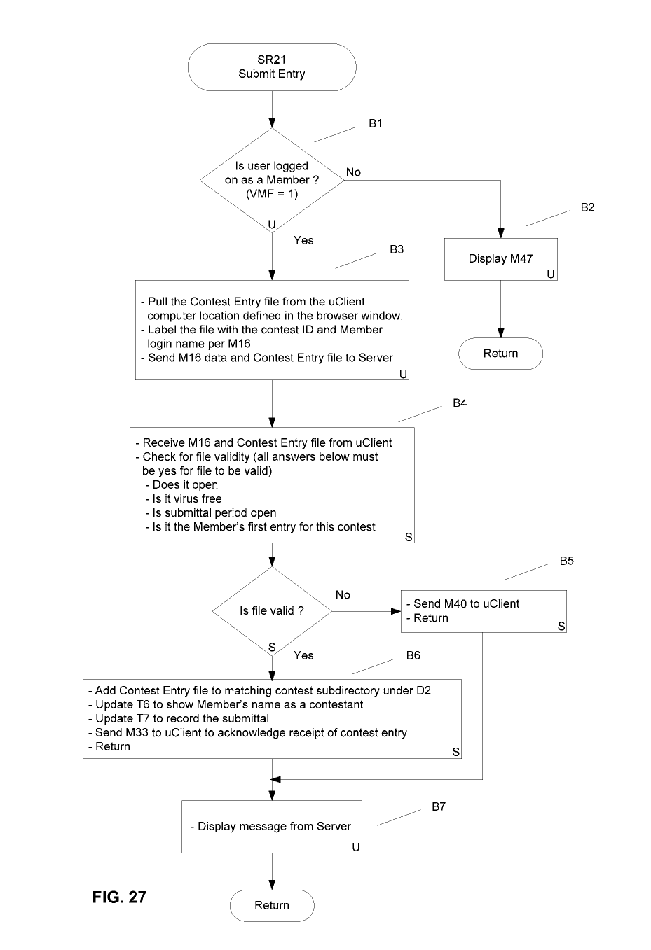

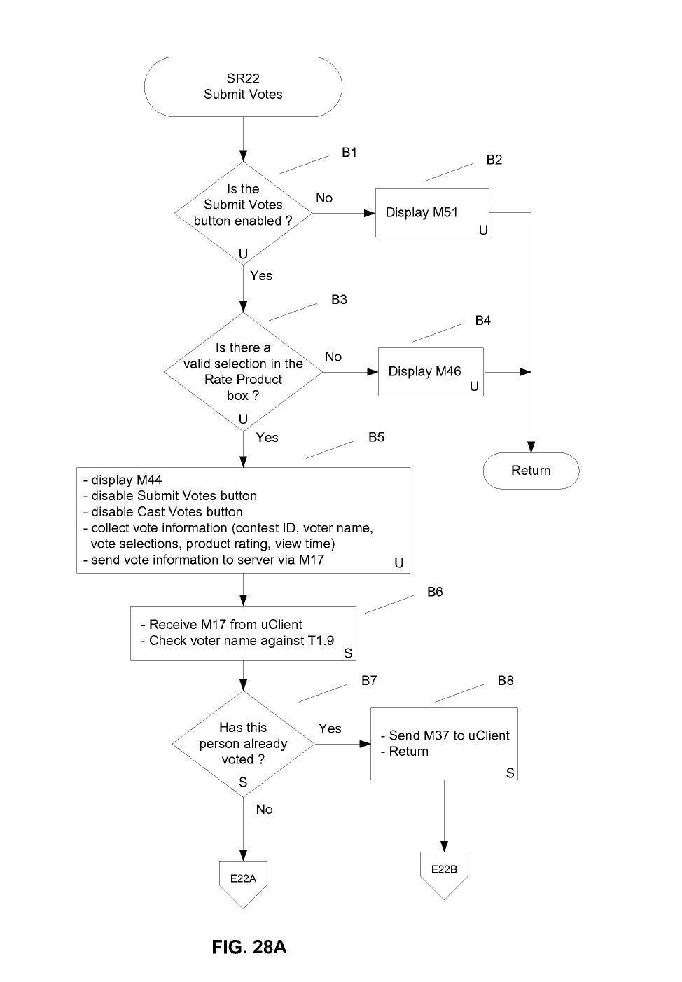

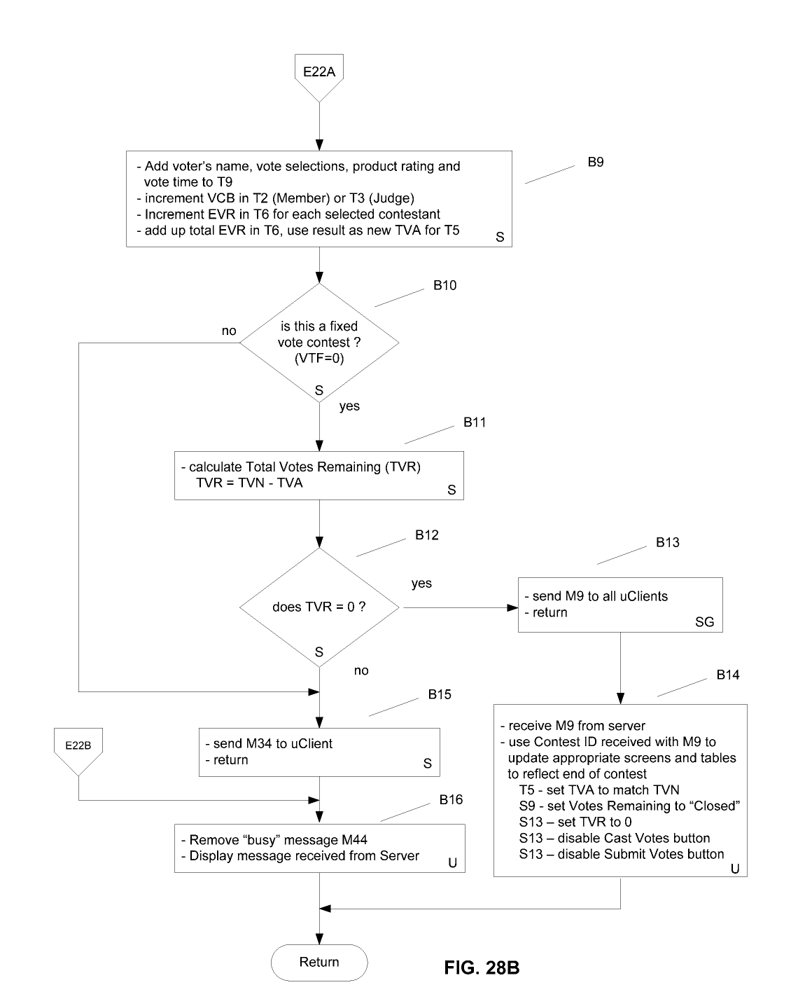

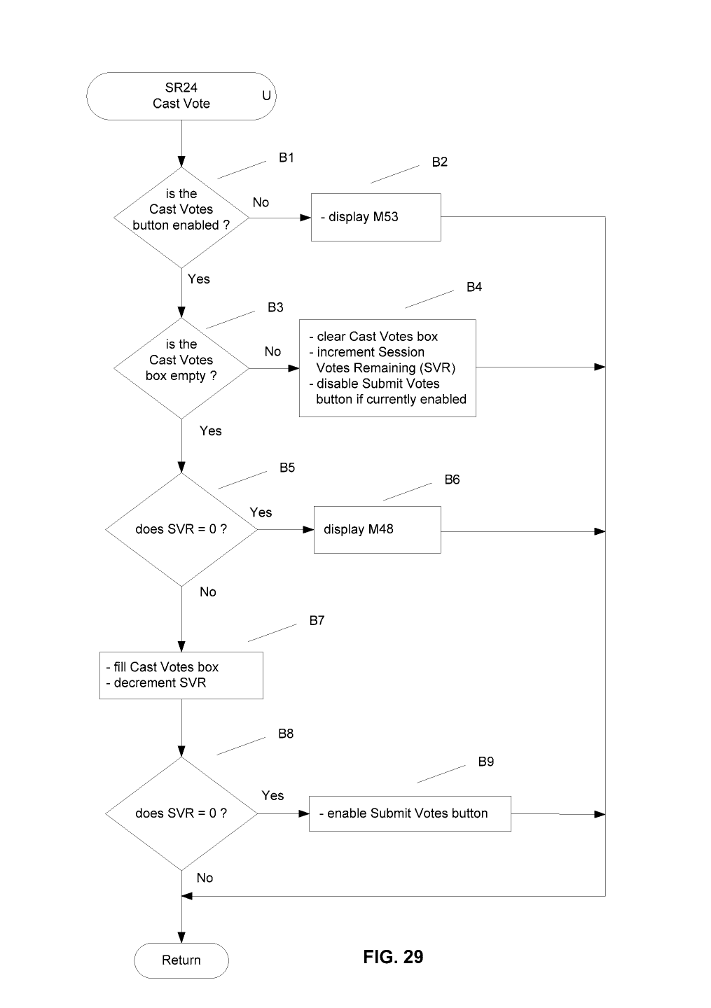

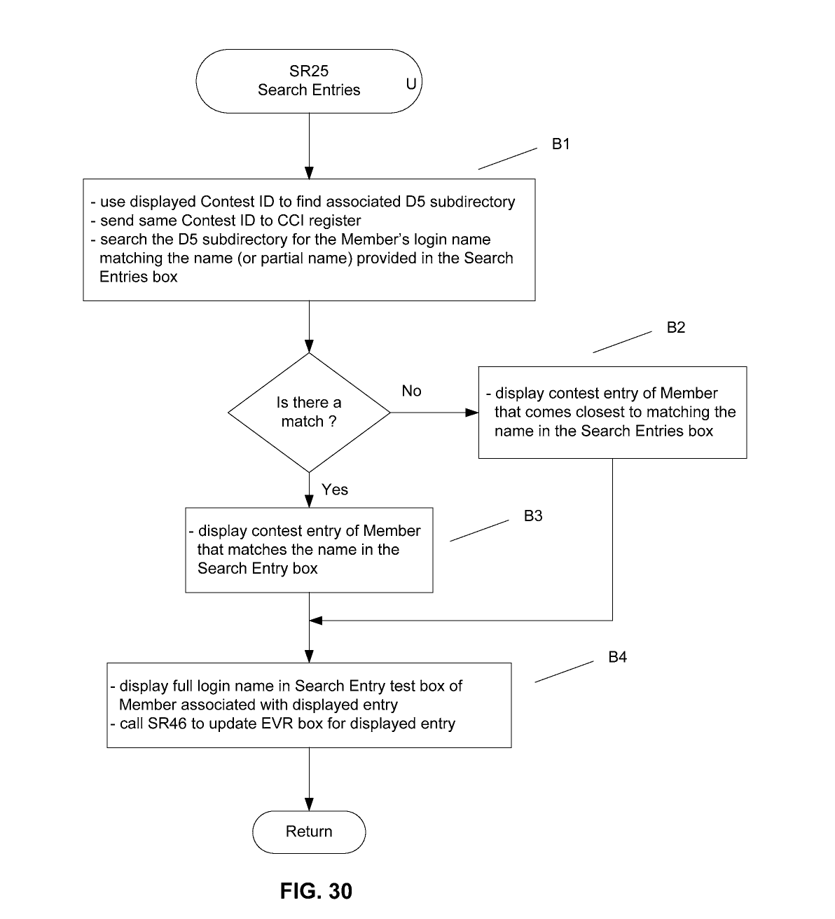

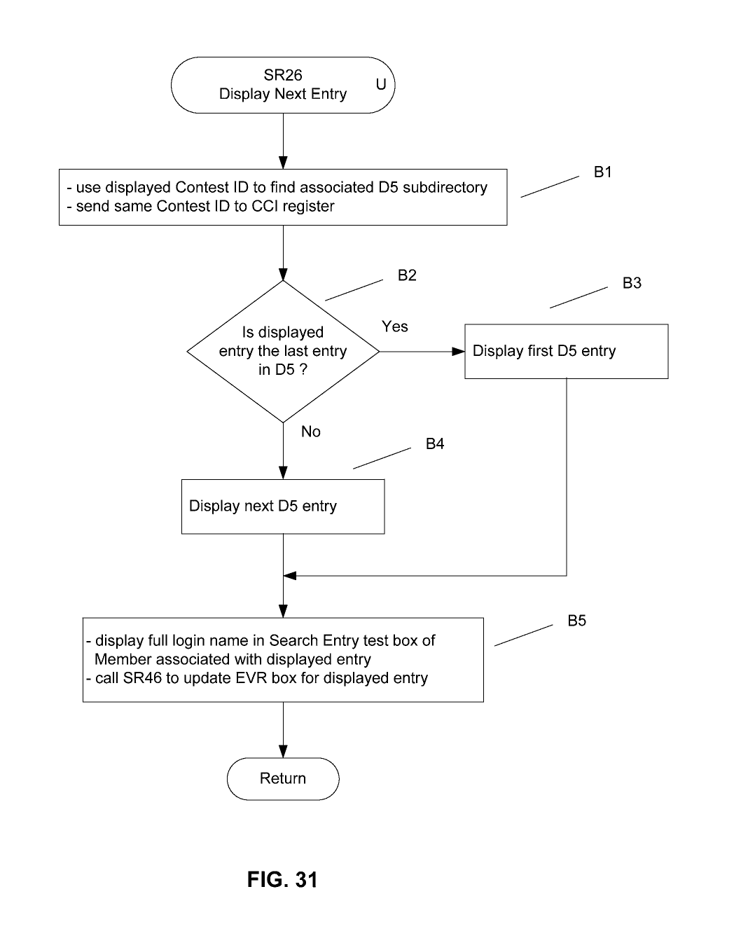

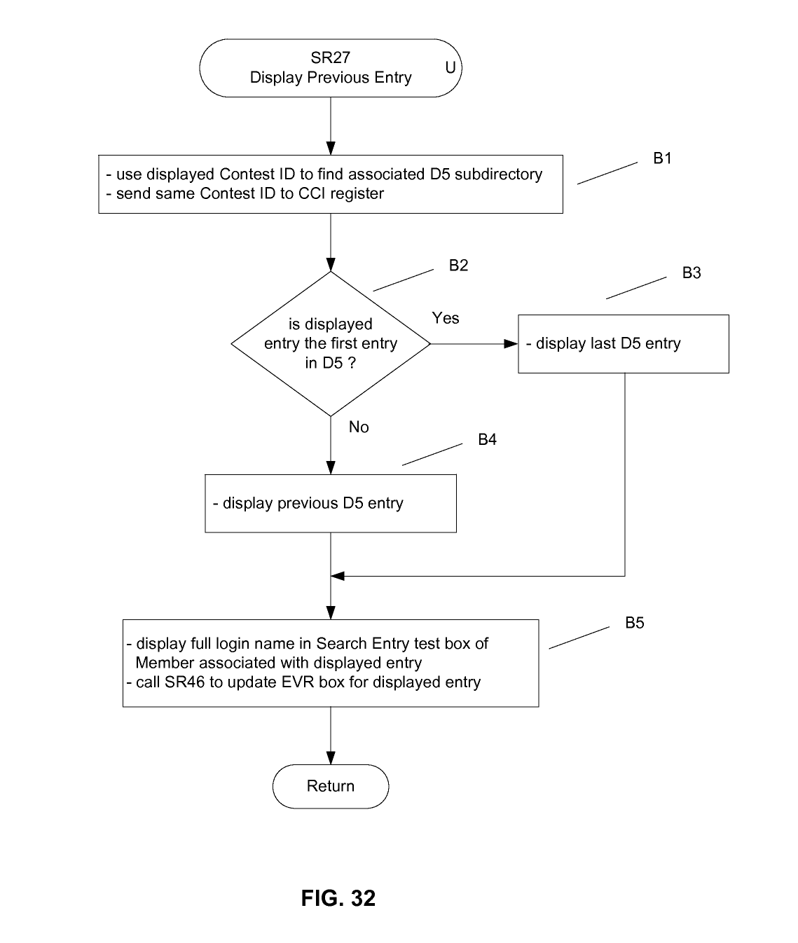

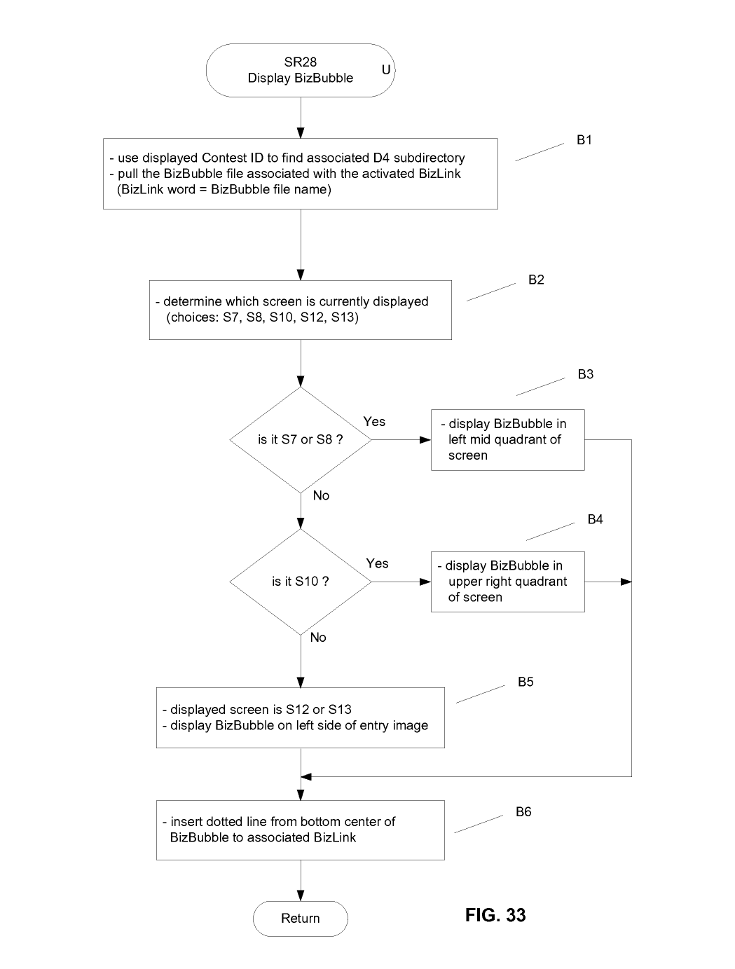

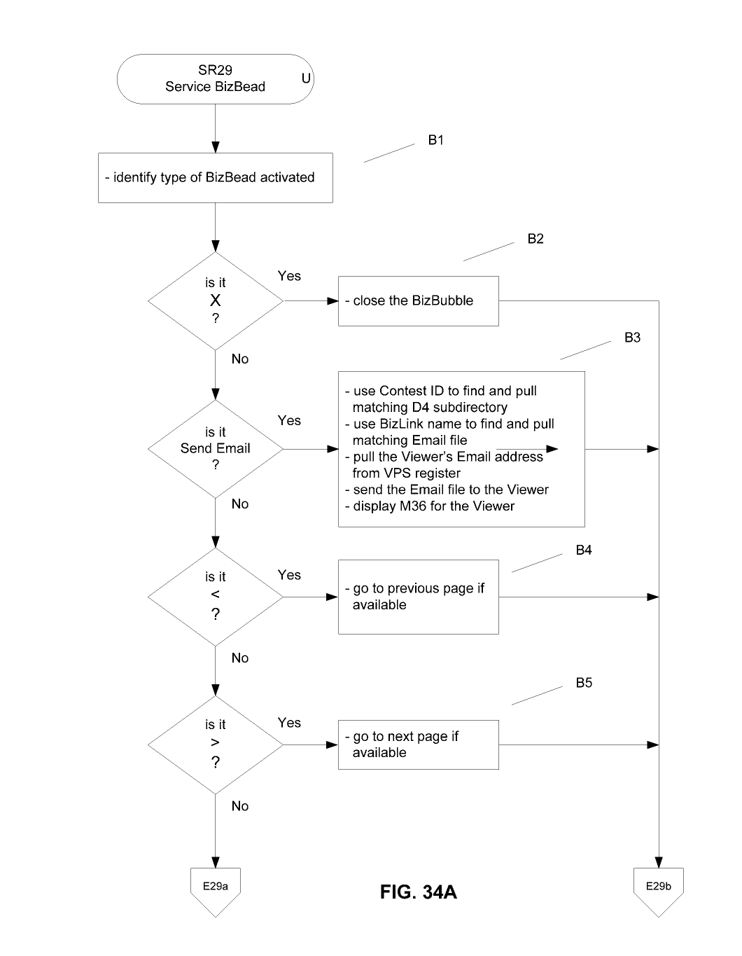

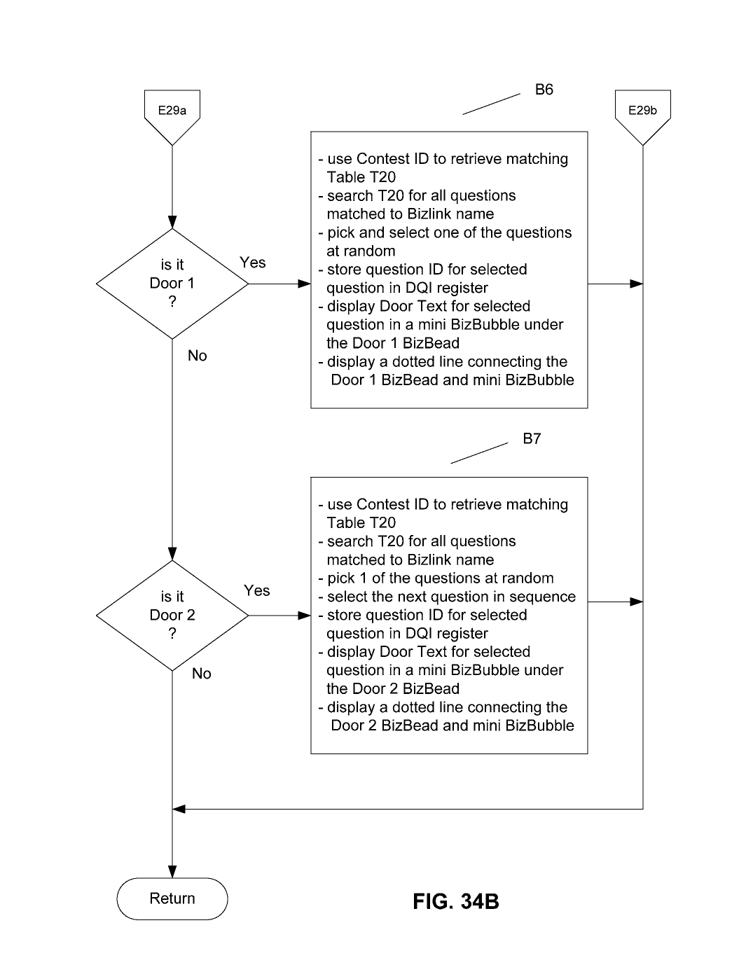

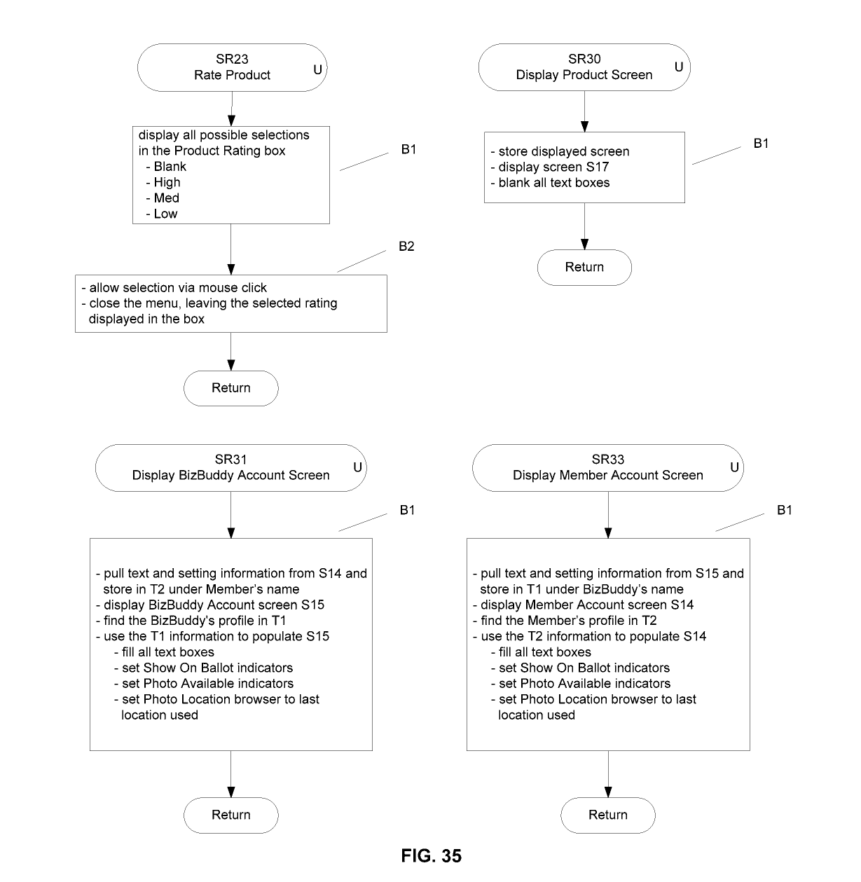

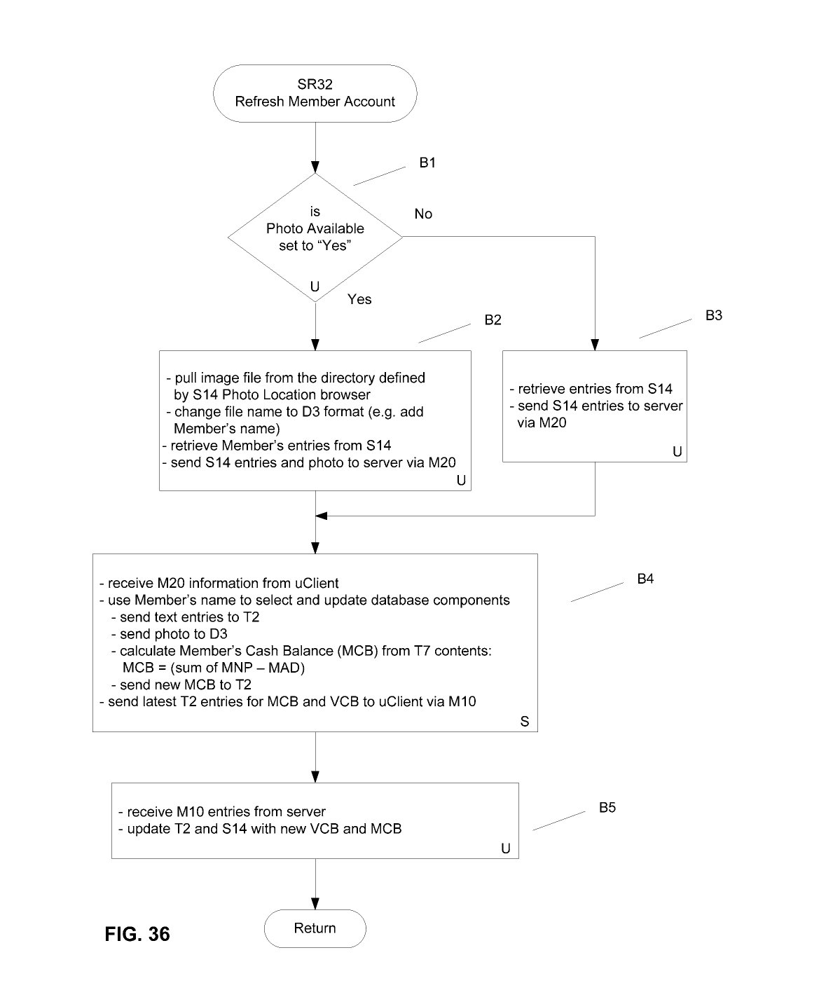

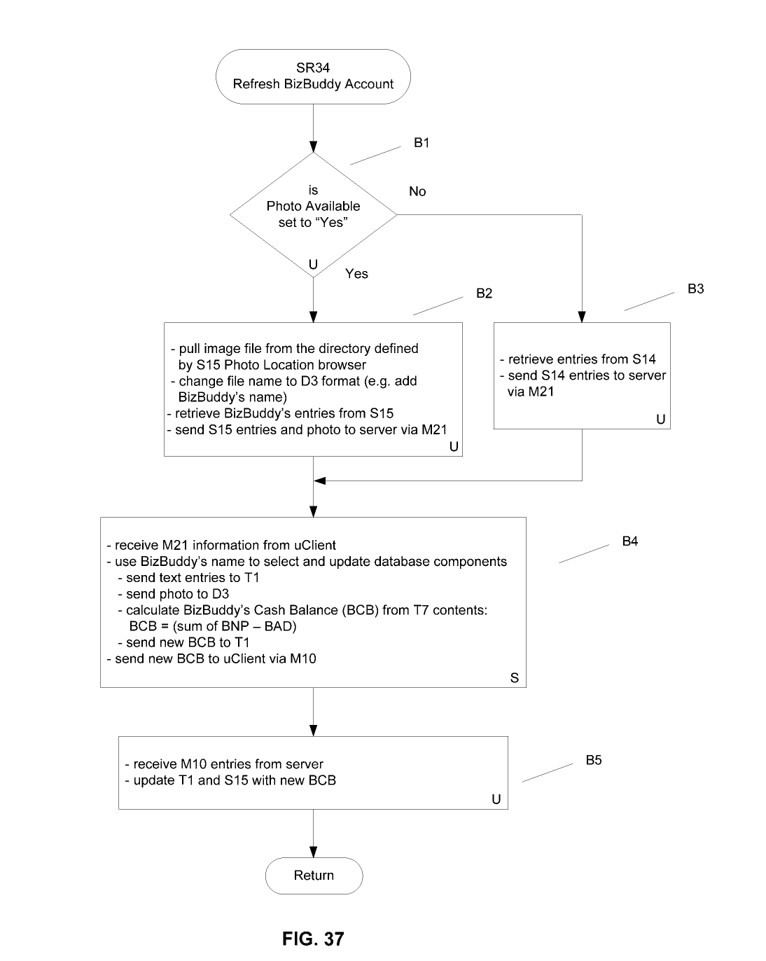

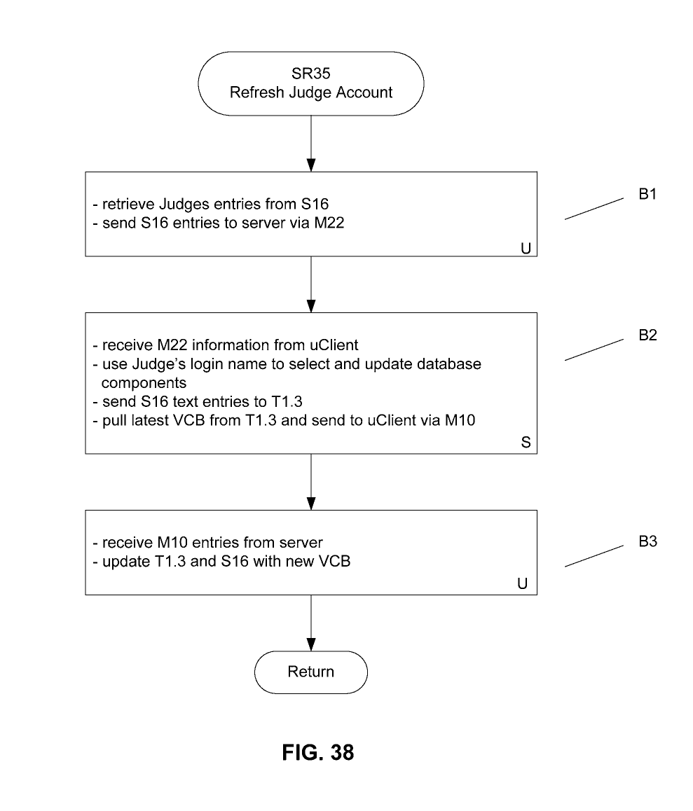

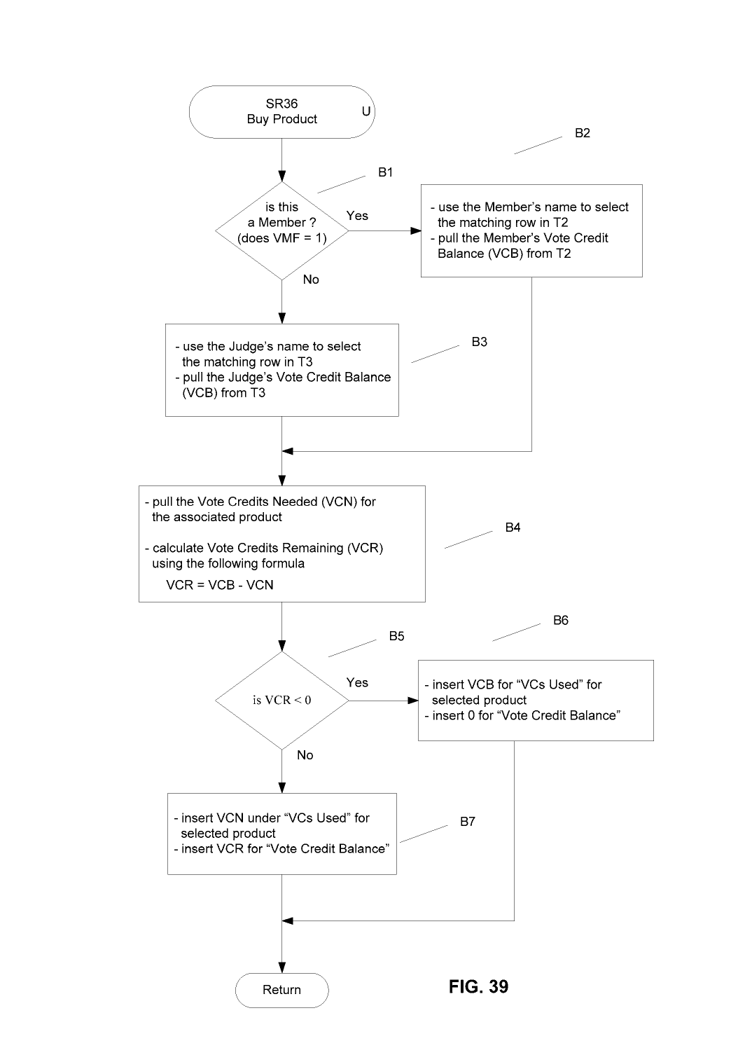

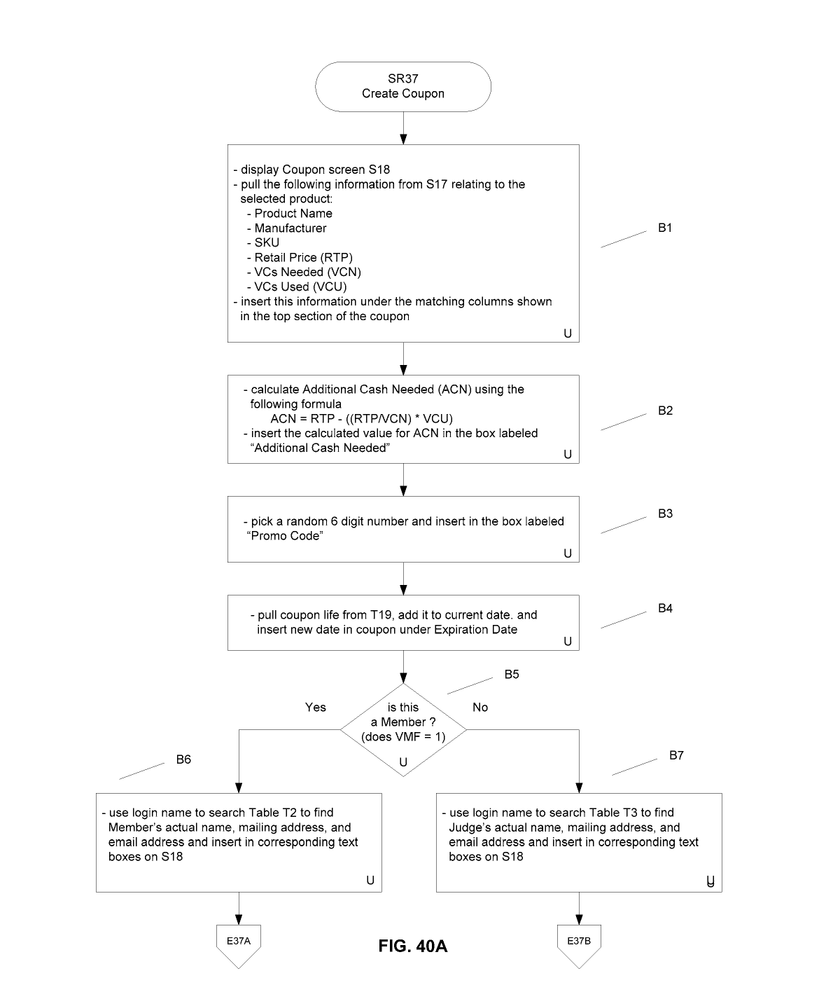

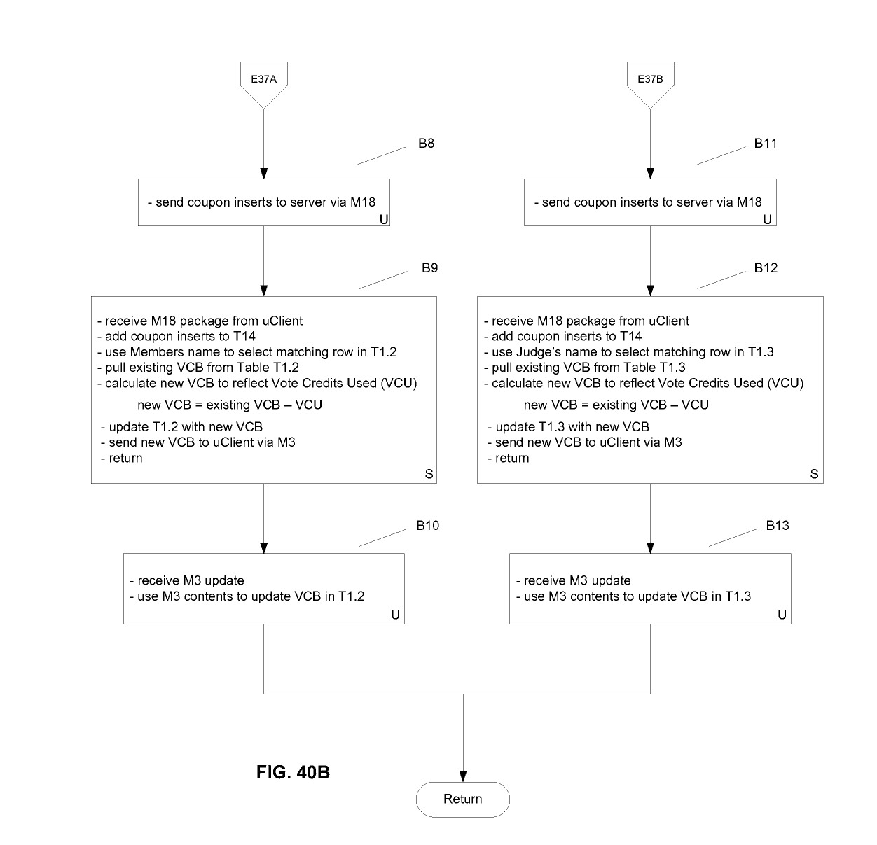

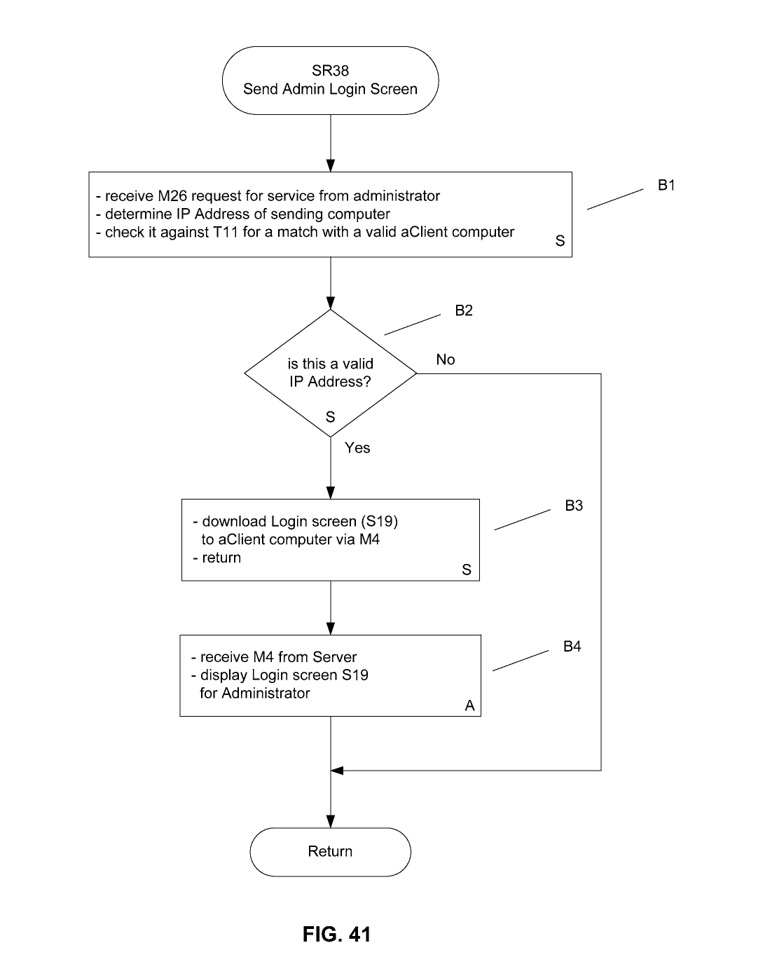

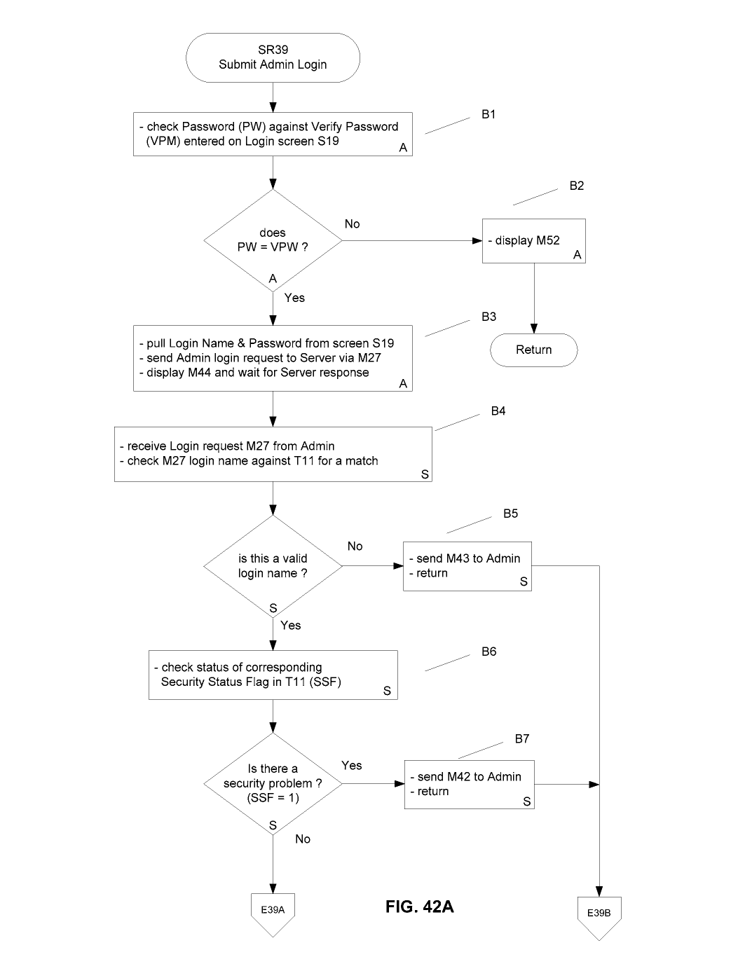

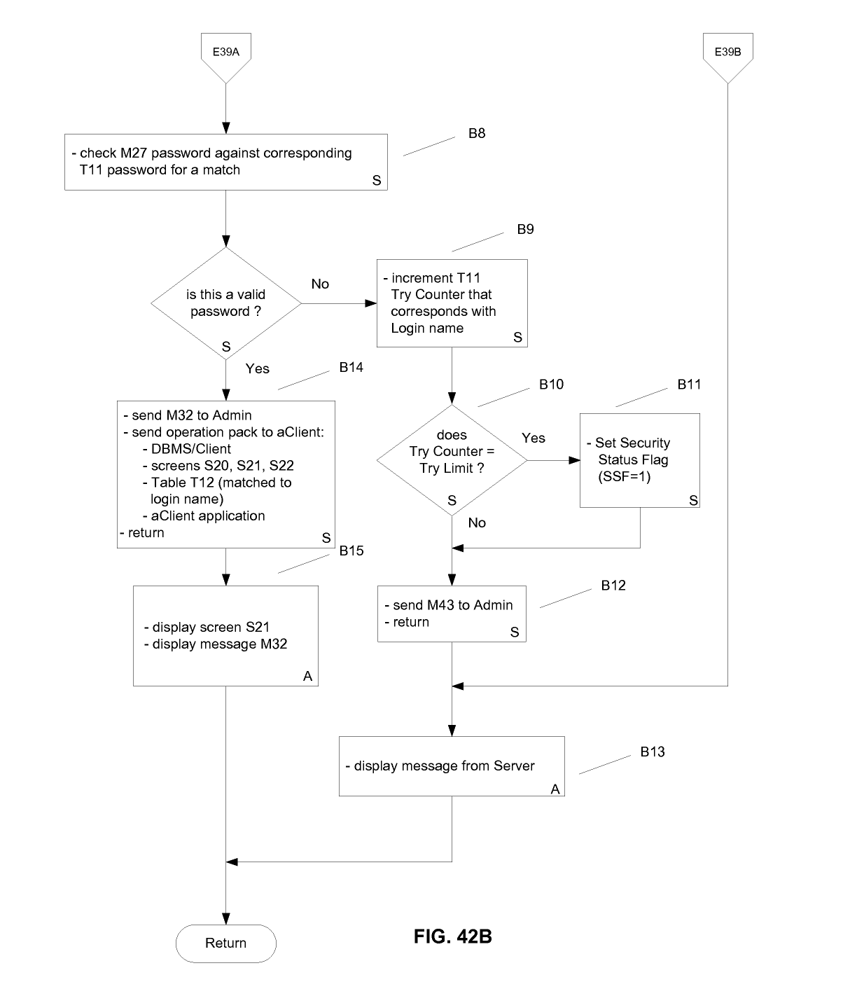

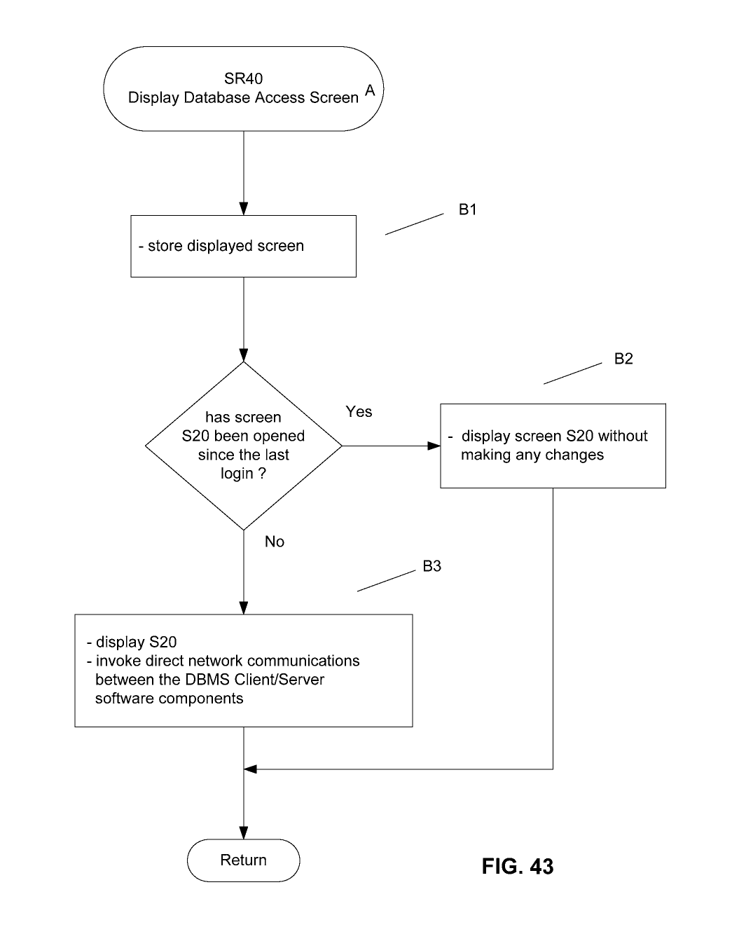

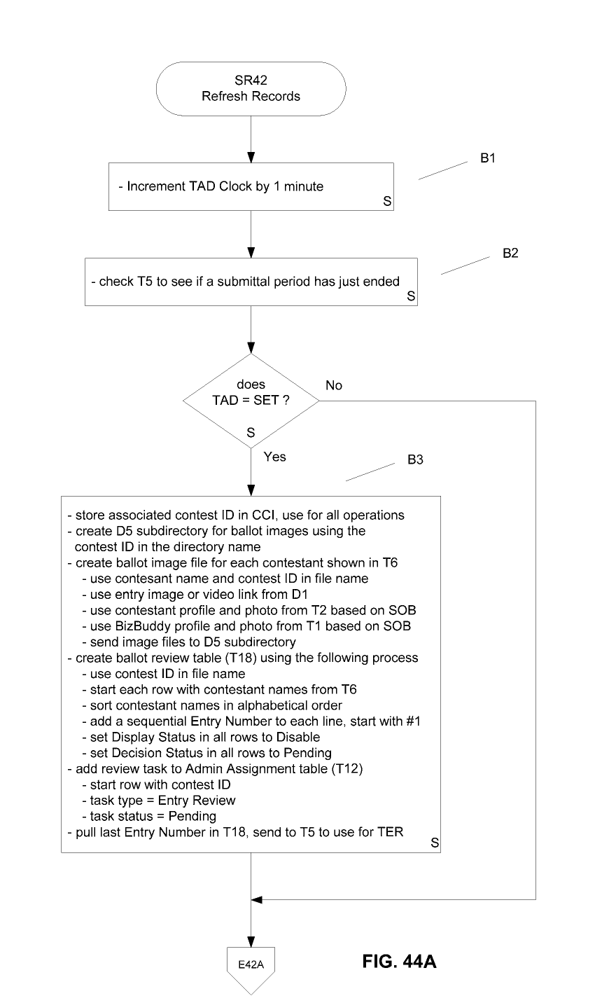

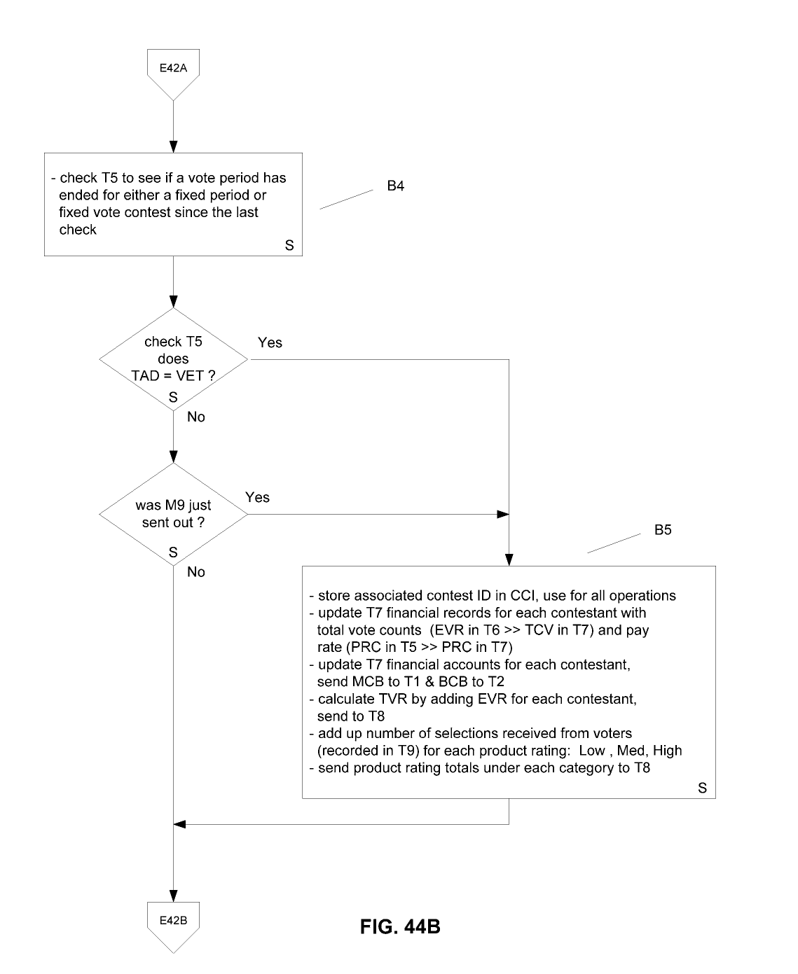

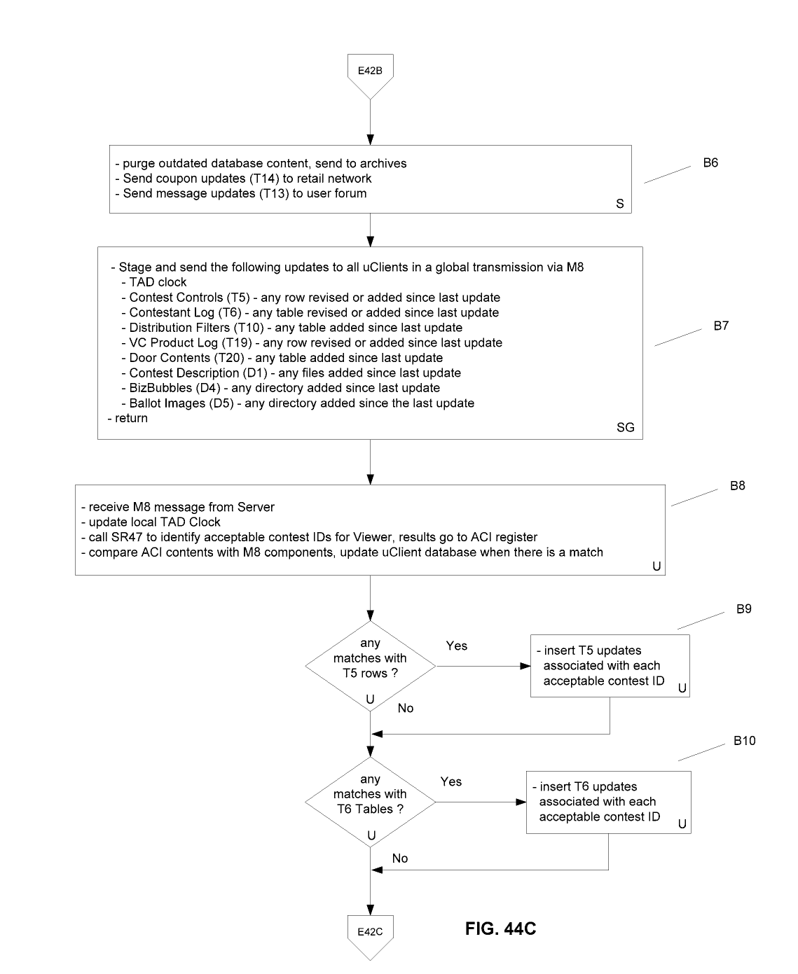

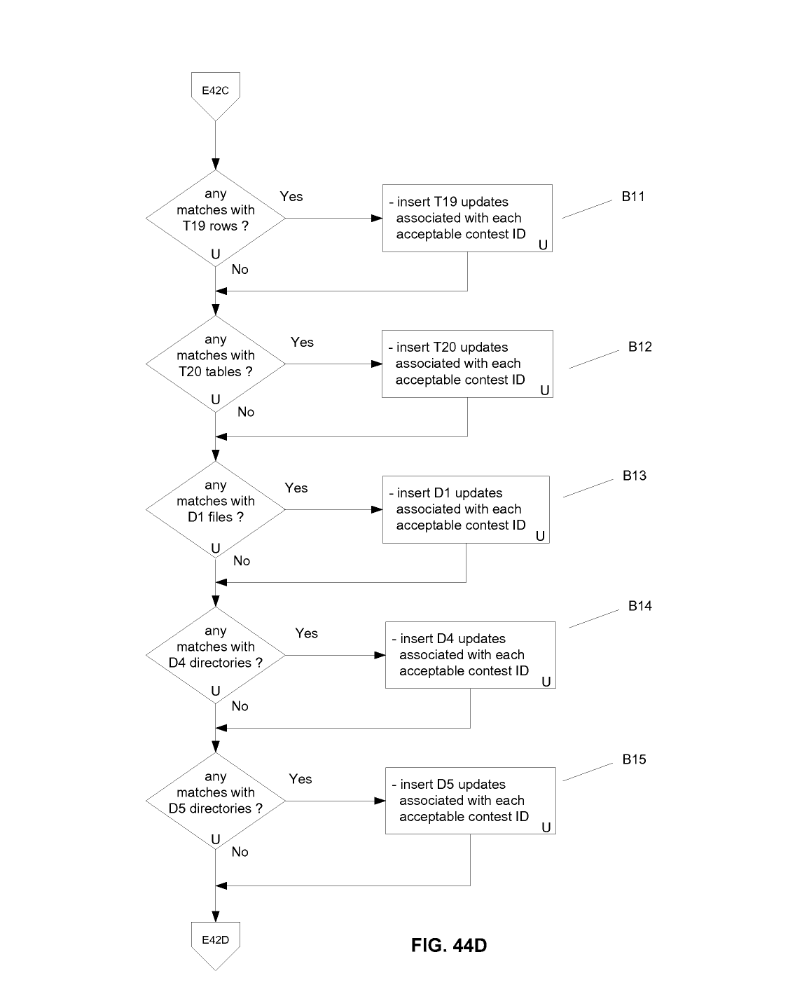

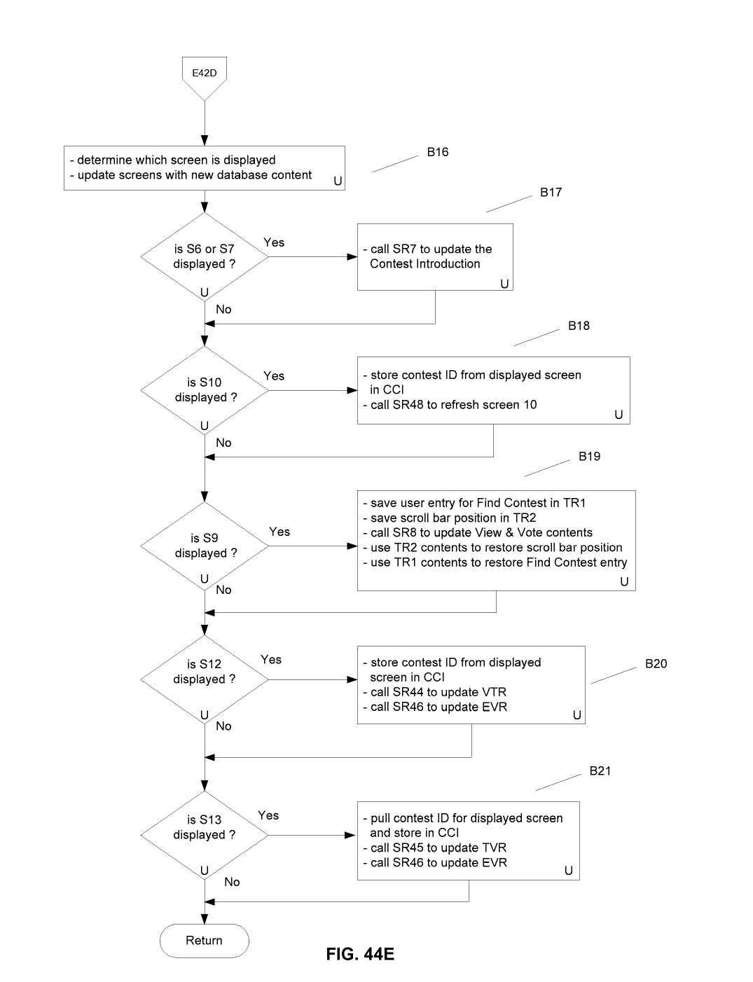

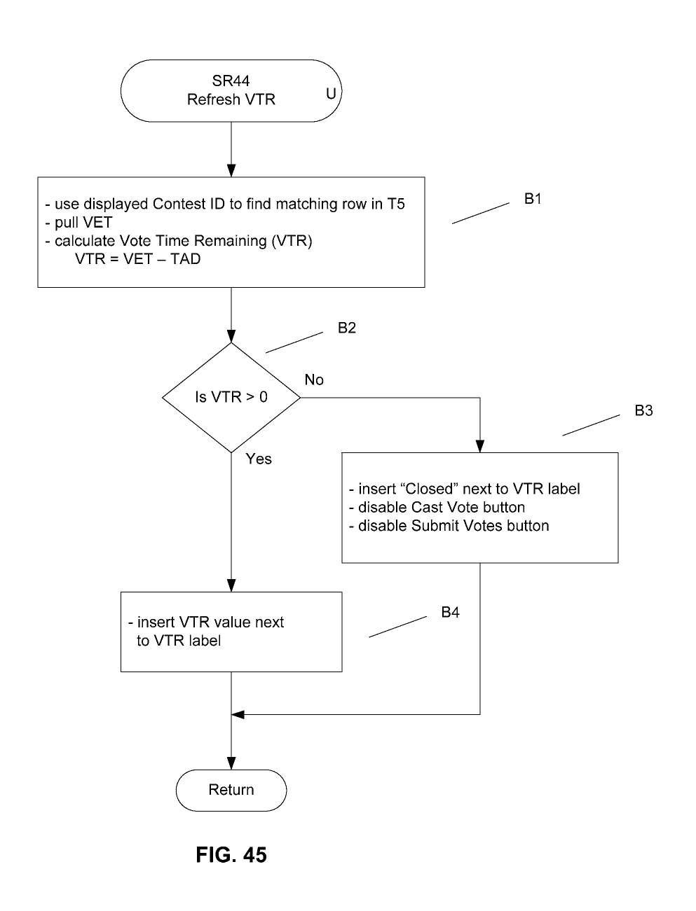

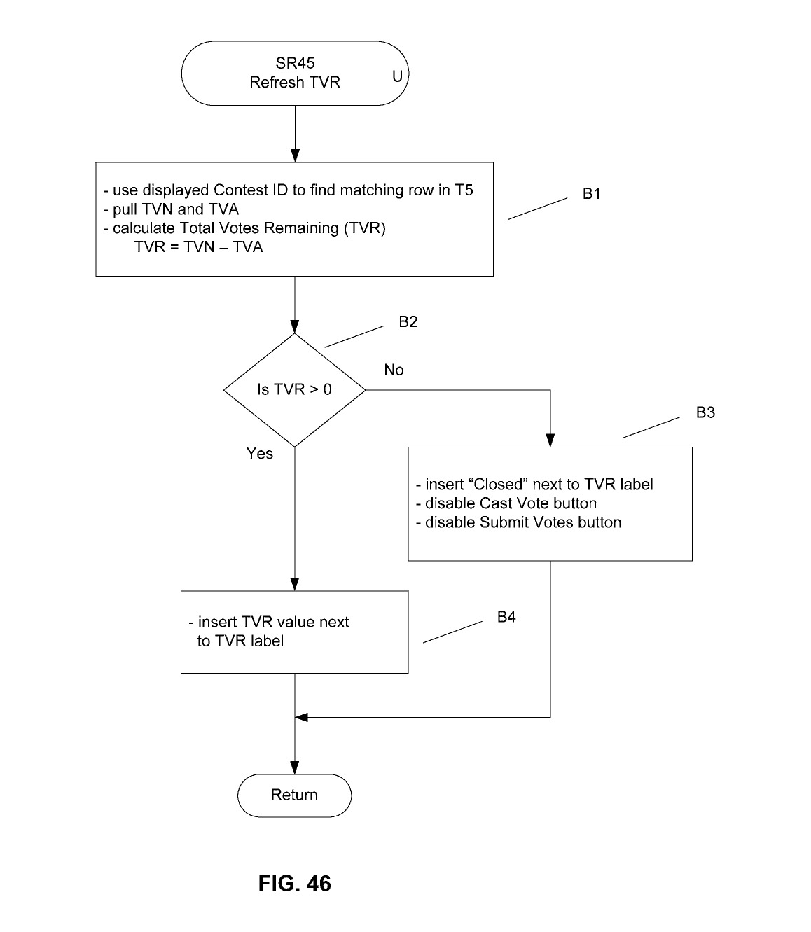

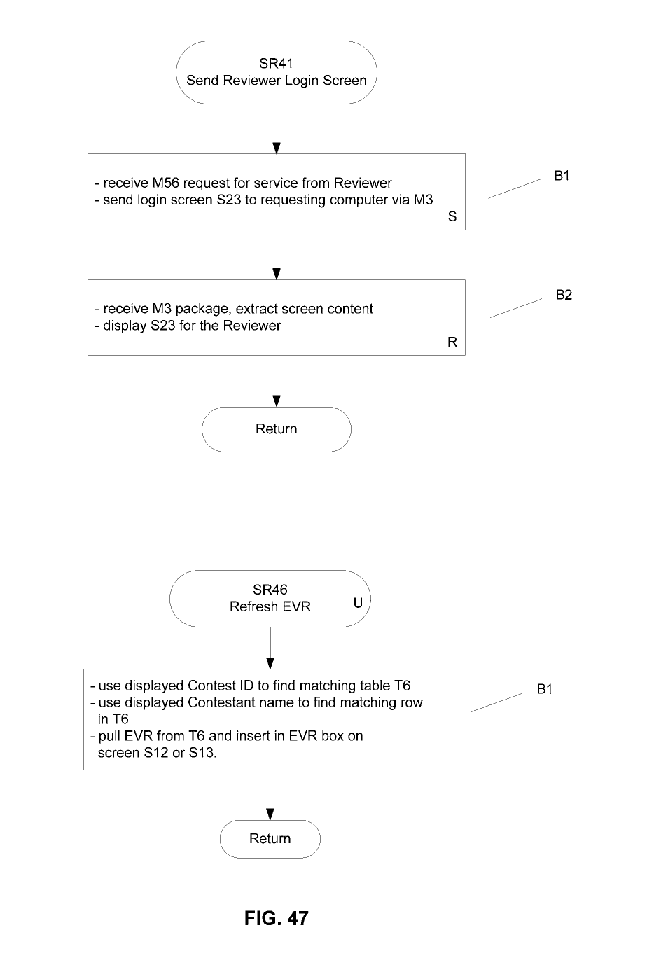

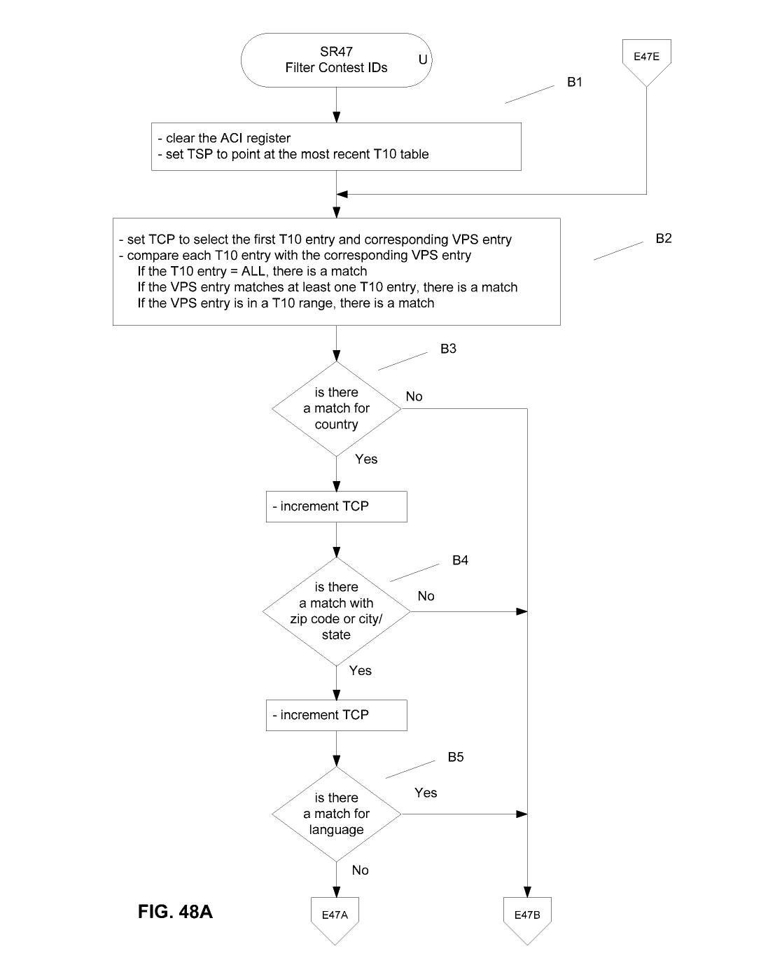

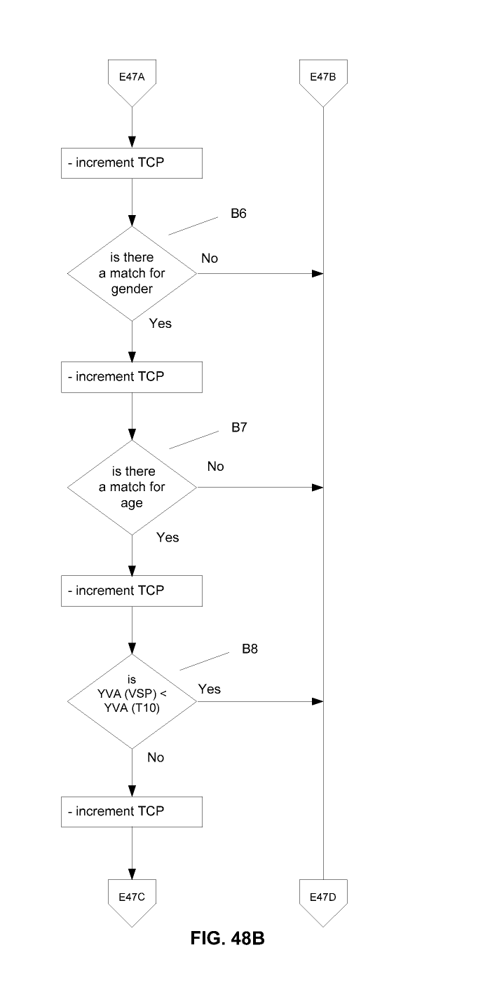

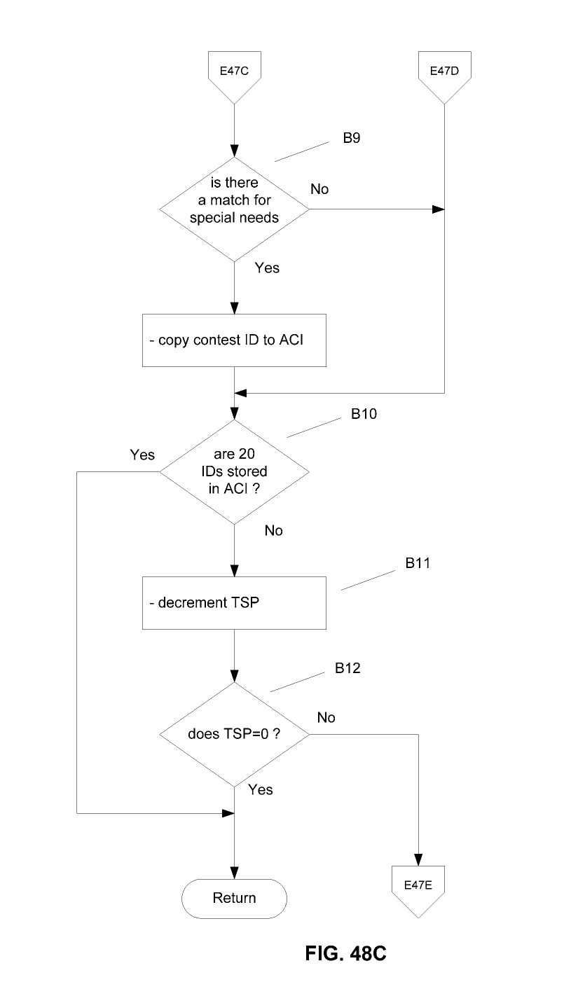

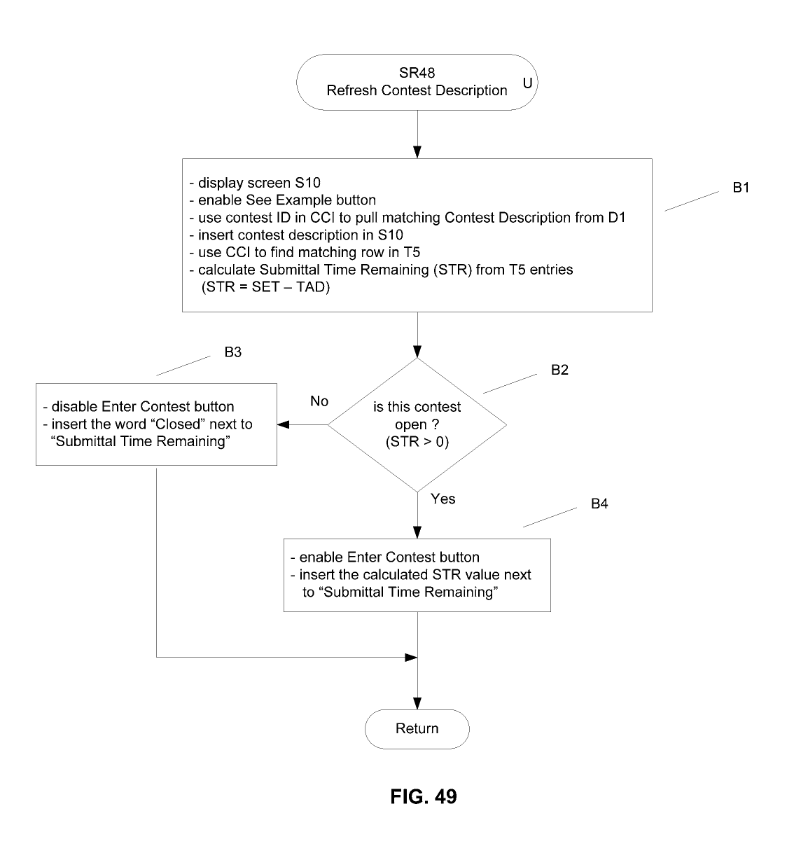

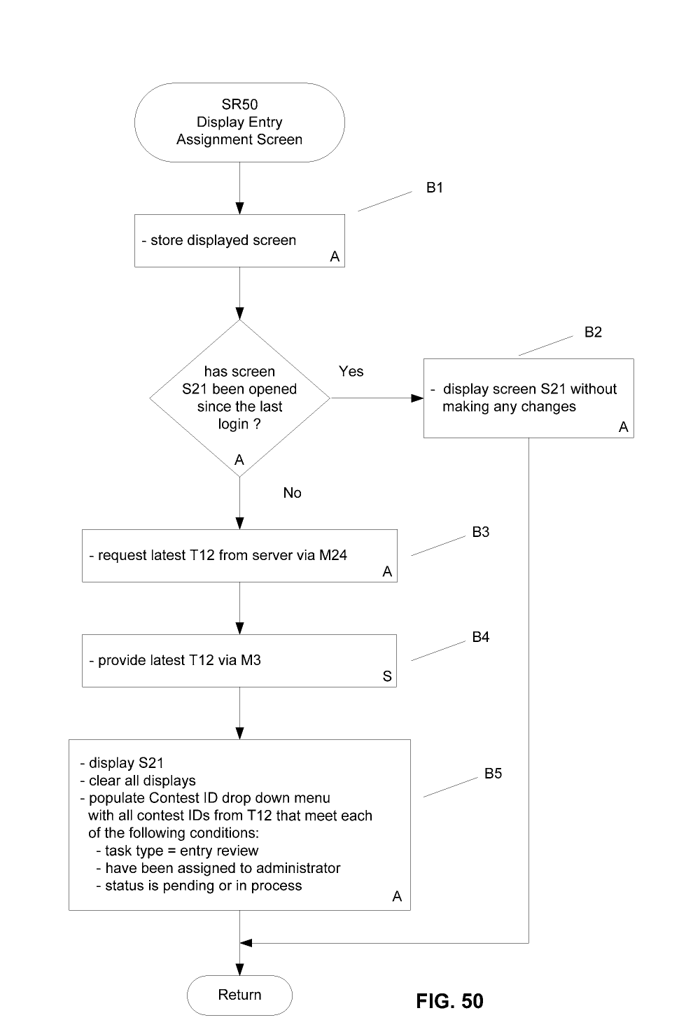

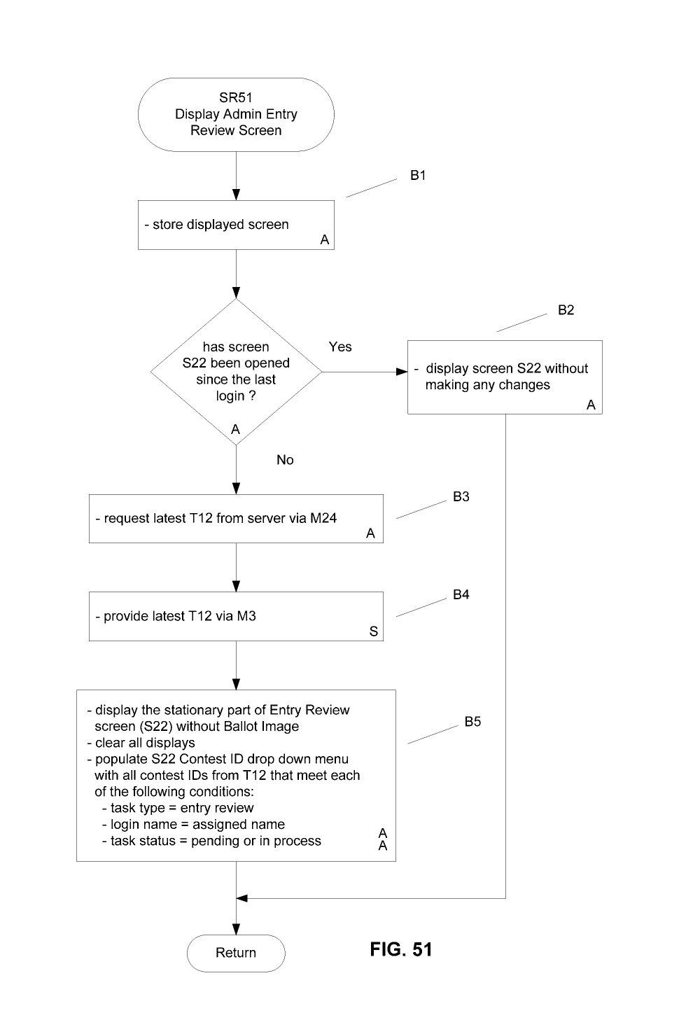

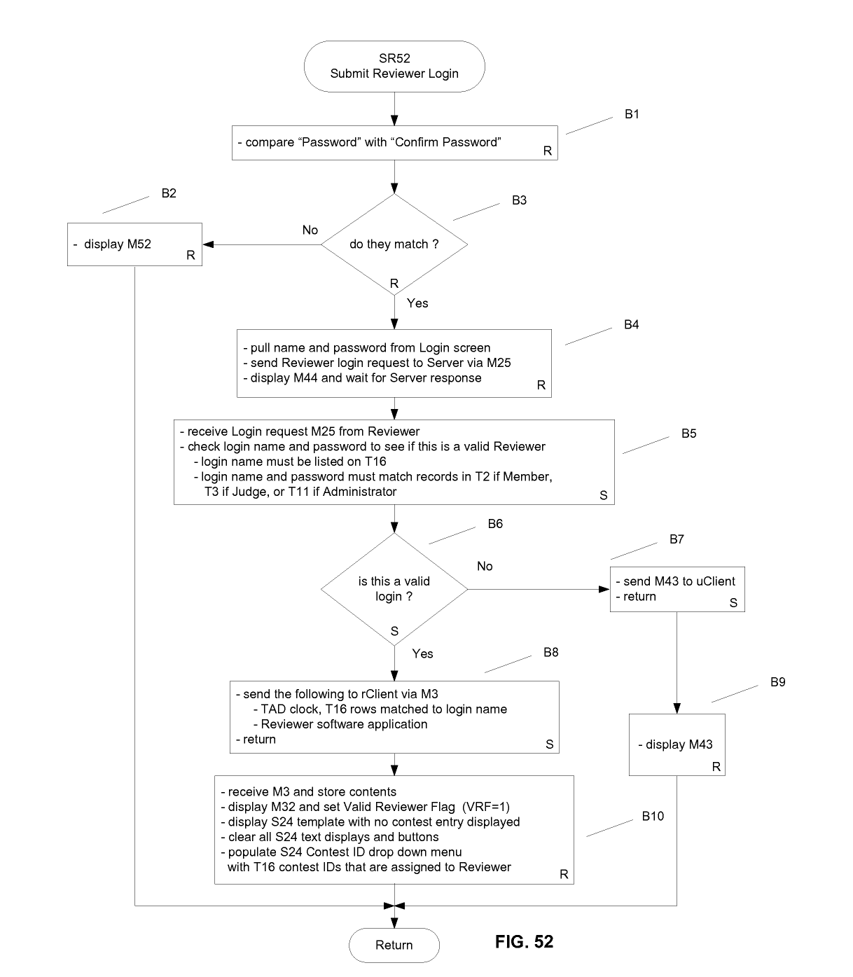

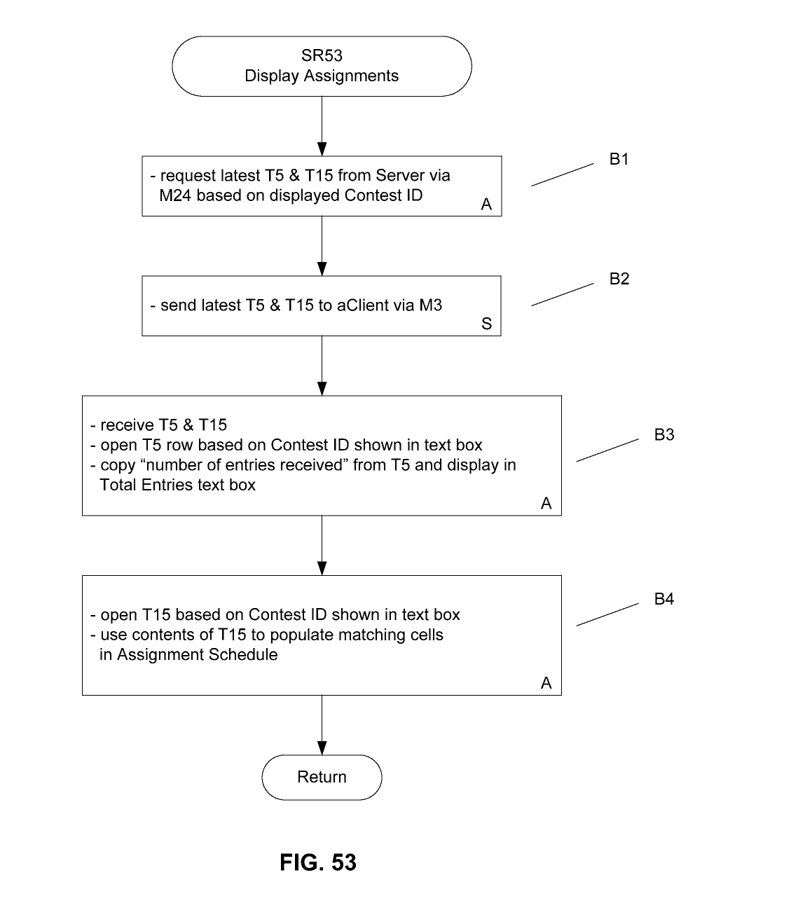

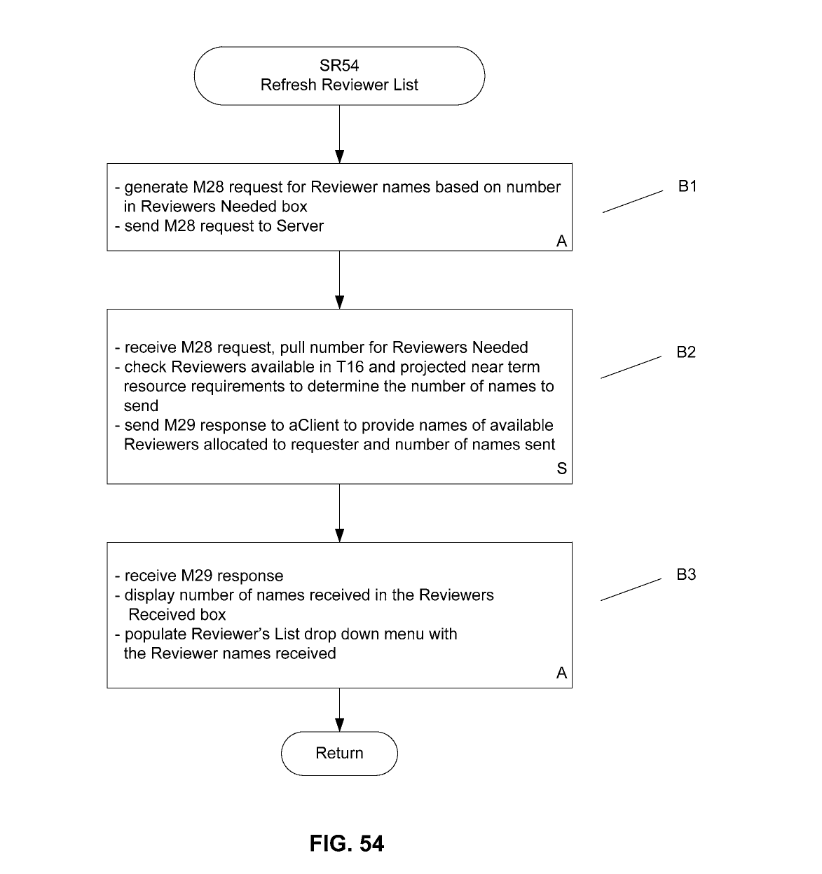

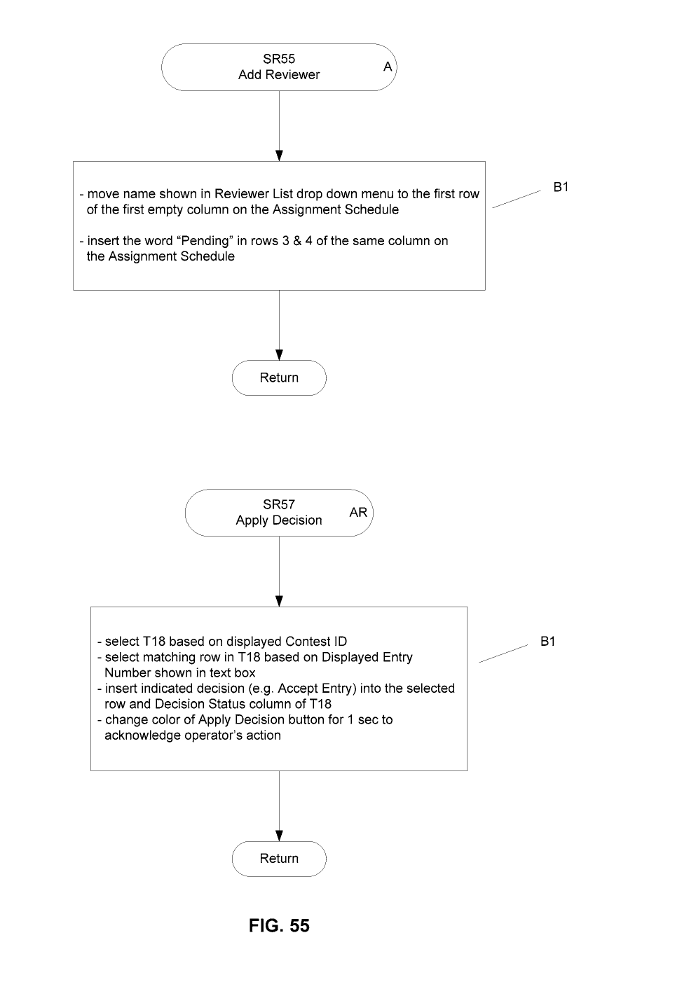

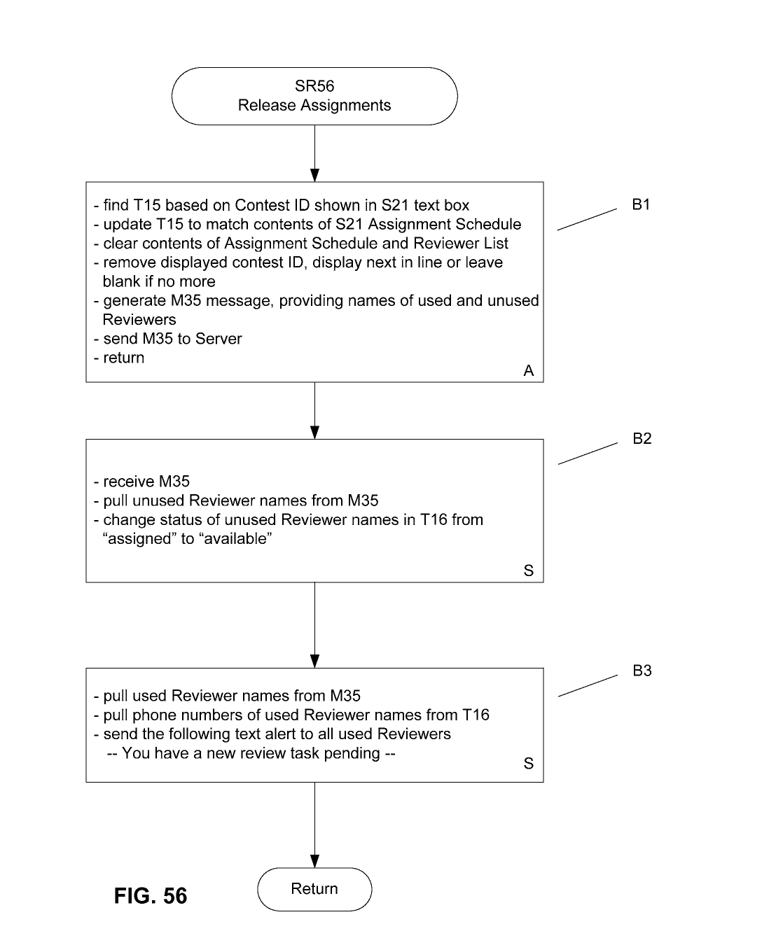

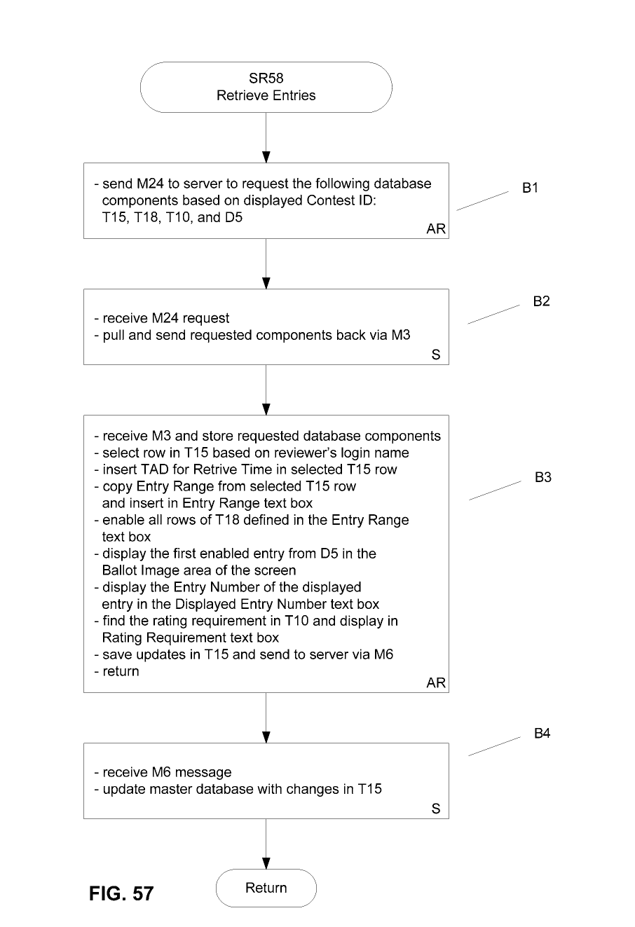

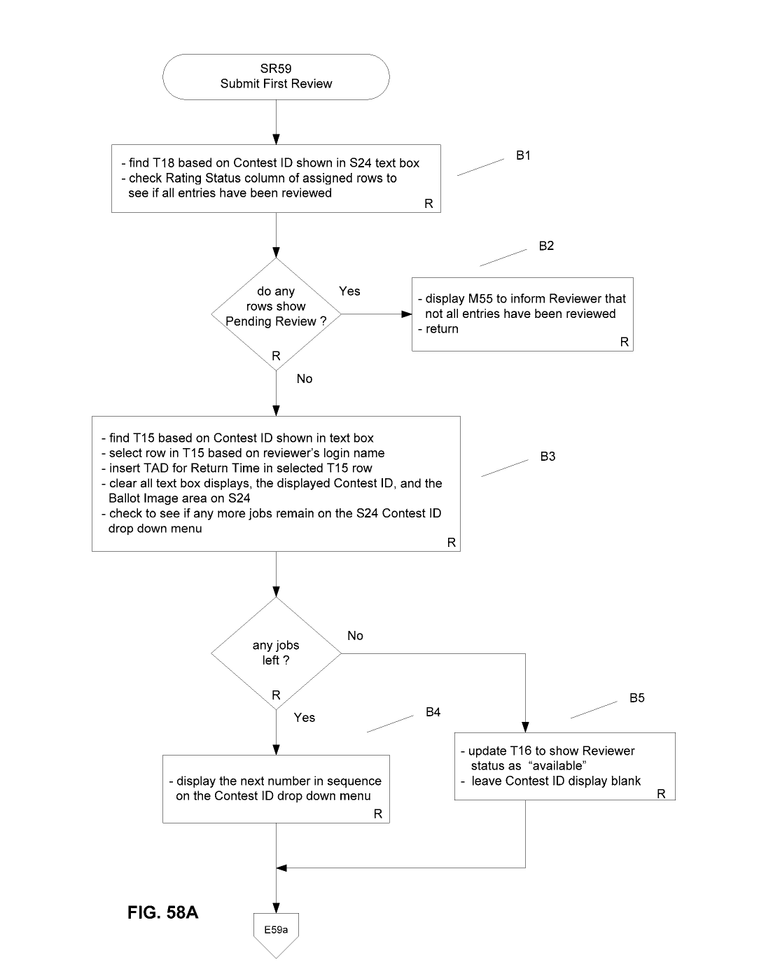

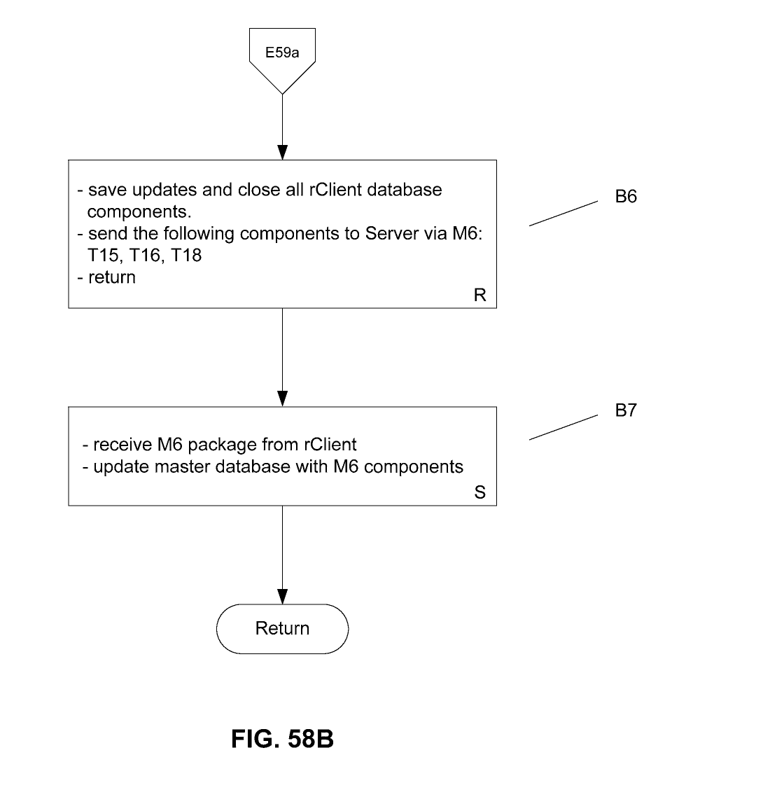

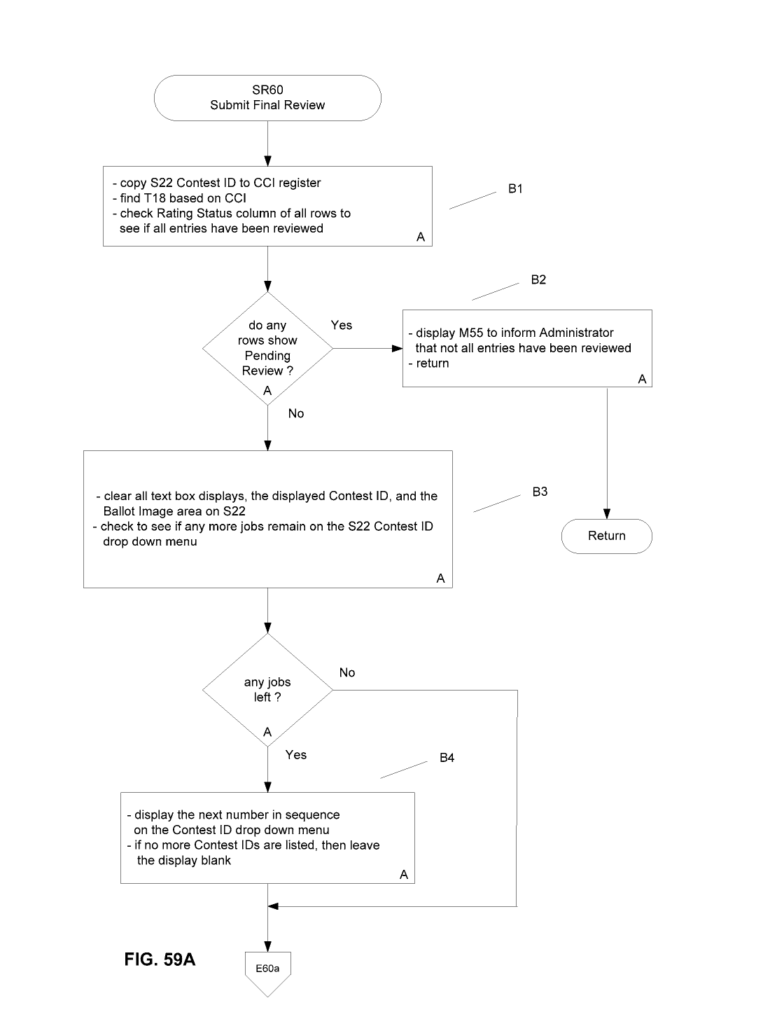

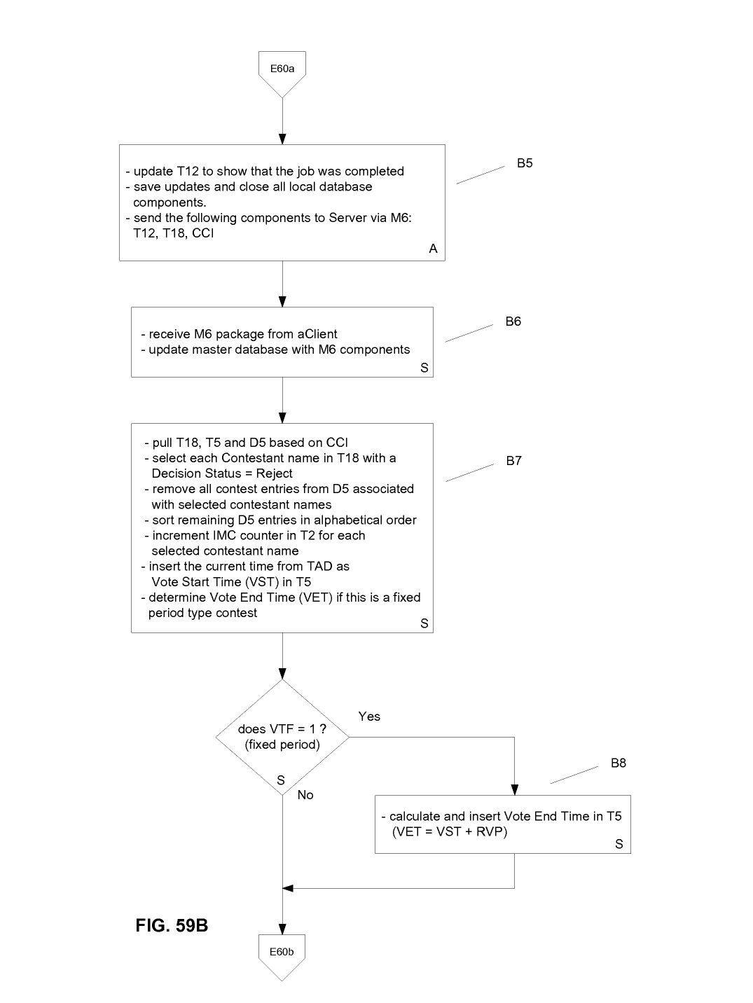

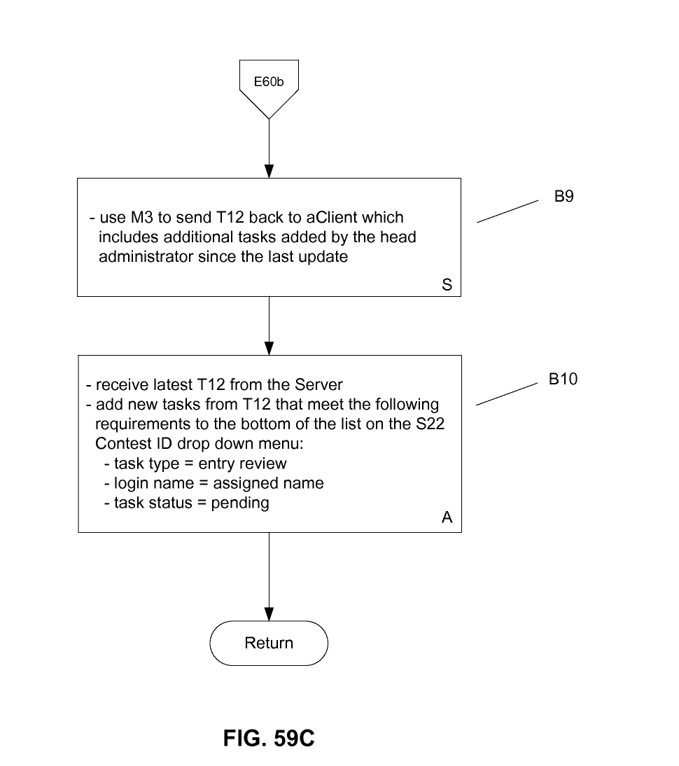

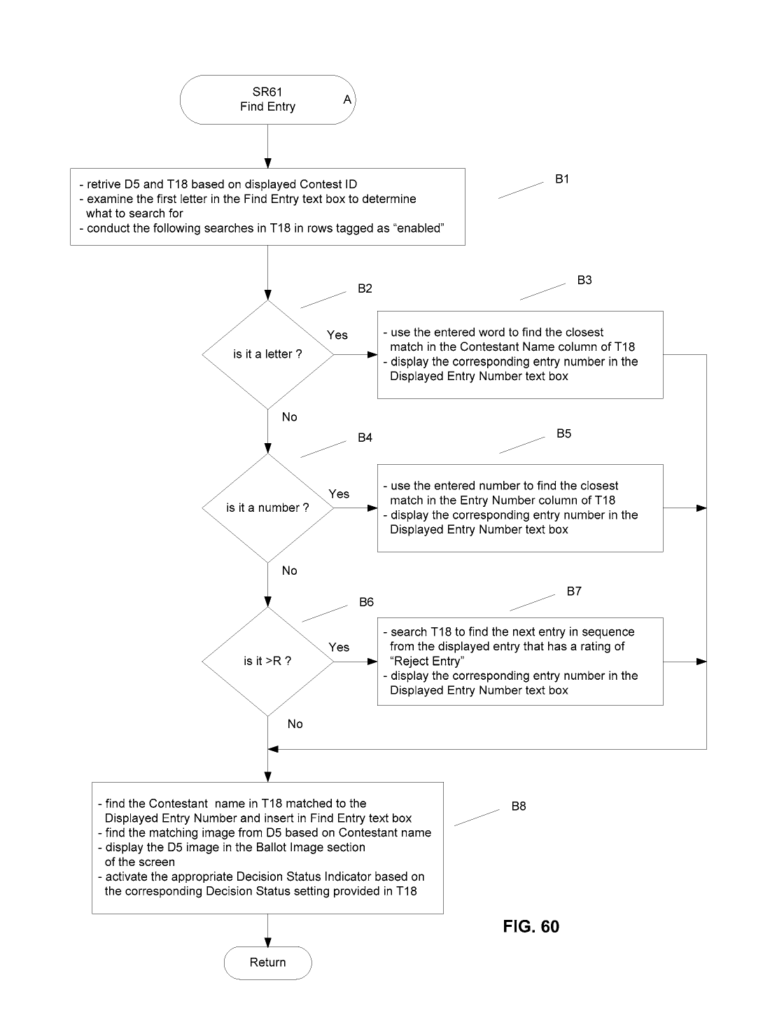

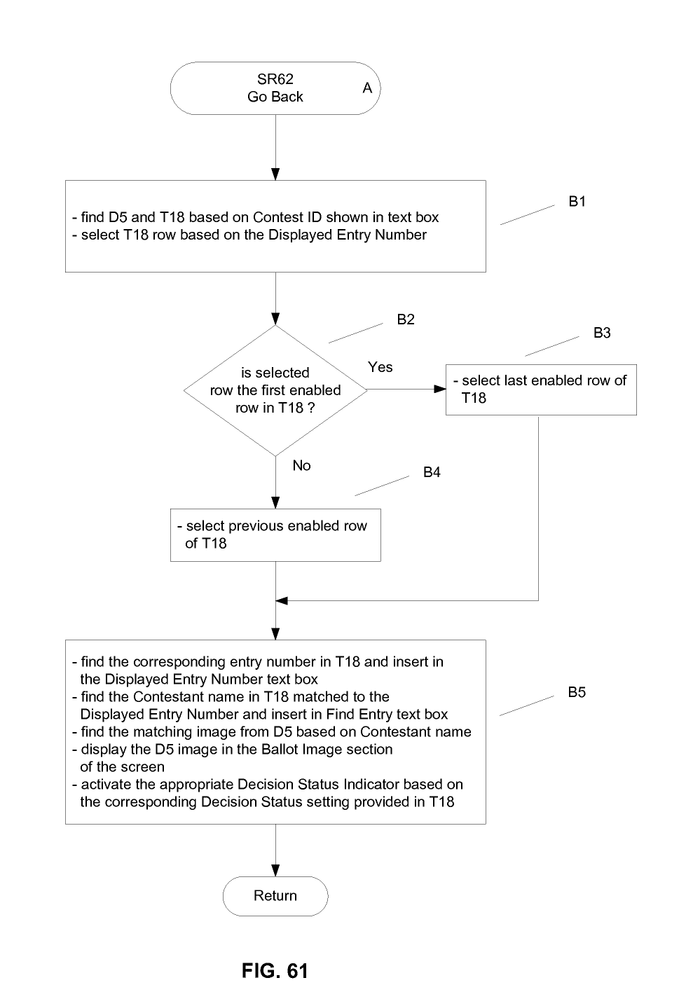

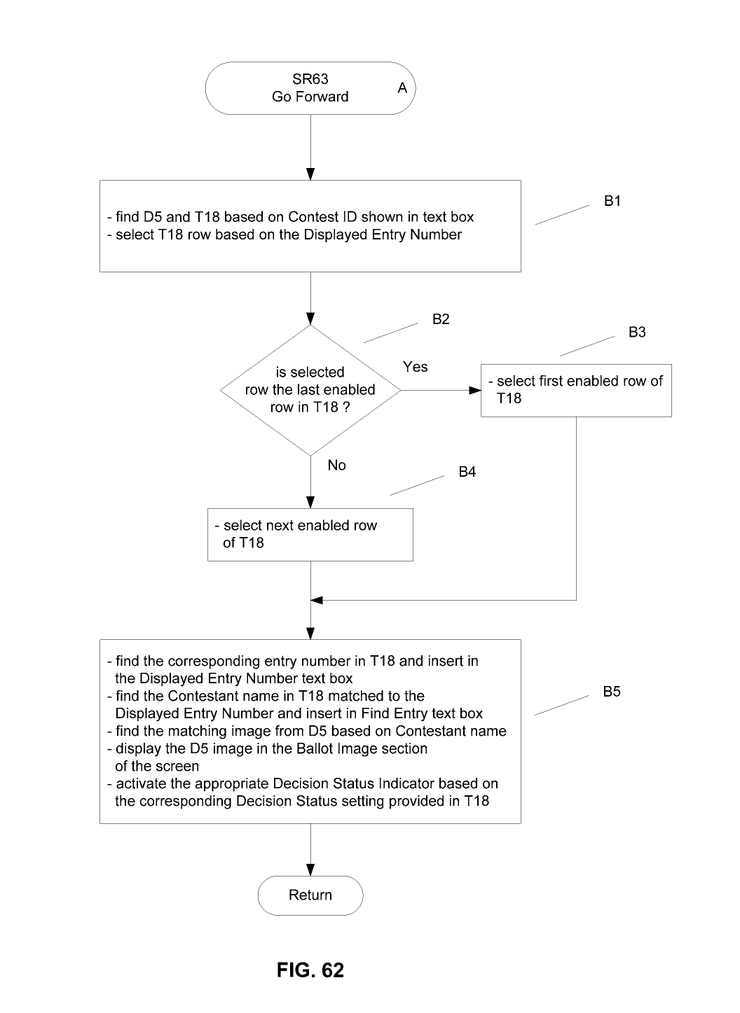

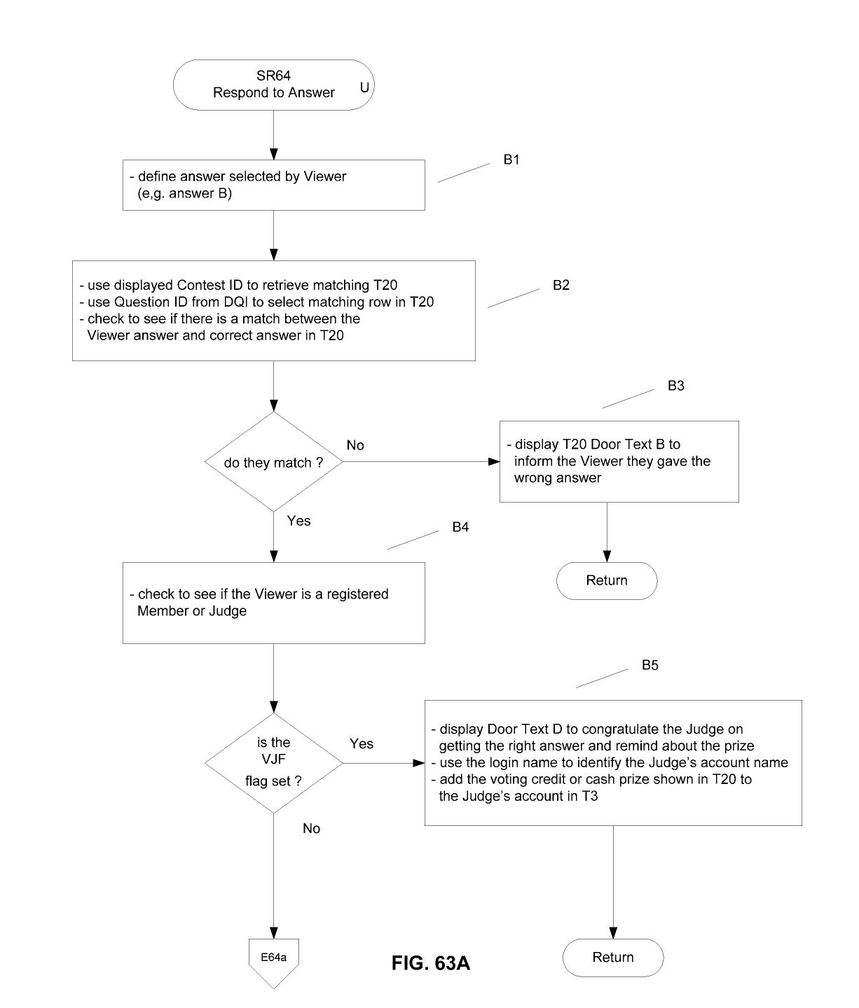

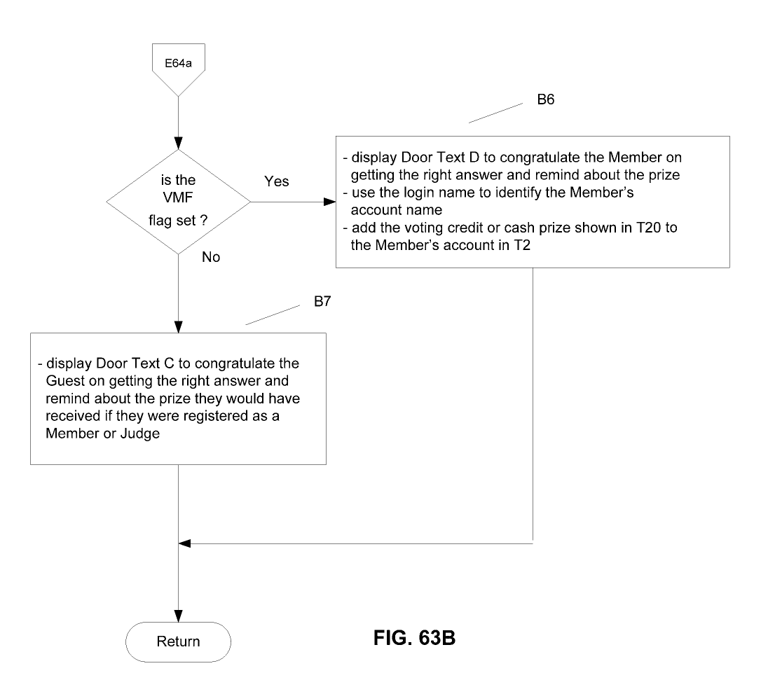

There are a total of 64 different subroutines. FIGS. 5A and 5B provide a listing of all subroutine names, along with a cross reference to the associated subroutine number (e.g. SR63), screen reference (e.g. S3), trigger name (e.g. Login Tab), and trigger source (e.g. S5.1). The flow charts associated with each subroutine are provided in FIGS. 12-63.

This section provides a detailed description for each subroutine. The following provides some guidelines to use when reviewing this information:
In many cases the data flow moves between multiple computer types. To identify which computer is performing the processing, a computer code letter is inserted in an open area on the bottom or right side of the flow chart element. In cases where all elements within the flow chart are handled by the same computer type, the coded letter is inserted only in the title element. The codes are defined below:
S=Server
U=uClient (User)
A=aClient (Administrator)
R=rClient (Reviewer)
G=Global (appended to identify when global a command is transmitted or received)

### SR1—Send Viewer Intro Screen

The purpose of this subroutine is to display a simple introductory screen (S1) which will allow the Viewer to identify if they are a registered User (Member or Judge) or a non-registered Guest (anyone). The response from the Viewer will dictate how the Server proceeds with login and collecting Viewer information. A Judge or Member receives a User login screen (S3) and a non registered Viewer receives a Guest login screen (S2). The introduction screens are simple enough to use embedded software for detecting viewer actions and communicating with the Server. Once the login screens are received, the Server sends a complete uClient software application and supporting files for operating the web site.

This subroutine is triggered when a URL request is received from a uClient computer. First the Server responds by downloading to the uClient screens S1, S2 and S3 via M1 [B1]. Next the uClient receives M1 and stores S1, S2, S3 on local disk [B2]. Finally the uClient displays S1 for the Viewer [B3].

### SR2—Display Login Screen

The purpose of this subroutine is to display the login screen (S3) for Users.

This subroutine is triggered when the A Registered Member or Judge button (S1.1) or Login tab (S4.2) is activated. The uClient responds by storing the displayed screen (if any) and then displaying S3 [B1].

### SR3—Display Guest Screen

The purpose of this subroutine is to display screen (S2) for the Guest. This subroutine is triggered when the A Guest button (S1) is activated. The uClient responds by displaying S2 [B1].

### SR4—Submit Guest Profile

The purpose of this subroutine is to retrieve uClient preference selections from a Guest and send them to the Server where they are used to pull screens and contest information matched to the viewer's preferences. The contest information is sent back to the uClient where it is used by other subroutines for displaying the contest descriptions and voting ballots.

This subroutine is triggered when the Submit Guest Profile button (S2.1) is activated. First the uClient responds by pulling the profile information from the screen, adding a default YVA of “1” for the Viewer (“suitable for all Viewers” is used as a default since the Viewer may be a child trying to log on with a fake age), storing the profile in the VPS register, sending the VPS contents to the Server via M23 and displaying status message M44 to inform the Viewer that the login process has started [B1]. The VPS settings are retained locally by the uClient and used by other subroutines for updating and displaying information matched to the Viewer.

The Server uses the VPS preference selections to find the appropriate software components and send them to the uClient via M2 [B2]. The components consist of: 1) the 20 most recent contest descriptions and voting ballots that match the Viewer preferences, 2) tables, directories, message template, 3) screens S4-S13 that match the Viewer style selection, and 3) the TAD clock which is required for operating all Client computers.

The uClient responds to the M2 message by storing the Database components, removing status display M44, and displaying the Home screen (S4) for the Viewer [B3].

### SR5—Display Home Screen

The purpose of this subroutine is to display the Home screen (S4) for the viewer. This subroutine is triggered when the Home tab (S4.1) is activated. The uClient responds by storing the displayed screen and displaying S4 [B1].

### SR6—Display Registration Screen

The purpose of this subroutine is to display the Registration screen (S5) for the Viewer. This subroutine is triggered when the Registration tab (S4.3) is activated. The uClient responds by storing the displayed screen and displaying S5 [B1].

### SR7—Display Contest Intro Screen

The purpose of this subroutine is to display either a closed curtain stage (S6) or an open curtain stage (S7). The closed curtain stage is used to show that a new contest is pending and includes a message to inform Viewers when the next contest will begin. The open curtain stage is used to announce that a new contest has started, provide details on the contest rules and objectives, and let the Viewers know how much time is left to submit their entries. The curtain is closed after the contest submittal period is over or 5 minutes before the next contest is scheduled to start, whichever comes first.

The contest is considered “open” from the time the curtain opens (submittal start time) until the submittal end time, which are both set by contest Administrators prior to starting the contest. Submittal start times are staggered (e.g. every 10 minutes) to allow each contest to have its own start time and introduction. It's possible for multiple contests to be running at the same time, however, only the most recently started contest is displayed on the stage. Information on the other open contests can be accessed from the View & Vote screen (S9).

This subroutine is triggered when the Contest Introduction tab [S4.4] is activated. The uClient responds by first computing the following time information on all pending and open contests identified in Table 5 [B1].
TUS (Time Until Submittal)
TSS (Time Since Submittal)
STR (Submittal Time Remaining)

Next the uClient checks to see if there are any contests pending or open by looking for at least 1 contest with a positive number for TUS or STR [B2]. If there are no contests pending or open, the closed curtain is displayed, along with a message that tells the Viewer to stay tuned for the next contest, but does not provide a starting time [B3]. If there is at least 1 contest pending or open, the uClient checks to see if there are any contests scheduled to start within 5 minutes [B4].

If yes, the uClient displays the closed curtain along with a message that tells the Viewer the amount of time remaining until the next contest starts (TUS) [B5]. If no contests are scheduled to start within 5 minutes, the uClient checks to see if there are any open contests [B6]. If yes, the uClient selects the contest with the lowest TUS, stores the contest ID in the CCI register for use by other subroutines, and displays the corresponding contest description on screen S7, along with a message to tell Viewers how much time they have to submit their entries [S7.1] [B7]. If there are no open contests, the uClient finds the next scheduled contest by looking for the lowest TUS [B8]. A TUS message is then displayed [S6.1], along with a closed curtain (S6.2), to tell Viewers when the next contest will start.

### SR8—Display View & Vote Screen

The purpose of this subroutine is to build and display the View & Vote screen (S9). The contest information is pulled from T5 and used in calculations to create the necessary links, values, and text for the screen, including:
Contest ID's and Names
Links to Contest Descriptions
Submittal Time Remaining
Vote Time Remaining or Total Votes Remaining
Links to Voting Ballots

This subroutine is triggered when the View & Vote tab [S4.5] is activated. The uClient responds by first setting up a pointer (TCP) to allow each T5 row to be selected for data retrieval and the equivalent S9 row [S9.20] to receive data [B1]. The TCP pointer is set to the number of T5 table rows (oldest contest at the bottom of the table) and is decremented until it reaches zero (latest contest at the top of the table). Next the uClient computes each of the key variables for the selected row, consisting of TUS, STR, TUV, VTR, and TVR [B2]. The results of these calculations are used to place the contest into one of the following categories:

### 1) Pending Submittal

### 2) Current Submittal

### 3) Past Submittal

### 4) Current Voting, Fixed Period

### 5) Current Voting, Fixed Votes

### 6) Past Voting, Fixed Period

### 7) Past Voting, Fixed Votes

Next the uClient populates each column of the selected S9 row based on the assigned category [B3-B9], as described below:

### Column 1—Contest ID

In all cases the associated contest ID is displayed under column 1 [S9.1].

### Column 2—Contest Name

The contest names for category 2-7 contests are displayed under column 2 [S9.2] as active hyperlinks (linked to the associated contest description in D1), allowing Viewers to quickly access each contest introduction by clicking the associated link. The contest names for category 1 contests are displayed as disabled hyperlinks, allowing Viewers to get a vague idea of what's in store for the future without seeing any more details until the contest is first introduced and opened via screen S7.

### Column 3—Submittal Time Remaining (STR)

The STR for category 2 contests is displayed under column 3 [S9.3] as an active hyperlink (linked to entry submittal screen S11), allowing Viewers to see the amount of time remaining for each contest and click the link to submit their entry if they are interested in participating in the contest. The word Pending is displayed for category 1 contests and the word Closed is displayed for category 3-7 contests.

### Column 4—Vote Time Remaining (VTR) (for Fixed Period Contests)

The VTR for category 4 contests is displayed under column 4 as an active hyperlink (linked to the associated Voting Ballot screen S12), allowing Viewers to see the amount of voting time remaining in each fixed period contest and to quickly access and display the voting ballots of interest. The word Closed is displayed for category 6 contests as an active hyperlink (linked to the associated voting ballot screen S12), allowing Viewers to quickly access past voting ballots of interest. The word Pending is displayed for category 1-3 contests.

### Column 4—Total Votes Remaining (TVR) (for Fixed Votes Contests)

The TVR for category 4 contests is displayed under column 4 as an active hyperlink (linked to the associated Voting Ballot screen S13), allowing Viewers to see the number of votes needed before the contest is closed and to quickly display the voting ballots of interest. The word Closed is displayed for category 7 contests as an active hyperlink (linked to the associated voting ballot screen S13), allowing Viewers to quickly access past voting ballots of interest. The word Pending is displayed for category 1-3 contests.

Next the TCP is decremented in order to select the next row of T5 and S9 [B10]. The TCP value is checked for zero [B11]. If not zero, the process is looped back to the beginning [B2] so the next row in sequence can be processed. If zero, then all rows have been processed and the completed screen S9 is displayed and the subroutine is terminated [B12].

### SR9—Display User Account Screen

The purpose of this subroutine is to display an account screen, customized to the type of Viewer and populated with the Viewer's most recent user entries and account information from the uClient Database. This subroutine is triggered when the User Account tab [S4.6] is activated. The uClient first responds by checking the VMF and VJF flags to see what type of Viewer is logged into the site [B1, B2, B4].

If it's a Member [B3], the uClient displays S14 and searches for the Member's account information by using the current login name to find and select the matching row in T2. The information from T2 is used to populate the S14 user entry boxes [S14.1-18] and balance boxes [S14.34-35], set the Show on Ballot indicators [S14.21-33], set the Photo Available indicators [S14.19], and set the Photo Location browser [S14.20] to reflect the most recent entries.

If it's a Judge [B5], the uClient displays S16 and searches for the Judge's account information by using the current login name to find and select the matching row in T3. The information from T3 is used to populate the S16 user entry boxes [S16.1-13] and vote credit balance box [S16.14] to reflect the most recent information.

If the Viewer is not logged in, the uClient assumes it's either a Member or Judge that has not yet logged in and displays the login screen S3 [B6].

### SR10—Submit Member Login

The purpose of this subroutine is to submit and attempt to validate a Member's login request. If the request is validated, additional screens, controls, and data are sent to the uClient allowing the Member to enter contests, vote in contests, and manage their personal account.

This subroutine is triggered when the Member Login button [S3.4] is activated. The uClient responds by first comparing the two passwords [S3.2,3] that were entered by the Viewer [B1, B2]. If they do not match, M52 is displayed to inform the Viewer that their 2 entries for passwords do not match [B3] and the process is terminated.

If the 2 password entries match, the uClient proceeds with sending the login name and password to the Server via M14 and displaying status message M44 to inform the Viewer that the login process has started [B4]. Next, the Server checks the login name and password against T2 for a match [B5, B6]. If there is an exact match on name and password, and if the Member is in good standing, the login is validated and the Member's records, appropriate Database components and TAD clock are sent back to the uClient via M2 [B8]. If the login is not validated, M43 is sent to the uClient [B7] where it's displayed to inform the Viewer that the login was not successful [B9].

If the uClient receives M2, it displays message M32 to inform the Member that their login was successful and sets the VMF flag to let other subroutines know that a valid Member is currently logged in [B10]. In addition, the Member's records and preference settings are stored locally for use by other subroutines.

### SR11—Submit Judge Login

The purpose of this subroutine is to submit and attempt to validate a Judge's login request. If the request is validated, additional screens, controls and data are sent to the uClient allowing the Judge to vote in contests and manage their personal account.

This subroutine is triggered when the Judge Login button [S3.5] is activated. The uClient responds by first comparing the two passwords [S3.2,3] that were entered by the Viewer [B1, B2]. If they do not match, M52 is displayed to inform the Viewer that their 2 entries for passwords do not match [B3] and the process is terminated.

If the 2 password entries match, the uClient proceeds with sending the login name and password to the Server via M15 and displaying status message M44 to inform the Viewer that the login process has started [B4]. Next, the Server checks the login name and password against T3 for a match [B5, B6]. If there is an exact match on name and password, and if the Judge is in good standing, the login is validated and the Judge's records, appropriate Database components and TAD clock are sent back to the uClient via M2 [B8]. If the login is not validated, M43 is sent to the uClient [B7] where it's displayed to inform the Viewer that the login was not successful [B9].

If the uClient receives M2, it displays message M32 to inform the Judge that their login was successful and sets the VJF flag to let other subroutines know that a valid Judge is currently logged in [B10]. In addition, the Judge's records and preference settings are stored locally for use by other subroutines.

### SR12—Submit Member Registration

The purpose of this subroutine is to submit and process a Viewer's application for membership. If the application is accepted, the Viewer is automatically logged on as a Member.

This subroutine is triggered when the Submit Member Registration button [S5.1] is activated. The uClient responds by first checking to see if all personal information blanks are filled in, selections are made, and the Terms of Use & Privacy Policy agreement box is checked [B1, B2]. If the entries are not complete, M45 is displayed to inform the applicant that information is missing and the request could not be processed [B3].

If the entries are complete, the uClient submits the request to the Server via M12 and displays M44 to inform the user that the registration process has started [B4].

The Server checks the login name and email address against T2 & T3 to see if they were registered in the past, but terminated for cause (e.g. inappropriate behavior) [B5]. If there is a match, M37 is sent to the uClient [B7] where it is displayed to inform the Viewer that their request for registration was denied [B16]. If there is no match, the uClient proceeds to process the application by contacting PayPal to validate the account number and withdraw the membership fee [B8]. If the withdrawal is unsuccessful, M38 is sent to the uClient [B10] where it is displayed to inform the Viewer that the PayPal withdrawal was unsuccessful [B16]. If the PayPal withdrawal is successful, the Server proceeds to process the application as a valid registration.

Next the Server creates a new row in T2 and a T7 for the Member and populates these registers with the data gathered from the registration screen (S5) and the PayPal financial transactions [B11]. Also, T3 is checked against the login name to see if this applicant is also signed up as a Judge [B12]. If yes, the status flag is changed from “active” to “quit” [B13]. This process helps to ensure that a single person does not operate as both a Judge and Member, and also allows a person to easily change from a Judge to a Member by merely registering as a Member.

Next the Server sends M31 to the uClient to acknowledge that the registration was a success [B14]. The uClient displays M31 to congratulate the new Member on a successful registration [B15].

### SR13—Submit Judge Registration

The purpose of this subroutine is to submit and process a Viewer's application to become a Judge. If the application is accepted, the Viewer is automatically logged on as a Judge.

This subroutine is triggered when the Submit Judge Registration button [S5.2] is activated. The uClient responds by first checking to see if all personal information blanks are filled in, selections are made, and the Terms of Use & Privacy Policy agreement box is checked [B1, B2]. If the entries are not complete, M45 is displayed to inform the applicant that information is missing and the request could not be processed [B3].

If the entries are complete, the uClient submits the request to the Server via M13 and displays M44 to inform the user that the registration process has started [B4].

The Server checks the login name and email address against T2 & T3 to see if they were registered in the past, but suspended from participating (e.g. inappropriate behavior) [B5]. If there is a match, M37 is sent to the uClient [B7] where it is displayed to inform the Viewer that their request for registration was denied [B13]. If there is no match, the uClient proceeds to process the application as a valid registration.

Next the Server creates a new row in T3 for the Judge and populates it with the data gathered from the registration screen (S5). If the applicant is under 18 years of age, the censorship rating preference setting is forced to 1 (i.e. suitable for all Viewers), regardless of what the applicant has requested, to ensure that the applicant's account is not enabled to receive material which is only suitable for Viewers over 18 years of age. T2 is checked against the login name to see if this applicant is also signed up as a Member [B8, B9]. If yes, the status flag is changed from “active” to “quit” [B10].

This process helps to ensure that a single person does not operate as both a Judge and Member, and also allows a person to easily change from a Member to a Judge by merely registering as a Judge. Next the Server sends M31 to the uClient to acknowledge that the registration was a success [B11]. The uClient displays M31 to congratulate the new Judge on a successful registration [B12].

### SR14—Display Enter Contest Screen

The purpose of this subroutine is to display the contest entry screen (S11) and if the information is available, fill in the entry boxes. This subroutine is triggered when a Submittal Time Remaining link (S9.9) or Enter Contest button (S7.2 or S10.3) is activated. The uClient responds by first checking to see if the button or link is active [B1]. If no, M50 is displayed to inform the Viewer that the entry time for this contest has elapsed [B2]. If yes, screen S11 is displayed [B3].

Next the uClient checks to see if the VMF is set [B4]. If no, M47 is displayed to inform the Viewer that they must be logged on as a Member in order to enter the contest [B5]. If yes, the uClient uses the Member's login name and contest ID from the CCI register to gather the appropriate information and fill in the text boxes [S11.1-4] [B6]. The content of the text box containing the Member's name cannot be changed by the viewer; the text in the other boxes can be changed. Finally, the uClient enables the Submit Entry button [S11.6] to allow entries to be submitted.

### SR15—Display Example Screen

The purpose of this subroutine is to display a contest entry example (S8) which corresponds to the Contest Description currently displayed for the Viewer. This subroutine is triggered when a See Example button [S7.3 or S10.2] is activated.

The uClient responds by first storing the present screen number (S7 or S10) in the PSN register, making it available for use by other subroutines to return the Viewer back to the present page [B1]. Next, the associated contest ID is pulled from the CCI register and used to find and retrieve the corresponding Entry Example from D1. The entry example is inserted into S8.1 to produce the completed Entry Example screen. Finally, S8 is displayed for the Viewer and the subroutine is terminated.

### SR16—Display Previous Page

The purpose of this subroutine is to return the Viewer to the screen that was previously displayed. This subroutine is triggered when the Previous Page button [S8.2] is activated.

The uClient responds by first pulling the previous screen number from the PSN register, which could be either S7 or S10 [B1]. Finally, the uClient displays the corresponding screen for the viewer.

### SR17—Display Contest Description Screen

The purpose of this subroutine is to display a selected Contest Description (S10) for the Viewer. This subroutine is triggered when an active link under Contest Name [S9.7] is activated.

The uClient responds by first pulling the contest ID associated with the activated link and storing it in the CCI register [B1]. Next the uClient calls Subroutine SR48, which pulls the CCI contest description from D1 and displays the corresponding Contest description for the Viewer as shown on S10. The subroutine is terminated once SR48 completes the task and returns control to SR17.

### SR18—Display Fixed Period Ballot Screen

The purpose of this subroutine is to display the Voting Ballot screen (S12) for contests that use the “fixed period” method of controlling contest voting period (i.e. contest is terminated after a fixed period of time, regardless of the number of votes received).

This subroutine is triggered from S9 when any fixed period hyperlink under Vote Time Remaining [S9.13] is activated. This type of link is identified by a time value embedded in the link (e.g. 12 hrs 13 min).

The uClient responds by first determining if the hyperlink is active [B1]. If no, M49 is displayed to inform the Viewer that the corresponding voting ballot is not available for viewing and the subroutine is terminated [B2]. If yes, the uClient pulls the contest ID from the same row as the activated link [S9.13] and sends it to the CCI. The CCI is used throughout the subroutine to find Database information related to the contest [B3].

Next the uClient proceeds to construct the voting ballot [B4]. The fixed section of the voting ballot is created by combining the voting ballot template S12 with the appropriate information extracted from T5 (contest name, session votes needed) and setting the defaults for Viewer controls (e.g. Rate Product menu, Cast Vote box, Search Entry box, Submit Votes button). The appropriate D5 subdirectory is used as the source for the moving section [S12.18]. The final screen is constructed by placing a random D5 contest entry in the moving section and calling SR44 and SR46 to add VTR [S12.3] and EVR [S12.17], respectively.

Next the uClient checks to see if the Viewer is eligible to vote (i.e. a logged in Member or Judge) by looking at the VMF and VJF flags [B5]. If either flag is set, the Cast Vote button is enabled (turned green) and the final S12 screen is displayed [B6]. If neither flag is set, the Cast Vote button is disabled (turned grey) and the final S12 screen is displayed [B7].

### SR19—Display Fixed Votes Ballot Screen

The purpose of this subroutine is to display the Voting Ballot screen (S13) for contests that use the “fixed votes” method of controlling contest voting period (i.e. contest is terminated after a fixed number of votes is received, regardless of the amount of time it takes to get the votes). This subroutine is triggered from S9 when any fixed votes hyperlink under Total Votes Remaining [S9.12] is activated. This type of link is identified by the vote value embedded in the link (e.g. 1244 Votes)

The uClient responds by first determining if the hyperlink is active [B1]. If no, M49 is displayed to inform the Viewer that the corresponding voting ballot is not available for viewing and the subroutine is terminated [B2]. If yes, the uClient pulls the contest ID from the same row as the activated link [S9.12] and sends it to the CCI. The CCI is used throughout the subroutine to find Database information related to the contest [B3].

Next the uClient proceeds to construct the voting ballot [B4]. The fixed section of the voting ballot is created by combining the voting ballot template S13 with the appropriate information extracted from T5 (contest name, session votes needed) and setting the defaults for Viewer controls (e.g. Rate Product menu, Cast Vote box, Search Entry box, Submit Votes button). The appropriate D5 subdirectory is used as the source for the moving section [S13.21]. The final screen is constructed by placing a random D5 contest entry in the center of the screen and calling SR44 and SR46 to add VTR [S13.3] and EVR [S13.17], respectively.

Next the uClient checks to see if the Viewer is eligible to vote (i.e. a logged in Member or Judge) by looking at the VMF and VJF flags [B5]. If either flag is set, the Cast Vote button is enabled (turned green) and the final S13 screen is displayed [B6]. If neither flag is set, the Cast Vote button is disabled (turned grey) and the final S13 screen is displayed [B7].

### SR20—Find Contest

The purpose of this subroutine is to find and display the contest ID and associated links defined by the contest ID entered into the Find Contest text box [S9.19] on screen S9. If the specified contest is within range of the uClient Database, the View & Vote display is scrolled so that the specified contest appears somewhere on the screen [S9.20].

If the contest is not within the uClient Database, the information is retrieved from Server archives and displayed on the screen in the row between the next and previous number in sequence. Thus, the contest IDs are always shown in sequence, even if there is a numerical gap between a recent contest and an archived contest.

This subroutine is triggered when the Find Contest button [S9.19] is activated. The uClient responds by first pulling the contest ID from the Find Contest text box [S9.18] and classifying it into 1 of 3 categories; 1) Invalid number, 2) in range of the uClient Database or 3) only available from Server archives [B1]. If it is an invalid number, then M49 is displayed to inform the Viewer of the problem [B2]. If it is within range of the uClient Database, then the display is scrolled so that the selected contest appears on the screen [B3]. If it is not within range of the uClient Database, then a request for information is sent to the Server via M24 [B4].

The Server responds by searching the archives for the requested information, retrieving the information and sending it back to the uClient via M3 [B5]. The uClient receives the M3 information, appends it to the uClient Database, rebuilds the View & Vote screen and scrolls the display so that the specified contest ID and associated links appear on the screen [B6].

Next, a check is made to see if the content on the D5 voting ballots is appropriate for the age level of the Viewer by checking to see if the YVA in the VPS register is smaller than the YVA specified for the contest [B7]. If Yes, then the D5 directory is replaced with a single screen containing a message to inform the Viewer that the entry material is not appropriate for the Viewer's age settings [B8]. If No, the D5 directory is left intact for access by the Viewer.

### SR21—Submit Entry

The purpose of this subroutine is to submit the Member's contest entry to the Server for processing. This subroutine is triggered when the S11 Submit Entry button [S11.6] is activated.

The uClient responds by checking to see if the Viewer is logged on as a valid Member [B1]. If no, then M47 is displayed to inform the Viewer that they must be logged in as a Member in order to submit a contest entry [B2]. If yes, then the uClient pulls the contest entry file from the uClient computer location defined in the entry browser text box [S11.4], changes the file name to include the contest ID [S11.2] and Member login name [S11-1], and sends all of this information to the Server via M16 [B3]. The Server receives the information and responds by first checking to see if it is a valid entry [B4]. If no, M40 is sent back to the uClient [B5] where it is displayed to inform the Member that their entry could not be processed [B7]. If yes, then the contest file is added to the appropriate D2 subdirectory, T7 is updated to record the event, T6 is updated to include the Member's name as a contestant in the associated contest, and M33 is sent to the uClient [B6]. The M33 message is displayed by the uClient to inform the Member that their contest entry has been received [B7].

### SR22—Submit Votes

The purpose of this subroutine is to submit votes to the Server for processing. This subroutine is triggered when the voter activates the Submit Votes button on S12 or S13.

The uClient responds by first checking to see if the Submit Votes button [S12/13.7] is enabled [B1]. If no, M51 is displayed to inform the voter that the required number of session votes must be cast before the votes can be submitted for processing [B2]. If yes, then the uClient checks to see if a valid rating is shown in the Rate Product box [S12/13.8] (i.e. anything except a blank) [B3]. If no, M46 is displayed to inform the voter that they must rate the product before their votes can be submitted [B4]. If yes, the uClient displays M44 to inform the voter that their request is being processed, disables the Submit Votes button [S12/13.7] and Cast Votes button [S12/13.14], and sends all vote information (contest ID, voter name, vote selections, product rating, voter view time) to the Server via M17 [B5].

The Server receives the vote information and responds by checking the contest ID and voter name against T9 to see if they have already voted in the contest [B6 B7]. If yes, M37 is sent to the uClient [B8] where it is displayed to inform the voter that their votes were not processed [B16]. If no, the Server adds the vote information to T9, increments the voter's VCB in T2 (Member) or T3 (Judge), increments EVR in T6 for each selected contestant, and updates the total votes accumulated (TVA in T5) for the contest [B9].

Next the Server checks to see if it is a fixed vote contest [B10]. If no, M34 is sent to the uClient [B15] and displayed to inform the voter that their votes have been received and processed [B16]. If yes, then the contest requires additional processing. The Server calculates TVR [B11] and checks to see if the result is zero [B12]. If no, M34 is sent to the uClient [B15] and displayed to inform the voter that their votes have been received and processed [B16]. If yes, the contest must come to an immediate end and all uClients are alerted with a global transmission of M9 to stop accepting votes [B13]. All online uClients receive the M9 message and respond by closing down the contest and disabling the Cast Vote and Submit Votes buttons so that in process voters quickly realize that their votes cannot be submitted [B14].

### SR23—Rate Product

The purpose of this subroutine is to give the voter a means to select a rating to show their interest level in the product associated with the contest they are voting in. This subroutine is triggered when the arrow next to the Rate Product box [S12.19 or S13.20] is activated. The uClient responds by displaying all possible product rating selections in a drop down menu, consisting of; Blank, High, Med, and Low [B1].

The blank setting is used as the initial screen default and must be changed by the voter to one of the other three settings in order to provide a valid product rating. The desired rating can be selected with click of the mouse which causes the drop down menu to close, leaving the selected rating shown in the display [S12.8 or S13.8] [B2].

### SR24—Cast Vote

The purpose of this subroutine is to record a vote for the contest entry displayed on the displayed voting ballot [S12 or S13]. This subroutine is triggered when the Cast Vote [S12/13.14] button is activated.

The uClient responds by first checking to see if the Cast Vote button [S12/13.14] is enabled [B1]. If no, M53 is displayed to inform the Viewer that their vote request cannot be processed [B2]. If yes, the uClient checks to see if the cast vote box [S12/13.15] is empty [B3].

If no, it's assumed that the voter is trying to delete a previous vote and the uClient responds by clearing the Cast Vote box [S12/13.15], incrementing the SVR count [S12/13.4] and disabling the Submit Votes button [S12/13.7] if currently enabled [B4]. If yes, the uClient checks to see if the SVR count [S12/13.4] is zero [B5].

If yes, M48 is displayed to inform the voter that they cannot cast any more votes in this contest [B6]. Note: even though the SVR count is zero, the Cast Votes button is still enabled so that the voter can remove a previous vote if desired, but additional votes are not allowed. If no, the Cast Votes box [S12/13.15] is filled to indicate a vote for the corresponding entry and the SRV count is decremented by 1 count [B7]. Next, the uClient checks to see if the SVR count [S12/13.4] has reached zero [B8]. If no, the processing is terminated. If yes, the Submit Votes button [S12/13.7] is enabled to allow the voter to take the next step in submitting their votes.

### SR25—Search Entries

The purpose of this subroutine is to find and display the contest entry based on all or part of a Member's name entered into the Search Entries text box [S12/13.13].

This subroutine is triggered when the Search Entries button [S12/S13.12] is activated. The uClient responds by using the displayed contest ID [S12/13.1] to find the appropriate D5 subdirectory and searching it for a match with the name provided in the Search Entries text box [S12/13.13] [B1].

The same Contest ID is copied to the CCI register for use by other subroutines. If there is an exact match, the uClient displays the associated contest entry in the dynamic section of the screen [S13.21] [B3]. If there is not an exact match, the uClient displays the contest entry of the Member with the closest name matched to the text box [B2]. Next, the uClient displays the full login name in the Search Entry test box [S12/13.13] of the Member associated with displayed entry. Finally, the uClient updates the EVR box [S12/13.17] using the latest value from T6 associated with the displayed contest entry [B4].

### SR26—Display Next Entry

The purpose of this subroutine is to display, on the voting ballot, the next contest entry [S12/13.18] in sequence. The contest entries are stored in a D5 subdirectory in alphabetical order, based on the Member's name.

This subroutine is triggered when the Next Entry button [S12/13.11] is activated. The uClient responds by first using the contest ID of the displayed screen to find the appropriate D5 subdirectory [B1]. The same Contest ID is copied to the CCI register for use by other subroutines. Next, the uClient checks to see if the displayed entry is the last entry in sequence [B2]. If yes, the first D5 entry in sequence is displayed [B3]. If no, the next entry in sequence is displayed [B4]. Next, the uClient displays the login name in the Search Entry test box [S12/13.13] of the Member associated with displayed entry. Finally, the uClient updates the EVR box [S12/13.17] using the latest value from T6 associated with the displayed contest entry [B4].

### SR27—Display Previous Entry

The purpose of this subroutine is to display, on the voting ballot, the previous contest entry [S12/13.18] in sequence. The contest entries are stored in a D5 subdirectory in alphabetical order, based on the Member's name.

This subroutine is triggered when the Previous Entry button [S12/13.10] is activated. The uClient responds by first using the contest ID of the displayed screen to find the appropriate D5 subdirectory [B1]. The same Contest ID is copied to the CCI register for use by other subroutines. Next, the uClient checks to see if the displayed entry is the first entry in sequence [B2]. If yes, the last D5 entry in sequence is displayed [B3]. If no, the previous entry in sequence is displayed [B4]. Next, the uClient displays the login name in the Search Entry test box [S12/13.13] of the Member associated with displayed entry. Finally, the uClient updates the EVR box [S12/13.17] using the latest value from T6 associated with the displayed contest entry [B4].

### SR28—Display BizBubble

The purpose of this subroutine is to display additional information related to one or more key words embedded in a contest entry, contest description, or contest example. The key words are typically related to the contest or advertisements (e.g. Sponsor name, services, product name, key product attributes, etc.), appear like conventional links, and are referred to as “BizLinks” [S13.23]. The summarized information appears in a bubble located near the BizLink and is referred to as a “BizBubble” [S13.31]. A dotted line [S13.24] is used to show the connection between the BizBubble and BizLink. The BizBubble has built in BizBeads [S13.25-30] to allow the Viewer to trigger additional functions, including; request more detailed information to be sent to their email address (Send Email) [S13.25], close down the bubble (X) [S13.28], scroll through multiple pages (< or >)[S13.27 or S13.29], and perform other operations which can be customized for each contest. The example shown in S13 uses the terms Door 1 [S13.26] and Door 2 [S13.30] to open mini BizBubbles [S13.32] that ask questions about the product and offer a prize for the right answer.

This subroutine is triggered when any BizLink [S13.23] is activated. The uClient responds by using the contest ID to find the appropriate D4 subdirectory and the BizLink word to find the associated BizBubble file within the D4 subdirectory [B1]. Next the uClient defines where to place the BizBubble based on the type of screen displayed [B2].

For example, if a contest description [S7] or contest example [S8] screen is displayed, the BizBubble can be placed in the left mid quadrant of the screen where it won't obstruct the view of key screen content [B3]. If a contest description [S10] is displayed, the BizBubble can be placed in the upper right quadrant of the screen [B4]. If a voting ballot is displayed [S13] the BizBubble can be placed to the left of the entry image [S13.22] [B5]. A dotted line [S13.24] is then inserted between the bottom mid section of the BizBubble [S13.31] and associated BizLink [S13.23] [B6].

### SR29—Service BizBead

The purpose of this subroutine is to identify the activated BizBead and provide the appropriate response.

This subroutine is triggered when any one of the 6 BizBeads [S13.25-30] is activated. The uClient responds by first identifying the activated BizBead [B1].

If it is “X” [S13.28], then the BizBubble is closed [B2].

If it is “Send Email” [S13.25], then the Client sends the viewer detailed information relating to the summary information shown in the BizBubble [B3]. This is done by using the displayed Contest ID [S13.1] to retrieve the matching D4 directory and the BizLink name [S13.23] to retrieve the matching Email file from D4. The Email file is sent to the email address stored in the VPS register. Next M36 is displayed to inform the Viewer that the requested information has been sent to their email address.

If it is “<” [S13.27], then the text file shown within the BizBubble is changed to show the previous page of information [B4]. If there is no previous page (e.g. at start of file), then clicking the button does nothing.

If it is “>” [S13.29], then the text file shown within the BizBubble is advanced to the next page of information [B5]. If there is no next page (e.g. at end of the file), then clicking the button does nothing.

If it is “Door 1” [S13.26] [B6], the uClient uses the Contest ID to find and retrieve the matching table T20 and the BizLink name to identify the set of questions in T20 that correspond to the BizLink. One of the questions is selected at random and the associated question ID is saved in the DQI register. The selected question text is pulled from T20 (Door Text A) and displayed in a mini BizBubble [S13.32] below the selected BizBead [S13.26], along with a dotted line [S13.34] connecting the mini BizBubble [S13.32] and BizBead [S13.26]. The mini BizBubble includes a small “X” BizBead [S13.35] at the top to allow the mini BizBubble to be closed.

If it is “Door 2” [S13.30] [B7], the uClient uses the Contest ID to find and retrieve the matching table T20 and the BizLink name to identify the set of questions in T20 that correspond to the BizLink. One of the questions is selected at random and the associated question ID is saved in the DQI register. However, in this case a different random method is used to select the question, for no other reason than to ensure that the same question would not be selected when using Door 2 instead of Door 1. The selected question text is pulled from T20 (Door Text A) and displayed in a mini BizBubble (not shown) below the selected BizBead [S13.30], along with a dotted line (not shown) connecting the mini BizBubble and BizBead [S13.30]. The mini-BizBubble includes a small “X” BizBead [S13.35] at the top to allow the mini BizBubble to be closed.

### SR30—Display Product Screen

The purpose of this subroutine is to display screen S17 which provides information on the products available for purchase with vote credits. This product information is created and frequently updated by Administrators using offline resources. In addition, S17 provides displays showing the User's Vote Credit Balance (VCB) and the number of vote credits used for each transaction.

This subroutine is triggered when the Vote Credit Product Choices link on S14 or S16 is activated. The uClient responds by storing the displayed screen and displaying S17 (which includes product information [S17.1,2,3,4,5]) and blanking all text boxes [S17.6,11] [B1].

### SR31—Display BizBuddy Account Screen

The purpose of this subroutine is to display screen S15, which provides the BizBuddy's preference settings and account information.

This subroutine is triggered when the Display BizBuddy Account button [S14.37] is activated. The uClient responds by collecting the Member entry information from S14 [S14.1-33], as it may have been changed since the last refresh cycle [B1]. The information is stored in T2, using the Member's name to select the appropriate row.

Next, the uClient displays S15 and searches for the BizBuddy's account information by using the BizBuddy name from S14 [S14.15] to find and select the appropriate row in T1. The information from T1 is used to fill the S15 text entry boxes [S15.1-11] and balance box [S15.26], set the Show on Ballot indicators [S15.15-25], set the Photo Available indicators [S15.13], and set the Photo Location browser [S15.14] to reflect the most recent entries.

### SR32—Refresh Member Account

The purpose of this subroutine is to refresh uClient registers T2 and screen S14 using the latest account information from the Server, and at the same time send to the Server the latest preference information entered on S14 by the Member.

This subroutine is triggered when the Refresh Member Account button [S14.36] is activated. The uClient responds by first checking the status of the Photo Available indicators [S14.19] [B1]. If Yes, the image file is pulled from the location designated by the Photo Location browser [S14.20], reformatted to include the Member's name, and staged for transmission. Next the uClient collects the latest S14 entries [S14.1-33], combines this information with the photo and sends it all to the Server via M20 [B2]. If No, the uClient collects the latest S14 entries [S14.1-33] and sends this information, without the photo, to the Server via M20 [B3].

The Server responds by using the Member's name from the M20 message to select and update the appropriate Database components with the M20 data. The settings and text entries are sent to T2 and the photo is sent to D3. Next the Member's Cash Balance (MCB) is re-calculated using the updated T2 information. The Member's Vote Credit Balance (VCB) is refreshed by other subroutines running on the Server, therefore no changes are made to VCB during this process. Next the MCB and VCB are sent to the uClient via M10 [B4].

The uClient receives M10 and updates T2 with the new values for MCB and VCB. Next, the uClient updates the associated screen displays for MCB (S14.34] and VCB [S14.35] with these same values [B5].

### SR33—Display Member Account Screen

The purpose of this subroutine is to display screen S14, which provides the Member's preference settings and account information.

This subroutine is triggered when the Display Member Account button [S15.28] is activated. The uClient responds by collecting the user entry information from S15 [S15.1-25], as it may have been changed since the last refresh cycle [B1]. The information is stored in T1, using the BizBuddy's name to select the appropriate row.

Next, the uClient displays S14 and searches for the Member's account information by using the login name to find and select the appropriate row in T2. The information from T2 is used to populate the S14 text entry boxes [S14.1-18] and balance boxes [S14.34-35], set the Show on Ballot indicators [S14.21-33], set the Photo Available indicators [S14.19], and set the Photo Location browser [S14.20] to reflect the most recent entries.

### SR34—Refresh BizBuddy Account

The purpose of this subroutine is to refresh uClient table T1 and screen S15 using the latest account information from the Server, and at the same time send to the Server the latest preference information entered on S15.

This subroutine is triggered when the Refresh BizBuddy Account button [S15.27] is activated. The uClient responds by first checking the status of the Photo Available indicators [S15.13] [B1]. If Yes, the image file is pulled from the location designated by the Photo Location browser [S15.14], reformatted to include the BizBuddy's name, and staged for transmission. Next the uClient collects the latest S15 entries [S15.1-25], combines this information with the photo and sends it all to the Server via M21 [B2]. If No, the uClient collects the latest S15 entries [S15.1-25] and sends them to the Server, without the photo, via M21 [B3].

The Server responds by using the BizBuddy's name from the M21 message to select and update the appropriate Database components with the M21 data. The settings and text entries are sent to and the photo is sent to D3. Next the BizBuddy's Cash Balance (BCB) is re-calculated, using the latest account information in T7. The new value for BCB is sent to the uClient via M10 [B4]. The uClient receives M10 and updates T1 and screen S15 [S15.26] with the new value for BCB [B5].

### SR35—Refresh Judge Account

The purpose of this subroutine is to refresh uClient registers T3 and screen S16 using the latest account information from the Server and at the same time, send to the Server the latest preference information entered on S16.

This subroutine is triggered when the Refresh Judge Account button [S16.15] is activated. The uClient responds by collecting the latest S16 entries [S16.1-14] and sending them to the Server via M22 [B1].

The Server responds by using the Judge's name from the M22 message to select and update the appropriate Database components with the M22 data [B2]. The text entries are sent to T3 and the latest value for VCB is pulled from T3 and sent to the uClient via M10. The uClient receives M10 and updates T3 and screen S16 [S16.14] with the new value for VCB [B3].

### SR36—Buy Product

The purpose of this subroutine is to determine the number of vote credits remaining in the User's account, display the number of these vote credits that can be applied for purchasing a product on S17, and display the Vote Credit Balance (VCB) that will remain if the selected products are purchased.

This subroutine is triggered when a Buy button [S17.7] is activated by the Viewer. By default, the Viewer must either be a Member or Judge because S17 can only be accessed from a Member or Judge account screen [S14, S16]. The uClient first checks to see if the Viewer is a Member or Judge [B1]. If Member, the Member's name is used to search T2 and pull the associated VCB [B2]. If Judge, the Judge's name is used to search T3 and pull the associated VCB [B3]. Next the VCN is determined by pulling the VC requirement listed on S17 for the associated product under VCs Needed [S17.5] [B4]. Vote Credits Remaining (VCR) is calculated from the pulled data using the following formula: VCR=VCB−VCN.

Next the uClient checks to see if VCR is less than zero [B5]. If Yes, that means there are not enough VCs to purchase the product so the entire VC balance is inserted in the VCs Used display [S17.6] and the VCB display [S17.11] is set to zero [B6].

In this case, extra cash will be needed to purchase the product and the amount of extra cash will be defined on the associated coupon. The coupon is generated when the Create Coupon button [S17.12] is activated. If No, there are enough VCs to purchase the product and the VCN is inserted into the VCs Used display [S17.6] and VCR is inserted into the VCB display [S17.11] [B7].

### SR37—Create Coupon

The purpose of this subroutine is to create a coupon that can be printed by a Member or Judge and used for purchasing products selected on S17.

This subroutine is triggered when the Create Coupon button [S17.12] is activated. The uClient responds by displaying the S18 coupon screen and pulling the selected product information from S17, consisting of Product Name [S17.1], Manufacturer [S17.2], SKU [S17.3], Retail Price [S17.4], VCs Needed [S17.5], and VCs Used [S17.6] [B1]. The product information from S17 is inserted under the matching columns on S18 [S18.1-6] and T14.

Next the Additional Cash Needed (ACN) is calculated by subtracting the value of the voting credits used from the price of the product and inserted in S18.9 [B2].

Next the promo code is generated by picking a random 6 digit number and inserting the result in S18.8 [B3]. The promo code is used to provide a unique ID for each coupon that is recorded (along with the owner's name and email address) on a network that can accessed (online or at the checkout counter) by participating retail outlets. The coupon can be validated during online redemption with a cross check between the promo code, name, and email address or in-person redemption with a cross check between the promo code, name and personal ID of the owner. The random number is used to reduce the possibility of counterfeiting by making each code very different regardless of the date and sequence in which they are generated.

The coupon life (defined by the manufacturer) is pulled from T19, added to the current date, and inserted in S18.7 for expiration date [B4]. This technique allows each manufacturer to define a unique expiration date for each product based on the day it is actually received by the owner.

Next the uClient checks to see if the Viewer is a Member or Judge [B5].

If the Viewer is a Member, the login name is used to select the matching row in T2 and pull the Member's actual name to use for Owner's Name [S18.10], mailing address to user for Owner's Mailing Address [S18.11] and email address for Owner's Email Address [S18.12] [B6]. This completes construction of a Member's coupon. Next the uClient informs the Server of the transaction by sending the coupon inserts to the Server via M18 [B8]. The Server uses the contents of M18 to update the master coupon log T14, compute the new VCB, and update the Member's section of T2 with the new VCB [B9]. The VCB is sent back to the uClient via M3 [B10]. The uClient updates T2 with the new VCB so the latest account information will be available the next time S14 is displayed.

If the Viewer is a Judge, the login name is used to select the matching row in T3 and pull the Judge's actual name to use for Owner's Name [S18.10], mailing address to user for Owner's Mailing Address [S18.11] and email address for Owner's Email Address [S18.12] [B7].

This completes construction of a Judge's coupon. Next the uClient informs the Server of the transaction by the sending coupon inserts to the Server via M18 [B11]. The Server uses the contents of M18 to update the master coupon log T14, compute the new VCB, and update the Judge's section of T3 with the new VCB [B12]. The VCB is sent back to the uClient via M3 [B13]. The uClient updates T3 with the new VCB so the latest account information will be available the next time S16 is displayed.

### SR38—Send Admin Login Screen

The purpose of this subroutine is to validate and service requests for the Administrator login screen.

This subroutine is triggered when the Server receives an M26 request from an aClient computer. The Server responds by pulling the IP address from M26 and checking it against T11 for a match with a valid aClient computer [B1, B2]. If there is no match, the Server terminates processing. If there is a match, the Server downloads the login screen [S19] to the requesting aClient via M4 [B3]. The aClient receives M4, pulls the screen content, and displays S19 [B4].

SR39—Submit aClient Login

The purpose of this subroutine is to submit and process the Administrator's login requests. Since Administrators have access to sensitive data, extra security measures have been added to minimize risk of outside intrusion.

This subroutine is triggered when the aClient Login button [S19.4] is activated. The aClient responds by checking to see if the two password entries [S19.2, S19.3] are the same [B1]. If no, error message M52 is displayed to inform the Administrator that the passwords don't match [B2] and the process is terminated. If yes, the login name and password is used to generate M27, which is sent to the Server as a login request [B3]. M44 is displayed to inform the Administrator that their request is being processed.

The Server receives the M27 request and checks the login name against T11 for a match with a valid Administrator login name [B4]. If No, M43 is sent to aClient [B5] where it is displayed to inform the Administrator that their login entry is invalid [B13].

If yes, the Server proceeds with a multi-step process to check validity of the password. The first step is to check the status of the Security Status Flag (SSF) in T11 [B6]. The SSF is set when there have been too many previous unsuccessful attempts to login under the Administrator's name. Once set, the SSF flag can only be reset manually by the head Administrator. If the SSF is set, the login is immediately blocked and M42 is sent to the Administrator [B7] where it is displayed to inform the Administrator that there is a security problem with the login name [B13]. If the SSF flag is not set, the Server checks the password for a match against the Administrator's password stored in T11 [B8].

If the password is valid, the Server sends M32 and a start-up package to the Administrator via M5, which includes; T12 (matched to the Administrator's name) S20, S21, S22, aClient application, and the DBMS/Client [B14]. The aClient displays S21 and M32 to inform the Administrator of a successful login [B15].

If the password is invalid, the Server increments the Try Counter in T11 associated with the login name received [B9]. Next the Server checks to see if the Try Counter is equal to the Try Limit associated with the same login name [B10]. If Yes, the SSF flag is set [B11] and M43 is sent to the aClient [B12]. If No, the SSF is not changed and M43 is sent to the aClient [B12]. The aClient displays M43 to inform the Administrator that their login entries are invalid [B13].

### SR40—Display Database Access Screen

The purpose of this subroutine is to open the screen used by Administrators to access the Master Database located on the Server. Administrators can access Database components using standard Database management system (DBMS) Client/Server screens anytime while logged in as an Administrator. Administrators have read-only access to Database components categorized as A1 or A2 and read-write access to components categorized as A1 (refer to Note 1 of FIG. 2C for more details). S20 is used to show an example of a conventional DBMS screen.

This subroutine is triggered when the Database Access tab [S21.1] is activated. The aClient responds by storing the displayed screen [B1] and checking to see if S20 has been opened since login. If yes, screen S20 is displayed as it was left the last time it was viewed [B2]. If no, communication between the DBMS Client/Server components is invoked, allowing Administrator to access the Master Database [B3].

### SR41—Send Reviewer Login Screen

The purpose of this subroutine is to service requests for the Reviewer login screen.

This subroutine is triggered when the Server receives an M56 request from an rClient computer. The Server responds by sending the login screen [S23] to the requester via M3 [B1]. The rClient receives M3, pulls the screen content, and displays S23 for the Reviewer [B2].

### SR42—Refresh Records

The purpose of this subroutine is to increment the TAD clock (for use as current time for all Server and Client functions), update the Master Database components, and send out information updates to uClients and third party participants in contest operations. The refresh rate can be relatively low, since all time critical functions are triggered by events. A rate of 1 minute per refresh is used as an example, but higher or lower rates could be easily used instead.

This subroutine is triggered once a minute by the system clock running on the Server. First the TAD clock is incremented by 1 minute so it can be used to provide a time stamp that will enable all participating computers (e.g. Server, uClient, aClient) to operate on the same “system time” regardless of differences in local computer clock settings and time zones.

Next, the Server checks each open contest in T5 to see if a submittal period has just ended [B2]. If no, the software jumps to the next operation [B4]. If yes, the software prepares the entries for review with a series of steps [B3], consisting of; 1) storing the contest ID in the CCI to use for all operations, 2) creating a D5 directory for storing the entry files using the contest ID number as part of the directory name, 3) creating a ballot image for each contestant which contains the contestant's entry, photos, and profiles laid out in the manner shown in S12 and S13, 4) creating a ballot review table (T18) using the list of contestants from T6, 5) adding the review task to the Administrator Assignment table (T12), and 6) sending the last sequential entry number in T18 to T5 to use for Total Entries Received (TER).

Next, the Server checks each open contest in T5 to see if a vote period has just ended for either a fixed period contest by checking to see if current time (TAD) equals Submittal End Time (SET) or a fixed vote contest by checking to see if M9 was just sent out, indicating that the required vote count has been met [B4]. If no, the software jumps to the next operation [B6]. If yes, the software updates the database to reflect the final vote count and financial records with a series of steps consisting of; 1) storing the contest ID in the CCI to use for all operations, 2) updating each Contestant's financial account (T7) with the final vote count (i.e. EVR in T6 is copied to TCV in T7) and pay rate (i.e. PRC in T5 is copied to PRC in T6), 3) calculating cash balance and other financial information for each contestant based on TCV and PRC, 4) distributing MCB to T2 and BCB to T1, 5) adding up the EVRs from each contestant to calculate TVR, 6) adding up the voter's product rating selections for each category (i.e. Low, Med High) and sending the totals to T8.

Next, the Server performs some housekeeping chores [B6]. This consists of; 1) moving outdated information from the Master Database to Archives where it can be stored for reference if needed in the future, 2) sending out the latest copy of the Coupon Log (T14) to retailers in order to provide details on coupon ownership/content, and 3) sending the Message Log (T13) to a third party user forum where the messages sent from Viewers to Contestants can be posted on the internet and viewed by all participants.

Next, the Server prepares for sending out database updates in a global transfer of information to all uClients [B7], with the understanding that each recipient computer will determine what it should do with the data (i.e. accept components that are matched to the Viewer's preferences and reject components that do not match with the Viewer's preferences). The Server stages updates to the following database components: T5, T6, T10, T19, T20, D1, D4, D5. The TAD clock and staged database components are sent out via M8.

Each uClient receives the M8 message and extracts the data content in preparation for processing [B8]. First the local TAD clock is updated to use for all operations affected by time and date. Next the uClient calls SR47 to review the new contests and determine which contest IDs are acceptable for the local uClient. This is done by comparing the Viewer preferences stored in VPS with the Sponsor parameters defined in T10 and storing in the ACI register each contest ID that passes the match test. Once the comparison process is complete, the uClient uses the contents of ACI to check and update the uClient Database components as summarized below;

any matches with T5 rows, if yes the updates are inserted in T5 [B9].
any matches with T6 tables, if yes the updates are inserted in T6 [B10].
any matches with T19 rows, if yes the updates are inserted in T19 [B11].
any matches with T20 tables, if yes the updates are inserted in T20 [B12].
any matches with D1 files, if yes the updates are inserted in D1 [B13].
any matches with D4 directories, if yes the updates are inserted in D4 [B14].
any matches with D5 directories, if yes the updates are inserted in D5 [B15].

Next the uClient checks to see which screen is displayed so updates can be applied if needed [B18]. If it's S6 or S7, then subroutine SR7 is called to update the information related to contest introduction (e.g. submittal time remaining) [B17]. If it's S10, then the contest ID is stored in CCI and SR48 is called to refresh the screen [B18]. If it's S9, then the user entries for Find Contest [S9.18] and scroll bar position [S9.16] are stored in temp registers TR1 and TR2, respectively [B21]. Next SR8 is called to update the entire screen, just as if S9 were opened for the first time. The user entries for Find Contest and scroll bar position are then restored so the Viewer will end up with the same screen settings and new contest information.

If S12 is displayed, the contest ID from the displayed screen is stored in the CC1 and SR44 is called to update VTR [S12.3] and SR46 is called to update EVR [S12.17] [B20]. If S13 is displayed, the contest ID from the displayed screen is stored in the CC1 and SR45 is called to update VTR [S13.3] and SR46 is called to update EVR [S13.17] [B21]. All other possible screens that may be displayed will not require immediate updates from the new Database components.

### SR43—Reserved

### SR44—Refresh VTR

The purpose of this subroutine is to update the value for Vote Time Remaining (VTR) on S12 based on the latest time provided by TAD and Vote End Time (VET), a fixed time/date established by Administrators during contest set-up.

This subroutine is ran on the uClient and triggered by various subroutines used for building or refreshing S12 (e.g. SR18). The uClient uses the displayed Contest ID to find the matching row in T15 and pull VET [B1]. VTR is then calculated by subtracting current time from VET. Next, the uClient checks to see if VTR is larger than zero [B2]. If yes, the value for VTR is inserted as S12.3 to inform the Viewer how much time is left in the voting period [B4]. If no, the word “Closed” is inserted for S12.3 and the Cast Vote button [S12.14] and Submit button [S12.7] are disabled to inhibit further voting [B3].

### SR45—Refresh TVR

The purpose of this subroutine is to update the value for Total Votes Remaining (TVR) on S13 based on the latest count in T5 for Total Votes Accumulated (TVA) and the fixed number established by the Sponsor for Total Votes Needed (TVN)

This subroutine is ran on the uClient and triggered by various subroutines used for building or refreshing S13 (e.g. SR19). The uClient uses the displayed Contest ID to find the matching row in T15 and pull TVA and TVN [B1]. TVR is then calculated by subtracting TVA from TVN. Next, the uClient checks to see if TVR is larger than zero [B2]. If yes, the value for TVR is inserted as S13.3 to inform the Viewer how many more votes will be collected before the contest is closed [B4]. If no, the word “Closed” is inserted for S13.3 and the Cast Vote button [S13.14] and Submit button [S13.7] are disabled to inhibit further voting [B3].

### SR46—Refresh EVR

The purpose of this subroutine is to update the value for Entry Votes Received, on S12 or S13, based on the latest count in T6 for the contest and contest entry currently displayed.

This subroutine is triggered by various subroutines used for refreshing S12.17 or S13.17 as a result of opening the screen, elapsed time, or changing the displayed contest entry.

The uClient uses the displayed Contest ID to find matching table T6 and the displayed Contestant name to find the matching row in T6 [B1]. The EVR is pulled from T6 and inserted as S12.17 if S12 is displayed or as S13.17 if S13 is displayed.

### SR47—Filter Contest IDs

The purpose of this subroutine is to identify 20 of the most recent contest IDs that match with the profile submitted by the Viewer. This is done by comparing the contest distribution parameters (established by the Sponsor and stored in T10) against the Viewer's preferences (stored in the Viewer Preference Settings (VPS) register) to determine if there is a match. If there is a match, the contest ID is sent to the Acceptable Contest ID (ACI) register where it is used by other subroutines to accept the associated contest.

This subroutine is triggered by various subroutines used for screen refresh or for displaying screens that allow access to contest materials, such as SR8. The uClient starts by clearing the ACI register and setting TSP to select the most recent T10 table [B1]. TCP is set to select the first T10 entry and corresponding VPS entry [B2]. A comparison is done for each entry in T10 and VPS and a match is declared if any one of the following is true:
1) the T10 entry says “ALL”
2) the VPS entry matches at least one T10 entry
3) the VPS entry is within a T10 range

TCP is incremented after each comparison to set the stage for comparing the next parameter in sequence.

The process starts with TCP set to select the Country attribute [B3]. If there is a match, the TCP is incremented to select zip code or city/state [B4] (i.e. this allows either city/state or zip code to be used by the Viewer). If there is a match, the TCP is incremented to select language [B5]. If there is a match, the TCP is incremented to select gender [B6]. If there is a match, the TCP is incremented to select age [B7]. If there is a match, the TCP is incremented to select YVA [B8].

If there is a match, the contest ID is sent to the ACI register [B9]. If any of the comparisons performed under B3-B8 fail the match test, processing is looped to the next stage [B10], therefore bypassing transfer of the associated contest ID to the ACI register.

Next the ACI register is checked to see if 20 accepted contest IDs have been found [B10]. If yes, then the mission was completed as desired and the process is terminated. If no, the TSP is decremented [B11] and checked to see if zero has been reached [B12]. If yes, the process is terminated leaving less than the desired amount of contest IDs in the ACI register. If no, the process is looped back to the beginning [B2] to allow a repeat of the same process using the next T10 table in sequence.

### SR48—Refresh Contest Description

The purpose of this subroutine is to build and display the contest description screen (S10).

This subroutine is executed on the uClient and is triggered by other subroutines used for opening or refreshing S10, such as SR17. The uClient starts by displaying the S10 screen template [B1] and enabling the See Example button [S10.2]. Next, the contest ID is pulled from CCI and used to find and pull the appropriate Contest Description from D1. The Contest Description is inserted in the center of the screen [S10.1]. Next, the contest ID is used to find the corresponding value for SET in T5 and uses it with TAD to calculate STR. Next STR is checked to determine if the submittal time is still open for this contest [B2]. If yes, the Enter Contest button [S10.3] is activated and the value for STR is inserted for Submittal Time Remaining [S10.4] [B4]. If no, the Enter Contest button is disabled and the word Closed is inserted for Submittal Time Remaining [S10.4] [B3].

### SR49—Reserved

### SR50—Display Entry Assignment Screen

The purpose of this subroutine is to display the Entry Assignment screen (S21). This screen is used by Administrators to assign the job of reviewing contest entries to determine if they contain material which is not suitable for display in the voting ballot. Typically these jobs are assigned to Administrators, with all entries for any given contest allocated to a single Administrator. However, additional resources may needed in order to review large numbers of entries in a timely manner. S21 provides the tools to allow contest entries to be split into sections and assigned to multiple Reviewers (i.e. Judges, Members, or other Administrators that log in as a Reviewer).

This subroutine is triggered when the Entry Assignment tab [S21.2] is activated. The aClient responds by storing the screen that is currently displayed [B1] and then checking to see if S21 has been displayed since the last login. If yes, the aClient displays the stored S21 screen without making any changes [B2]. If no, the aClient uses the login name to create M24 and sends it to the Server to request T12 [B3]. The Server uses M3 to return the latest copy of T12 [B4].

The aClient displays S21 and clears all of the displays [S21.4-8, 23] [B5]. Next, the information in T12 is extracted and used to define the contest IDs that are assigned to the Administrator. This includes any entry review jobs that are in process or pending. The associated contest IDs are loaded on the Contest ID drop down menu [S21.4], giving the Administrator quick access to the appropriate jobs.

### SR51—Display Admin Entry Review Screen

The purpose of this subroutine is to display the Entry Review screen (S22). This screen is used by Administrators to review contest entries and identify and flag any entries that contain material which is not suitable for display in the voting ballot.

This subroutine is triggered when the Entry Review tab [S21.2] is activated. The aClient responds by storing the screen that is currently displayed [B1] and then checking to see if S22 has been displayed since the last login. If yes, the aClient displays the stored S22 screen without making any changes [B2]. If no, the aClient uses the login name to create M24 and sends it to the Server to request T12 [B3]. The Server uses M3 to return the latest copy of T12 [B4].

The aClient displays S22 and clears all of the displays [S22.7,9,11-16] and the ballot image [S22.20] [B5]. Next, the information in T12 is extracted and used to define the contest IDs that are assigned to the Administrator. This includes any entry review jobs that are in process or pending. The associated contest IDs are loaded on the Contest ID drop down menu [S22.14], giving the Administrator quick access to the appropriate jobs.

### SR52—Submit Reviewer Login

The purpose of this subroutine is to submit and validate a Reviewer's login request. If the request is validated, a review screen, controls and data are sent to the rClient allowing the Reviewer to receive entry review assignments, view and decide on accepting contest entries, and submit results of the review to Administrators for final check and validation.

This subroutine is triggered when the Reviewer Login button [S23.4] is activated. The rClient responds by first comparing the two passwords that were entered by the Reviewer [B1]. If they do not match, M52 is displayed to inform the Reviewer that their 2 entries for passwords do not match [B2] and the process is terminated.

If the 2 password entries match, the rClient proceeds with sending the login name and password to the Server via M25 and displaying status message M44 to inform the Reviewer that the login process has started [B4]. Next, the Server checks the login name against T16 to see if the requester is on the Reviewer list and against T2, T3, or T11 (depending on if it's a Member, Judge, or Administrator, respectively) to validate the name and password [B5]. If the match test is successful, the login is validated and an M3 message is sent back to the rClient to provide the TAD clock, rClient software application, and T16 rows matched to the login name [B8]. If the login is not validated, M43 is sent to the rClient [B7] where it's displayed to inform the Reviewer that the login was not successful [B9].

If the rClient receives M3, it stores the contents and displays message M32 to inform the Reviewer that the login was successful [B10]. The VRF flag is activated to let other subroutines know that a valid Reviewer is currently logged in. Next, the rClient displays the Reviewer Entry Review screen template, which includes everything outside the red dotted line [S24.20]. All text displays and buttons [S24.7, 9, 11-16] are cleared. Table T16 is searched using the Reviewer's login name to find any pending or in-process entry review jobs that have been assigned to the Reviewer. A list of the associated contest IDs is created and used to populate the Contest ID drop down menu [S24.14].

### SR53—Display Assignments

The purpose of this subroutine is to populate S21 with Total Entries from T5 and Assignment Schedule information from T15.

This subroutine is triggered when the Display Assignments button [S21.9] is activated. The aClient responds by requesting T5 & T15 from the Server [B1] based on the Contest ID. The Server responds by sending the requested tables [B2]. The aClient receives and opens T5 pulling the number of entries received for the contest and displaying this value in the Total Entries box [S21.5] [B3]. Next, the same Contest ID is used to open the associated T15 table [B4]. The contents of T15 are displayed in corresponding cells within the Assignment Schedule [S21.23].

### SR54—Refresh Reviewer List

The purpose of this subroutine is to update the S21 Reviewer List drop down menu [S21.8] with one or more available Reviewers listed in T16. To ensure that multiple Administrators do not give conflicting assignments to the same Reviewer, the Server distributes different Reviewer names to each requester and flags each distributed name as “assigned”. When the Release Assignment button [S21.12] is activated, T16 is updated to flag all unused names as “available”.

This subroutine is triggered when the Refresh Reviewer List button [S21.10] is activated. The aClient responds by sending an M28 request to the Server for names of available Reviewers. The number of names shown in the Reviewers Needed box [S21.6] is sent along with the request [B1].

The Server receives the M28 request and identifies the number of names requested [B2]. Next the Server checks T16 to see how many reviewers are currently available and checks internal workflow projections to determine how many reviewers will be needed by other Administrators in the near term (e.g. next 60 minutes). A decision is made from these inputs as to how many names will be sent; the number requested, or a smaller amount due to resource limitations. Based on this decision, the Server generates an M29 response which includes the selected reviewer names from T16 and the number of names sent.

The aClient receives the M29 response, displays the number of names sent in the Reviewers Received box [S21.7], and uses the names received to populate the Reviewer List drop down menu [S21.8].

### SR55—Add Reviewer

The purpose of this subroutine is to add Reviewer names and other updates to the Reviewer Assignment Schedule shown on S21.

This subroutine is triggered when the Add Reviewer button [S21.11] is activated. The aClient responds by moving the Reviewer name displayed in the Reviewer List drop down menu [S21.8] to the top row of the first empty column [S21.22/17] of the Assignment Schedule [S21.23] [B1]. The word Pending is inserted into rows 3 and 4 [S21.17/19,17/20] of the same column.

At this point the processing is complete for this subroutine. Now it is left up to the Administrator to fill in row 2 [S21.17/21] with the entry range to be assigned to the Reviewer and add more reviewers or activate the Release Assignments button, which causes the Assignment Table to be cleared in preparation for building the next assignment schedule.

### SR56—Release Assignments

The purpose of this subroutine is to release the Reviewer assignments made on S21 and update the appropriate Database components.

This subroutine is triggered when the Release Assignments button [S21.12] is activated. The aClient responds by using the displayed Contest ID [S21.4] to find and open T15, update T15 to reflect the new information shown on the Assignment Schedule [S21.23], save and close T15, clear the name from the displayed Reviewer List [S21.8], clear the Contest ID [S21.4] and display the next ID in sequence (leave blank if none) and clear the information shown in the Assignment Schedule [S21.23] [B1]. Next, message M35 is prepared and sent to the Server to signal release of assignments and provide the names of used and unused Reviewers.

The Server pulls the unused names from M35 and updates T16, changing the status of all unused Reviewers from “assigned” to “available” [B2]. Next, the Server pulls the assigned names from M35 and sends out text alerts to the Reviewers to remind them that they have new jobs pending [B3]. Automatic texting by this subroutine is limited to Reviewers that have just received an assignment. Additional reminders can be sent out by the DBMS when Reviewers fail to retrieve their assigned entries within a reasonable time.

### SR57—Apply Decision

The purpose of this subroutine is to record the decision made by the Administrator or Reviewer for contest entries shown on S22 or S24, respectively.

This subroutine is triggered when the Apply Decision button [S22.8 or S24.8] is activated. The arClient responds by using the displayed Contest ID [S22.14, S24.14] to select the matching T18 table and the Displayed Entry Number [S22.16 or S24.16] to select the row in T18 that matches the displayed entry [B1]. Next the Reviewer's decision is recorded by checking the Decision Status Rating Indicators [S22.11,12,13 or S24.11,12,13] and entering the result into the selected row and Decision Status column of T18 as either Pending Review, Accept Entry, or Reject Entry. The color of the Apply Decision button is changed for 1 sec to acknowledge the operator's action.

### SR58—Retrieve Entries

The purpose of this subroutine is to use the displayed Contest ID to retrieve and stage contest entry material in preparation for content review either by an Administrator [S22] or Reviewer [S24].

This subroutine is triggered when the Retrieve Entries button [S22.17 or S24.17] is activated. The software responds by requesting from the Server the following Database components based on the selected Contest ID [S22.14 or S24.14]: T15, T18, T10 and D5 [B1]. The Server responds by pulling a copy of the components from the Master Database and sending them to the requester via M3 [B2].

The arClient receives the M3 data and uses the login name to select the corresponding row in T15. The current TAD time is inserted into T15 as the Retrieve Time and the Entry Range from T15 is copied to the Entry Range screen display [S22.15 or S24.15].

Next the arClient enables all rows in T18 that are in the Entry Range (using the T18 column labeled Display Status) and disables all others. The number of the first enabled entry is displayed in the Displayed Entry Number box [S22.16 or S24.16] and the corresponding ballot image is retrieved from D5 and inserted in the dynamic image area of screen S22 or S24, designated by the red dotted line [S22.20 or S24.19]. The Contest ID is used to retrieve the censorship guidelines received from the Sponsor in T10 and is displayed in the Sponsor Requirements box [S22.9 or S24.9]. Finally, the arClient returns the updated T15 to the Server via M6 to use for updating the Master Database.

The Reviewer will use the Sponsor Requirement as a gauge to determine if each entry is suitable for posting on a voting ballot. For example, if the Sponsor Requirement is that entries must be suitable for all Viewers and an entry is found that contains material that is not appropriate for people under 18 years old, then the Reviewer would reject the entry.

### SR59—Submit First Review

The purpose of this subroutine is to submit the first review of the contest entries. The first review is performed by Reviewers and the final review is performed by the responsible Administrator.

This subroutine is triggered when the Submit First Review button [S24.18] is activated. The rClient responds by using the displayed Contest ID [S24.14] to find the appropriate T18 and then checks it to see if any entries assigned to the Reviewer are still flagged as “Pending” [B1]. If yes, M55 is displayed to inform the Reviewer that not all assigned entries have been reviewed [B2]. If no, then the rClient proceeds with the submittal process.

Next the displayed Contest ID is used to find T15 and the Reviewer's name is used to find the appropriate row in T15. The current TAD time is inserted in T15 for return time [B3]. The S24 displays [S24.7,9,11-16] and the Ballot image [S24.19] are cleared. If additional Contest IDs are available on the Contest ID drop down menu [S24.14], then the next number is sequence is displayed [B4]. If no more Contest IDs are available, then the Contest ID is left blank and T16 is updated to show that the Reviewer is available for new jobs [B5]. Next the rClient saves the updates, closes all files and sends the updated components to the Server via M6. The Server receives the M6 package and uses the contents to update the Master Database [B7].

### SR60—Submit Final Review

The purpose of this subroutine is to submit the final review of the contest entries to the Server. The final review is always performed by Administrators and applies to all contest entries (i.e. all Reviewer sections combined into a single T18 Table). The primary purpose for this review is to have an Administrator take a second look at the rejected entries to determine if any reject decisions should be reversed.

This subroutine is triggered when the Submit Final Review button [S22.18] is activated. The aClient responds by using the displayed Contest ID [S22.14] to find the appropriate T18 and then checks it to see if any entries are still flagged as “Pending” [B1]. If yes, M55 is displayed to inform the Administrator that not all entries have been reviewed [B2]. If no, then the aClient proceeds with the submittal process. Next the S22 displays [S22.7,9,11-16] and the Ballot image [S22.19] are cleared [B3]. If additional Contest IDs are available on the Contest ID drop down menu [S22.14], then the next number is sequence is displayed [B4]. If no more Contest IDs are available, then the Contest ID is left blank

The aClient updates T12 to show that the job was completed, saves and closes all files, and sends the updated components (T12, T18, CCI) to the Server via M6 [B5]. The Server receives the M6 package and uses the contents to update T12 and T18 in the Master Database and retains the associated Contest ID via CCI [B6].

Next the Server makes preparations to start the voting process by pulling T18, T5 and D5 using the contest ID in CCI [B7]. The Contestant names listed in T18 with rejected entries are selected and used to identify and delete the associated contest entries in D5. The remaining entries are sorted in alphabetical order. The IMC counters in T2 associated with each selected Contestant name are incremented by 1 count. The IMC counters keep a running total on the number of times each contestant submits inappropriate material. Administrators can use this information to suspend Membership or limit distribution of new contest opportunities to Members that submit excessive amounts of inappropriate material. The current time from the TAD clock is inserted as the voting start time (VST).

The vote end time for “fixed period” contests is calculated by adding the Requested Vote Period (RVP) (supplied by the Sponsor) to VST and this is inserted into T5 as VET [B8]. The total vote count is used to terminate “fixed vote” contests and this is handled under SR22.

The Server uses M3 to send the updated T12 back to the aClient [B9]. The aClient uses the information from the updated T12 to add new review tasks assigned to the Administrator to the bottom of the list on the Contest ID drop down menu [B10].

### SR61—Find Entry

The purpose of this subroutine is to find and display the contest entry in D5 associated with the name, partial name, entry number, or code number located in the Find Entry text box on S22 or S24. The contest entries are stored in D5 by using the unique section of the file name (i.e. contestants' login name) sorted in alphabetical order. Table T18 provides a cross reference between the contestant name and the associated entry number (i.e. sequence number).

This subroutine is triggered when the Find Entry button [S22.6 or S24.6] is activated. The arClient responds by using the displayed Contest ID [S22.14 or S24.14] to find and open the appropriate D5 and T18 components [B1]. The first character in the Find Entry box [S22.7 or S24.7] is examined to determine the type of search to be performed. All searches are performed in T18 in rows tagged as “enabled”.

If it is a letter, the search is based on finding the name of a contestant [B3]. In this case, the entry number associated with the closest contestant name found in T18 is inserted in the Displayed Entry Number text box [S22.16 or S24.16]. If it is a number, the search is based on finding the number of the entry [B5].

In this case, the closest entry number found in T18 is inserted in the Displayed Entry Number text box. If it is >R, the search is based on finding the next entry with a reject tag [B7]. In this case, the entry number associated with the next rejected entry is inserted in the Displayed Entry Number text box.

Once the T18 search is complete, the arClient uses the number in the Displayed Entry Number text box to search T18 for the associated Contestant name and insert this name in the Find Entry box [S22.7 or S24.7]. The arClient also uses this name to search D5 for the associated contest entry image [B8]. The image is inserted into the dynamic section of the screen defined by the red dotted lines [S22.20 or S24.20]. Next the associated Decision Status settings stored in T18 are used to illuminate the appropriate Decision Status Indicators on the screen [S22.11,12,13 or S24.11,12,13].

### SR62—Go Back

The purpose of this subroutine is to display the contest entry image that is previous in sequence to the one currently displayed on S22 or S24.

This subroutine is triggered when the Back button [S22.4 or S24.4] is activated. The arClient responds by using the displayed Contest ID [S22.14 or S24.14] to find the appropriate D5 and T18 components and the Display Entry Number [S22.16 or S24.16] to select the matching row in T18 [B1]. Next the arClient checks to see if the selected row is the first enabled row in T18 [B2]. If yes, the last enabled row of T18 is selected [B3]. If no, the previous enabled row of T18 is selected [B4].

Next, the newly selected row number is used to find additional information in T18 for display [B5]. The entry number is inserted in Displayed Entry Number [S22.16 or S24.16] and the Contestant name is inserted in the Find Entry box [S22.7 or S24.7]. The Contestant name is used to search D5 for the associated contest entry image. The contest entry image is inserted into the dynamic section of the screen defined by the red dotted lines [S22.20 or S24.20]. Next the associated Decision Status settings stored in T18 are used to illuminate the appropriate Decision Status Indicators on the screen [S22.11,12,13 or S24.11,12,13].

### SR63—Go Forward

The purpose of this subroutine is to display the contest entry image that is next in sequence to the one currently displayed on S22 or S24.

This subroutine is triggered when the Forward button [S22.4 or S24.4] is activated. The arClient responds by using the displayed Contest ID [S22.14 or S24.14] to find and the appropriate D5 and T18 components and the Display Entry Number [S22.16 or S24.16] to select the matching row in T18 [B1]. Next the arClient checks to see if the selected row is the last enabled row in T18 [B2]. If yes, the first enabled row of T18 is selected [B3]. If no, the next enabled row of T18 is selected [B4].

Next, the newly selected row number is used to find additional information in T18 for display [B5]. The entry number is inserted in Displayed Entry Number [S22.16 or S24.16] and the Contestant name is inserted in the Find Entry box [S22.7 or S24.7]. The Contestant name is used to search D5 for the associated contest entry image. The contest entry image is inserted into the dynamic section of the screen defined by the red dotted lines [S22.20 or S24.20]. Next the associated Decision Status settings stored in T18 are used to illuminate the appropriate Decision Status Indicators on the screen [S22.11,12,13 or S24.11,12,13].

### S64 Respond to Answer

The purpose of this subroutine is to identify the BizQuiz answer selected by the viewer on S13 and provide the appropriate response.

This subroutine is triggered when the viewer clicks one of the answer buttons [S13.33] on a mini-BizBubble [S13.32]. The uClient responds by first identifying the answer selected by the viewer [B1]. Next the uClient finds the correct answer by using the displayed Contest ID to find the correct T20 table and the question ID from DQI to select the appropriate row within the table. The viewer selection is compared with the correct answer to determine if there is a match (i.e. the question was answered correctly) [B2]. If no, then Door Text B is pulled from T20 and displayed in the mini BizBubble to inform the viewer that their answer was wrong [B3]. If yes, the uClient checks to see if the viewer is logged on as a Judge or Member [B4].

If the viewer is logged on as a Judge, then Door text D is displayed to congratulate the Judge on selecting the correct answer and provide more information about the prize [B5]. The login name is used to find the Judge's account in T3 and the prize is automatically added to the account.

If the viewer is logged on as a Member, then Door text D is displayed to congratulate the Member on selecting the correct answer and provide more information about the prize [B6]. The login name is used to find the Member's account in T2 and the prize is automatically added to the account.

If the viewer is not logged on as a Judge or Member, then the viewer is considered a Guest. In this case Door Text C is displayed to congratulate the Guest on selecting the correct answer and provide more information about the prize they would receive if they were registered as a Judge or Member [B7].

### Operation

The invention is a system, method, web site software and a business model structured specifically for holding online contests which challenge contestants to create advertisements for Sponsor companies. The advertisements are displayed for online voting with the intent of creating online audiences and generating advertising revenue. A portion of the advertising revenue (or other types of prizes) are returned to the contestants as prizes based on the number of votes received.

One example embodiment allows for 3 categories of people to participate in the contests: Members, Judges, and Guests. Members can enter contests and vote in contests and can maintain a financial account linked to the web site where funds can be automatically deposited for contest winnings and deducted for monthly fees (if monthly fees are deemed to be required). Judges do not enter contests, but can vote in contests. Guests can view the contests, entries, and voting results but cannot vote. If no monthly fees are accessed, then Members and Judges could be combined into 1 category (e.g. Users) where the only requirement would be that they must be identified and registered so that web site Administrators can ensure that the voting results are accurate and rewards are fairly distributed.

Members and Judges can participate in only one voting session per contest. Each session may require voters to rate the entry (e.g. 1-5 stars, with 5 stars representing the most favorable vote) or cast multiple votes on different entries (to create diversity in votes), but voters are not allowed to vote more than once for any given entry. Judges and Members must register and provide personal information and identification so that web site Administrators can ensure that no one votes under multiple names. Guests can view contest descriptions and voting ballots, but are not allowed to vote since Guest voting cannot be accurately accounted for (e.g. a single Guest could vote on the same entry from multiple computers).

The descriptions provided herein use examples to assist with illustrating the points, but this practice is not meant to impose limitations on: 1) the types of Sponsors, products or services that can be applied, 2), the types of Gamification techniques that can be applied to enhance participation in the contests and advertising effectiveness, 3) the amount of time allotted for entry submittal or voting, 4) types of screens, controls, displays, menus and related items used for hosting and operating the contests, 5) the number and type of Servers and other technical support devices used for hosting and operating the contests, 6) the type of devices that can be used by Guests, Judges or Members to participate in the contests (e.g. smart phones, notebook computers, iPads)

Also, the examples are not meant to impose limitations on the types of prizes that can be awarded and the ratios in which the prizes are awarded to contestants. For example, all contestants can receive cash awards in proportion to the amount of votes each receives. Although this is a specific type of reward and distribution, it does not mean that other reward types and distribution could not be used, such as providing; 1) high value prizes to one or just a few contestants with top vote counts and no prizes for other contestants, 2) high value prizes to one or just a few contestants with top vote counts and lower value prizes to other contestants, 3) prizes that money can't always buy, such as a backstage pass to a rock concert, date with a celebrity, or a role in a movie or television show.

### Production Line Processing

The architecture allows many contests to be held at the same time, in production line fashion, from one or more Server computers and a single web site. Each contest can run on its own timetable, with each stage of each contest under control of one or more Administrators. The stages consist of: contest preparation, contest introduction, entry submittal, entry review, voting, tabulation of voting results, and distribution of proceeds.

### Censorship Review

Since each Sponsor may have different ideas about what constitutes inappropriate entry material, the system can provide a means for entries to be reviewed by Administrators, using Sponsor guidelines for acceptance, prior to posting on the voting ballots. The Sponsor can provide their own custom censorship rating guidelines for each contest (e.g. suitable only for Viewers over 18 years old, but no profanity) and entries can be rejected from the ballot during the review period if the specified guidelines are not met.

In addition to allowing Administrators to conduct their own reviews, the system provides a means to allow review tasks to be assigned to one or more online Reviewers (e.g. Members or Judges working under special contract) so that concurrent work can be done on different sections of the same contest when large volumes of entries are involved or when contest entry type requires extra review time (e.g. video entries). Reviewers are directed to conduct their reviews with a conservative outlook (i.e. reject any entry that is questionable), since their results will be sent to an Administrators for final review before submittal to a voting ballot. The Administrator can conduct a quick review of just rejected entries to make a sure that no entry was rejected without good cause and to allow a second and more qualified decision with respect to borderline entries that may or may not be considered appropriate.

The following describes how censorship parameters are used during contest operations;
1. Guidelines from the Sponsor are used to dictate what will be acceptable as advertising material for each contest, which is stored in the Master Database (T10) as Entry Acceptance Guidelines (EAG). Any material that does meet these guidelines is rejected during the entry review process.
2. An age threshold called the Youngest Viewer Age (YVA) is applied by Administrators to each contest after reviewing the Sponsor guidelines and is stored in the Master Database (T10). This number defines the age a person needs to be in order to view the contest entries. For example; if the Sponsor will allow some types of R rated material, the YVA for that contest would be set to 18. This number can be varied for different countries, since age restrictions may vary depending on the country (e.g. the same material considered suitable for ages 18 and over in the USA may be considered suitable for ages 16 and over in Sweden).
3. The preference settings menu on the User account screens (S14, S16) includes a setting for YVA. This can be set by the User to any number that is lower than or equal to the User's own age and is used to dictate which voting ballots are accepted by their computer. For example, a 22 year old woman with a small child can set YVA to 4 and her computer will accept voting ballots that are suitable for viewers 4 years old and less (i.e. G rated content suitable for all viewers). When the child is not around, she can set the YVA to 22 allowing her computer to accept voting ballots suitable for ages 22 and over (i.e. all voting ballots).
4. The preference settings for Guests are collected on the viewer introduction screen since they have not registered and do not have an established account. Since a Guest could be any age and there may be no way to know if they enter a fake age, the YVA setting for all Guests is forced to 1.

### Contestant Tools

The system provides ideas, tools, and incentives to inspire and encourage contestants to create unique and effective advertisements. Each contest includes; contest instructions (what is expected), entry example (a great way to convey the idea), easy access to past contest material (descriptions, examples, entries) and BizBubbles to show boilerplate product information. The contestants can easily incorporate BizBubbles into their contest entries by using designated words (e.g. Sponsor name, product name) in their caption or title.

When the contestant entries are reformatted into voting ballots, the designated words are turned into hyperlinks which are linked to boilerplate information on the Server. Then a Viewer clicks a BizBubble hyperlink on the voting ballot, a bubble filled with summary information about the product appears next to the caption. This feature allows the Viewer to receive accurate and consistent information about the product and allows the contestants to focus on making the advertisement funny, entertaining and effective without having to worry about adding boilerplate information about the product or Sponsor.

### Gamification

The perimeter of the BizBubble is lined with BizBeads which act as buttons for launching related functions (e.g. closing the BizBubble, expanding the bubble size and content, next page, last page, auto email the Viewer more details about the product, etc.). In addition, the BizBeads can be used to increase viewer interest and advertising effectiveness by creating games between the Viewer and advertisement. A large number of possibilities exist; the following provides some examples;

Example 1—a BizBubble could have multiple BizBeads labeled with door numbers (e.g. Door 1, Door 2). When any Door is selected by the Viewer, a mini BizBubble appears with a random question about the product and a prize if the answer is correct (this example is illustrated in the description above). In this first example, all questions are at the same level and all prizes are of similar value.

Example 2—the level of the question and value of the prize increases in accordance with the number on the Door (e.g. selecting Door 1 creates an easy question with a low cost prize and selecting Door 4 creates a difficult question with an expensive prize).

Example 3—time constraints and special effects can be combined with example 2, providing another layer of challenge and entertainment. A quick correct response receives a better prize than a slow correct response. If it takes too long, dollar signs appear and then fade away and the mini BizBubble disappears.

Example 4—the prize value is increased in accordance with the number of contests that the Viewer has participated in as a voter or contestant

Example 5—a pop quiz related to the advertised product is displayed for all viewers at random times through out the day. The first 20 viewers to respond with a correct answer receive a prize. This provides a good incentive for viewers to stay engaged and pay close attention to ad content.

### BizBuddy

Some implementations provide a mechanism for Members to bring a BizBuddy onto their account to act as a muse to inspire and help create the contest entries and share in the rewards. The primary intent of the BizBuddy concept is to extend contest participation and rewards to people in third world countries that do not have a means of generating income or operating a computer or mobile communications device. However, a BizBuddy can be anyone that the Member chooses. For example: someone that cannot participate directly with contests because they are disabled, do not have a computer or mobile communication device, skills to operate a computer, or are unable to open a bank account (e.g. a young child, a homeless person, a disabled person, a senior citizen, an incarcerated person or the like). In a second example, the BizBuddy could be a professional person (e.g. designer, musician, film editor) that collaborates with the Member to create the original entry or improve on the original entry.

The Member can allocate a percentage of their contest proceeds to go into a separate account set up for the BizBuddy. The BizBuddy can provide their photo, profile, income percentage and story to show on the voting ballot, along with the Member's profile/photo/story. The story can convey to voters how the BizBuddy is helping the Member with ideas and inspiration and how the Member is helping the BizBuddy by sharing the rewards.

### View & Vote Screen

The system can provide a simple, user friendly, single screen to use as a central point for monitoring contest status and participating in contest events. This includes a scrolling and searchable list of:
contest names and contest IDs for recent past, current, and future contests
links to recent past and current contest descriptions and examples
submittal time remaining for open contests and status indicators for pending or closed contests
links to submittal screen for open contests
vote time remaining for open “fixed period” contests and status indicators for pending or closed contests
votes remaining for open “fixed vote” contests and status indicators for pending or closed contests
links to associated voting ballots for open contests

### Distribution Filters

Some implementations provide a means to distribute contest descriptions or voting ballots in accordance with Sponsor defined guidelines, which includes but is not limited to;
Country (e.g. only France)
Zip, City, or State (just CA and FL)
Language (e.g. English)
Gender (e.g. male)
Age (e.g. 18-25)
Special needs (only autistic kids)
Youngest Viewer Age (7)

A profile for all Guests, Members and Judges, which includes these same attributes, is determined during the initial stages of login and retained in local memory by uClient computers. Contests descriptions and voting ballots are sent out to all Clients globally and the uClient compares the Sponsor preferences with the local profile to filter out unwanted contest descriptions and/or voting ballots. If there is a match of all attributes, the contest ID is accepted, if there is no match the contest is rejected. There are a number of benefits provided by the distribution filters for both Sponsors and Viewers, including:

Sponsors can direct advertising to specific people, languages, or areas for a number of purposes, including; test marketing, measuring advertising effectiveness (e.g. advertising effectiveness can be more easily measured by limiting specific ads to a small area), or maximizing advertising effectiveness (e.g. small local business can limit contest viewers to a local area so they won't need to pay for non local votes).

Sponsors have an option to allow R rated advertising by limiting distribution to appropriate Viewers (e.g. only Users that are over 18 years of age). In addition, they can customize the guidelines used for accepting entry material. For example, they could specify that entries must be equivalent to a PG-13 rating in all respects, except nudity is acceptable if it's done in a tasteful way. In a second example, Sponsors could specify that entries may contain R rated material, except profanity is not acceptable. Administrators would probably assign a minimum age requirement of 18 years old to each of these examples, but in each case the Sponsors would be controlling the type of material that 18+ year old viewers would see and associate with their products.

Viewers have the ability to accept only contest material that they want to see regardless of other factors. For example, a person that only speaks Spanish will probably not want to see or get involved with contests presented only in English even if they live in the USA. For a second example, a mother with a small child can chose to automatically reject R rated ads from being displayed even though she is over 18 years old.

Sponsors can limit contest entry to small, specific groupings of people, without limiting distribution of voting ballots. For example: a contest could be structured especially for special needs children ages 4-10, with the opportunity for contest entry distributed only to these kids or their parents. This would allow the special needs kids to compete against each other without interference from kids in the same age group that do not have special needs. The voting ballot distribution can be maximized (e.g. all ages, all countries, many languages, both genders), in order to maximize rewards for the contestants.

### Contest Introduction

Some implementations provide a means to introduce each contest “Hollywood style” by providing a stage setting with a closed curtain and a countdown counter showing time remaining until the next contest. When the counter reaches zero, the curtain opens to unveil the contest description, which typically includes; the Sponsor company name and logo, a description of the contest rules and expectations, unique stage settings, and links to example entries. The intention of the contest introduction is to give each contest its own “15 minutes of frame” and provide excitement and entertainment centered around the new contest. The stage settings can be changed to correspond with a number of variables, including; the contest type (e.g. a contest for a music player could be surrounded by guitars), the time of year (e.g. snow falling on the stage during winter), and upcoming holidays (spooky setting and background music for Halloween). For added entertainment, the stage setting can include humorous content or the opening and closing of the curtain can be shown to be unreliable (e.g. only one side opens, a sound is heard, shadows appear under the closed section and then the other side opens slowly). Also, the stage provides a way to associate the web site with a related television show by making the stage on the web site look the same as the stage on the television show.

In addition, Viewers can select a screen style using the preference menus on the introduction screen (Guests) or account screens (Members and Judges). The screen style can be applied to all screens but is intended for use primarily with the curtain and stage. One example is western style, where the closed curtain has an old fashion look and the open curtain shows a stage with wild-west decor. Many other themes are possible, including; vampire, gangster, European 1920s, doll house (for little girls), rave/rock (for teenagers).

All of these effects are implemented simply by inserting screens with different pictures and matching sounds at appropriate times.

### Vote Credits

Some implementations provide a means to collect and distribute vote credits in order to provide added incentives for people (especially Judges) to vote in contests. Each time votes are submitted, the voter receives voting credits which are added to their account and displayed upon demand. The voting credits can be accumulated and used to purchase one or more of the products used in the contests. A link on the voter's account screen is used to display a screen showing the products available for purchase with vote credits and the number of voting credits required to purchase each product. When the selection is made, a coupon can be generated for the selected product and the vote credits used are deducted from the vote credit balance. If there are not enough vote credits in the account, the coupon shows the amount of cash required to use with the coupon in order to purchase the product. The owner's name, address, and promotion codes are printed on all coupons and are made available to retailers to use as a cross reference for validating the coupons during redemption. Feedback from coupon issuance and redemptions can be used to track sales trends and measure advertising effectiveness.

### Guest Participation

Some implementations provide a means for anyone to log into the web site and view all web site functions, including contest descriptions, voting ballots and voting results, even though they are not allowed to enter or vote in contests. Guests are asked to provide preference settings during login (e.g. location, language, gender, age, screen preference) so they are only shown applicable contest material, as described in detail under Distribution Filters. The Youngest Viewer Age setting for all Guests is forced to 1 (Suitable for all Viewers) since a Guest Viewer's age cannot be verified.

The Guest feature is provided for a number of reasons, including; increase audience size to maximize advertising rates, promote the web site, and provide a chance for interested Viewers to see how the system works before registering as Member or Judge.

### Video Files

Some implementations provide for video files to be submitted as the contest entry. In this case the video screen is placed in the area on the voting ballot where the still image is normally placed and an area is provided below the video screen where a caption can be inserted to supplement the information on the video file. The caption can be any text information provided by the contestant, such as; a funny observation related to the screen content, a message to the Viewer, or additional comments on the product with embedded BizLinks to allow BizBubbles to be triggered by the Viewer. In addition, the text could be subtitles representing the audio sounds produced in the video clip (e.g. voice form the actors, sounds, funny comments from an outside moderator, etc.), which would allow contest entries to be enjoyed in multiple languages without the need to modify the original video file and without obstructing the original content displayed on the video screen. The captions can be linked in time with the video, so that appropriate text is displayed at the right time while the video is playing. The video is triggered when clicking the play button located in the center of the screen. This causes the uClient to stream the file in from the source of the video (e.g. dedicated secondary Servers) instead of from files downloaded from the primary Server to the uClients as is done with still images. Since video files are typically fairly large and require high bandwidth, this method allows for expansion, as needed, to accommodate growth in viewers without interfering with the bandwidth limitations of the primary Server.

### Advertising Effectiveness

Some implementations provide a means for the uClient software to monitor view times. When the Viewer opens a voting ballot, a timer is automatically started to record the amount of time the Viewer spends on viewing the entries. When the ballot is closed, the view time is sent to the Server along with the Viewer type (e.g. voter or non voter). This information can be used in offline analysis to help in demonstrating advertising effectiveness and justifying advertising rates.

### Product Rating

Some implementations provide a means for Voters to send feedback to Sponsors on their interest level in the products or services advertised. The interest level information is summarized and provided to Sponsors for use in offline analysis for a variety of purposes, including; market testing, market targeting, and determining price point.

A drop down menu with selections of Low, Med or High interest level is shown in the description of the voting ballot and one of these selections must be made before the votes can be submitted. Once votes are submitted, “Vote Credits” are automatically sent to the voter's account, providing voters with an incentive for placing the votes and making the product rating selection.

However, various other methods can be used to convey the voter's interest level, such as: a message space for viewer comments, a questionnaire with multiple choice questions, and a round face with controls to allow changing the mouth from smile to a frown. In addition, additional vote credits can be provided to those voters that take the extra time to give more a detailed response on interest level (e.g. filling out a questionnaire).

### Voting Period

Some implementations allow for the Sponsor to define the voting period either by time (Fixed Period) or by number of votes (Fixed Vote). The Fixed Vote method can be used by Sponsors with a fixed advertising budget and the Fixed Period method can be used by Sponsors that are focused on getting the maximum amount of advertising exposure in a minimum amount of time.

### Voting Ballot

Some implementations provide a highly effective means for Viewers to view entries and cast their votes by providing a single screen with all pertinent information and controls. The screen includes a static section to show contest information and a dynamic section to show contestant information. The dynamic section can be changed by clicking the Next Entry, Previous Entry, or Search Entry buttons. The contents of each section are listed below;

### Static Section

Contest ID
Contest name
Vote Time Remaining or Total Votes Remaining
Session Votes Required
Entry Votes Received
Message to Contestant
Controls (e.g. Next Entry, Cast Vote, Submit Votes, Rate Product)

### Dynamic Section

Contest entry
Contestant's photo, story and profile
BizBuddy' photo, story and profile
BizBubbles and mini BizBubbles
BizBeads

### Interaction Between Contestants and Voters

Some implementations provide a means for Contestants to write a message to viewers, which appears on the voting ballot along with the profiles and photos. For example, this could be a short story telling about the BizBuddy and the inspiration or ideas which sparked the creation of the advertisement.

The viewer can send a short message back to the contestant, which will hopefully be positive and provide inspiration for future work. The messages can be sent directly to the contestants or posted on a public forum.

### Interaction Between Web Site and Public Broadcasting

Some implementations provide a unique environment for linking web site activities with public broadcasting outlets (e.g. television, radio, mobile devices, magazines, social networks). For example, contest winners could be featured on reality television shows to show their winning ads, build a story based on the ad (e.g. comedy skit, rags to riches story, science fiction, drama, music, etc.), and compete with other ad winners to win a grand prize. Viewers can watch the presentations on TV and then go to the web site to view key scenes from the TV show, learn more about the product and contestant, play games related to the ads, and vote on their favorite ad/story. An objective is to create an interactive environment where ads can be used keep viewers involved and entertained and thereby increase the effectiveness of the advertising.

### System Components

It will be appreciated that the modules, processes, methods, systems, and sections described above can be implemented in hardware, hardware programmed by software, software instructions stored on a nontransitory computer readable medium, software instructions received via transitory computer readable medium or a combination of the above. A system according to at least one embodiment can be implemented, for example, using a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net, Ruby or the like, and/or a scripting language such as javascript, PHP or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or storage device which may be any suitable memory apparatus, including, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer readable media may be readily implemented, fully or partially, in software using, for example, object or object-oriented software development environments that provide portable source code that can be used on a variety of computer platforms. Also, proprietary or specific-purpose scripting and/or programming languages may be used for various components mentioned above.

Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the user interface, web, and/or computer programming arts.

It is, therefore, apparent that there is provided, in accordance with the various embodiments disclosed herein, systems, methods and computer-readable media for holding online contests to create advertising material.

While the disclosed subject matter has been described in conjunction with a number of example embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A method for operating an internet based system having one or more Servers, aClients, rClients, and uClients connected together by either wired or wireless means, comprising:
holding online contests which challenge amateur or professional contestants to create complete advertisements or partial advertising content for one or more sponsor companies using natural skills and common or professional equipment;
displaying complete advertisements or partial advertising content for online voting, creating online audiences and generating advertising revenue;
using a portion of the advertising revenue generated to reward contestants with prizes based on the number of votes received, and;
using a portion of the advertising revenue to purchase entry rights from any contestant that enters a contest, regardless of if they win or lose the contest

2. The method of claim 1, comprising three categories of people to participate in the contests: Members, Judges, and Guests.

3. The method of claim 2, wherein Members can enter contests, vote in contests, win prizes or money, and maintain a financial account linked to the web site where funds are automatically deposited for contest winnings and deducted for applicable monthly fees.

4. The method of claim 2, wherein Judges do not enter contests, but vote in contests.

5. The method of claim 2, wherein Guests view the contests, entries, and voting results but cannot vote.

6. The method of claim 2, wherein voters participate in only one voting session per contest.

7. The method of claim 7, wherein each session may require voters to rate entries or cast votes on multiple entries to create diversity in votes, but voters are not allowed to vote more than once for any given entry.

8. The method of claim 2, wherein Judges and Members register and provide personal information and identification so that web site Administrators can ensure that no one votes under multiple names.

9. The method of claim 2, comprising posting approved entries on web site and starting a voting period, wherein members can vote on their own entries, friends of members can login as judges or members and vote on member entries, each voter votes only once for any given entry, each voter votes for the same number of entries in any given contest, and the number of votes required from each voter can vary from contest to contest.

10. The method of claim 2, comprising a means for entries to be reviewed by administrators, using Sponsor guidelines for acceptance, prior to posting on the voting ballots, wherein a Sponsor provides a custom censorship rating guideline for each contest and entries not meeting specified guidelines are removed from the voting ballot.

11. The method of claim 2, whereby adult-only material is not displayed by default and only enabled for display by registered members that are confirmed to be of legal age to view such material, thereby setting the stage for Sponsors to use adult-only material in advertisements if they should desire.

12. The method of claim 2, wherein a Member brings a BizBuddy onto their account to act as a muse to inspire and help create the contest entries and share in the rewards and thereby extend contest participation and rewards to people who could not otherwise participate and receive rewards.

13. The method of claim 2, comprising introducing each contest in a “Hollywood style” by providing a stage setting with a closed curtain and a countdown counter showing time remaining until the next contest, wherein when the counter reaches zero, the curtain opens to unveil the contest description with a Sponsor company name and logo, a description of the contest rules and expectations, unique stage settings, and links to example entries.

14. The method of claim 2, wherein each time a vote is submitted, a voter receives voting credits added to the voter's account and displayed upon demand, wherein the voting credits are accumulated and used to create custom coupons that can be used for purchasing products.

15. The method of claim 2, comprising monitoring view times so that when a viewer opens a voting ballot, a timer is automatically started to record the time the viewer spends viewing entries.

16. The method of claim 2, comprising linking web site activities with public broadcasting outlets including one or more of: television, radio, mobile devices, magazines, social networks.

17. The method of claim 2, comprising distributing prizes, pro rata, to all contestants based on the number of votes received by each contestant.

18. The method of claim 2, comprising viewing entries and casting votes using a single screen including a static section to show contest information and a dynamic section to show contestant information.

19. The method of claim 2, comprising holding multiple contests at the same time, in production line fashion, from one or more Server computers and a single web site, whereby each contest is independent of others and can run with its own set of rules and timetable.

20. The method of claim 2, where users can create links to product boilerplate details, with this information being part of the uClient Application updated continually by the database refreshing application, thereby allowing user to focus on creative material and not on product details.

21. The method of claim 2, whereby a means is available to have users rate advertised products, creating an instant feedback mechanism for the benefit of the Sponsor.

22. The method of claim 2, whereby gamification is used to create a “contest within a contest” for viewers, with questions asked about the advertised brand, product or service and voting credits or other prizes awarded to contest winners, thereby accomplishing two objectives; 1) attracting more viewers to the contest and 2) engaging viewers to interact with the advertisement, thereby increasing the effectiveness of the advertisement.

23. The method of claim 2, whereby each viewer's personal profile is used to filter out material that would not be of interest to the viewer, thereby improving the effectiveness of material that would be of interest to the viewer.

24. The method of claim 2, whereby the contest process can be used to obtain entries with only entertainment content, with the intent of adding brand and product information as a secondary operation and thereby reducing the amount of time and money required for contestants to create their entry and allowing for the possibility of using existing material for their entry.

25. The method of claim 2, whereby the review process can be quickly expanded to handle a large amount of entries or contracted to handle a small amounts of entries, depending on contest requirements.

26. The method of claim 2, whereby links are built in to the voting ballots that allow viewers to play games, win prizes, or request summary or detailed information on the brand, product or service advertised.

27. The method of claim 2, whereby voters can accumulate voting credits and convert them into custom coupons that can be applied to a desired product or service chosen from a pool of products or services offered by one or more participating Sponsors or other suppliers.

28. The method of claim 2, whereby a small text screen is provided below a related video screen for the purpose of supplementing the content shown on the video screen with text data running in sync with the contents of the video screen with information such as; subtitles in various languages, real-time messages to the viewer, and humorous or informational comments relating to the video content.
